(19) United States
(12) Patent Application Publication
(10) Pub. No.: US 2008/0071116 A1
(43) Pub. Date: Mar. 20, 2008

(54) Modulators of Lysophosphatidic Acid (Lpa) Signaling and the Use Thereof

(75) Inventors: Yutaka Hasegawa, Odawara (JP); Gordon Mills, Houston, TX (US)

Correspondence Address: FULBRIGHT & JAWORSKI L.L.P., 600 CONGRESS AVE., SUITE 2400, AUSTIN, TX, 78701, US

(73) Assignee: THE BOARD OF REGENTS OF THE UNIVERSITY OF TEXAS SYSTEM, Austin, TX (US)

(21) Appl. No.: 10/598,216

(22) PCT Filed: Dec. 15, 2004
(86) PCT No.: PCT/US04/42395

§ 371 Date: Sep. 18, 2007

Related U.S. Application Data
(60) Provisional application No. 60/546,601, filed on Feb. 20, 2004.
(60) Provisional application No. 60/555,235, filed on Mar. 22, 2004.

(51) Int. Cl. C07F 9/09

(52) U.S. Cl. 568/12; 568/15

(57) ABSTRACT

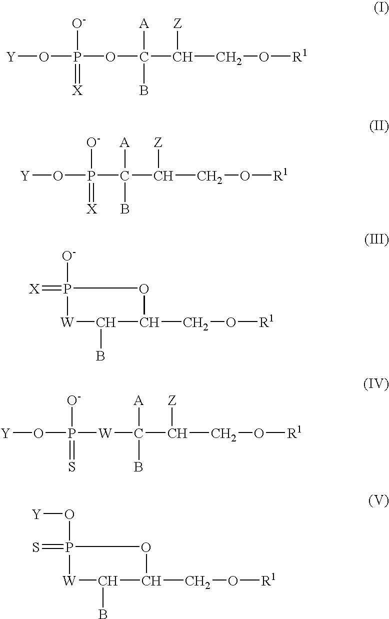

The present invention provides phosphoric acid and phosphoric acid compounds as well as thioderivatives thereof of formulat (I, II, III, IV and V).

### GOVERNMENT RIGHTS IN THIS INVENTION

This invention was made in part with U.S. government support from the National Institute of Health under contract number, 5 P50 CA 090270 03, and from the National Cancer Institute under contract number, P01 CA 64602. The U.S. government has certain rights in this invention.

### BACKGROUND OF THE INVENTION

1. Field of the Invention

Embodiments of this invention generally relate to therapeutically effective compositions of matter and their uses. Specifically, embodiments of the invention relate to compositions containing modulators for lysophosphatidic acid (LPA) signaling and analogs and derivatives thereof, as well as methods of using these compositions.

2. Description of the Related Art

Phospholipids, such as phosphatidic acid (PA), phosphatitylinositol (PI), lysophosphatidic acid (LPA), lysophosphatidylinositol (LPI), lysophosphatidylcholine (LPC), are generally found to be involved in a broad range of biological processes and cellular events in a variety of plants and animals. Lysophosphatidic acid (LPA) has been reported to induce cell proliferation, differentiation, mitogenesis, wound healing, platelet aggregation and smooth muscle contraction, to prevent apoptosis induced by stress or stimuli during angiogenesis, to induce growth-factor-like responses and stimulate cell morphologic changes, cell adhesion, and cell migration, and to be used as an anti-wrinkle agent. More specifically, LPA has been reported to induce the production of T cell growth factor, e.g., interleukin 2 (IL-2), and to stimulate cell proliferation in serum free medium or in synergy with low concentrations of fetal bovine serum. LPA has also been reported to induce a transient increase in cytosolic free calcium (Ca²⁺) in many cell lines.

LPA is typically produced either extracellularly or intracellularly in response to various growth factors, including LPA itself, phorbol esters, epidermal growth factor and other factors. Further, the recent discovery of the LPA biosynthesis pathway has elucidated how LPA is produced in extracellular milieu. It is now known that extracellular LPA is mainly generated sequentially from phosphatidylcholine (PC) by phospholipase A (PLA) into lysophosphatidylcholine (LPC), and from LPC into LPA by an enzyme, ATX/lysoPLD ectophosphodiesterase, which has been implicated in cell motility and tumor invasion, neovascularization, and metastasis.

It is also known that LPA induces invasion in vitro and could play a role in the pathophysiology of cancers. Ovarian cancer-activating factor (OCAF) from ascites of ovarian cancer patients was purified, characterized and then identified as a mixture of multiple forms of LPA. The OCAF is responsible for the major activity of the ovarian cancer ascites to activate ovarian cancer cells. In addition, aberrant LPA receptor expression, LPA production, and/or expression of the enzymes for LPA synthesis are significantly increased in malignant cancer cell effusions and in multiple cancer cell lineages. It has been observed that activities of LPA in cancer lead to an increase in proliferation under anchorage-dependent and anchorage-independent conditions; prevention of apoptosis and anoikis; an increase in invasiveness; an inducement to cytoskeletal reorganization and change of cell shape; a decrease in sensitivity to chemotherapy agents; an increase in production of various regulators of neovascularisation and/or the mRNA expression of these growth factors or regulators/mediators, e.g., vascular endothelial growth factor (VEGF), interleukin-8 (IL-8), IL-6, proteases (urokinase plasminogen activator (uPA), and/or LPA itself; and an increase in the activity of cancer development related proteases, e.g., matrix metalloproteinase 2 (MMP-2) and MMP-9. These observations underscore the importance of LPA in cancer.

LPA signals by binding to specific receptors which, in turn, lead to specific targeted cellular events. LPA specific receptors belong to the membrane G protein coupled receptors (GPCR) protein family, whose structures span seven-times across cell membrane. Four mammalian LPA specific receptors have been identified so far, LPA1, LPA2, LPA3 and LPA4. They were formerly called endothelial differentiation genes (EDG), EDG2, EDG4, EDG7, and GPR23/P2Y9, respectively. LPA1 is the most widely expressed receptor, whereas LPA2 and LPA3 are aberrantly expressed in different cancer cells. LPA4 seems to be expressed at very low levels. In ovarian cancer, LPA1, LPA2, and LPA3 are known to be expressed to regulate cellular proliferation, apoptosis, anoikis. These findings have suggested a role for LPA and LPA receptors as cancer markers for ovarian cancer screening.

In the case of prostate cancers, both LPA sensitive and LPA insensitive cell lines have been found. In some prostate cancer cell lines, LPA acts an autocrine growth factor. However, little is known about the biological functions of LPA and LPA receptors in prostate cancer. For most prostate cancers, androgen withdrawal provides the first-line of therapy, and under the selective pressure of hormonal ablation therapy, androgen insensitive clones invariably arise, resulting in tumor progression and inevitable death. Androgen insensitive prostate cancer cells are characterized by a low proliferative rate that decreases the efficacy of most chemotherapeutic regimens. In particular, LPA has been found to have potent growth and survival promoting activity for prostate cancer cells.

Thus, there remains a need for a method of controlling the function of LPA and/or specific LPA receptor subtypes with respect to cancer cell growth and survival. In addition, LPA plays a role in the pathophysiology of multiple other diseases, including atherosclerosis, hypertension, ischemia perfusion injury, diabetes, cardiovascular disease, stroke, prevention of toxicity of chemotherapy and radiation therapy, immunological function and others. Thus, modulators of LPA function may find utility in multiple diseases.

### SUMMARY OF THE INVENTION

Embodiments of the invention generally relate to compounds and pharmaceutical compositions involved in LPA signaling and methods of treating a disease, such as cancer diseases, using compounds and compositions of the invention.

In one embodiment, the invention provides a compound having the formula (I):

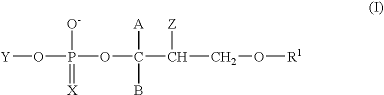

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, A is selected from the group consisting of hydrogen, hydroxyl, and halogen, B is selected from the group consisting of hydrogen, hydroxyl, and halogen, Z is selected from the group consisting of hydrogen, hydroxyl, halogen, haloakyl, haloalkyloxy, alkyl, alkenyl, alkylnyl, saturated acyl, unsaturated acyl, alkoxy, alkenyloxy, and alkynyloxy, X is selected from the group consisting of oxygen and sulfur, Y is selected from the group consisting of hydrogen, halogen, saturated and unsaturated haloakyl, saturated and unsaturated haloalkyloxy, alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, substituted aryloxy, and lower alicyclic-oxy groups which are optionally substituted with one or more hydroxy or lower alkoxy groups; or a mimetic, stereoisomer, enantiomer, or pharmaceutically acceptable salt thereof, and when X is oxygen and A and B are both hydrogen, then Y is not hydrogen.

In another embodiment, the invention provides a compound having the formula (II):

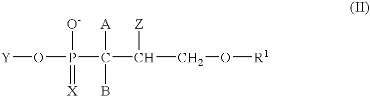

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, A is selected from the group consisting of hydrogen, hydroxyl, and halogen, B is selected from the group consisting of hydrogen, hydroxyl, and halogen, Z is selected from the group consisting of hydrogen, hydroxyl, halogen, haloakyl, haloalkyloxy, alkyl, alkenyl, alkylnyl, saturated acyl, unsaturated acyl, alkoxy, alkenyloxy, and alkynyloxy, X is selected from the group consisting of oxygen and sulfur, Y is selected from the group consisting of halogen, saturated and unsaturated haloakyl, saturated and unsaturated haloalkyloxy, alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, substituted aryloxy, and lower alicyclic-oxy groups which are optionally substituted with one or more hydroxy or lower alkoxy groups; or a mimetic, stereoisomer, enantiomer, or pharmaceutically acceptable salt thereof.

In another embodiment, the invention further provides a compound having the formula (III):

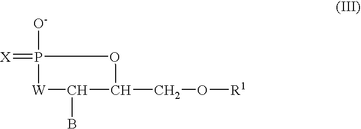

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, B is selected from the group consisting of hydrogen, hydroxyl, and halogen, W is oxygen or a bond, X is selected from the group consisting of oxygen and sulfur; or a mimetic, stereoisomer, enantiomer, or pharmaceutically acceptable salt thereof.

In another embodiment, the invention further provides a compound having the formula (IV):

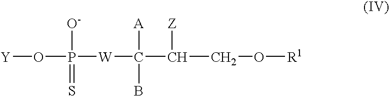

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, A is selected from the group consisting of hydrogen, hydroxyl, and halogen, B is selected from the group consisting of hydrogen, hydroxyl, and halogen, W is oxygen or a bond, Z is selected from the group consisting of halogen, haloakyl, haloalkyloxy, alkyl, alkenyl, alkylnyl, saturated acyl, unsaturated acyl, alkoxy, alkenyloxy, and alkynyloxy, Y is selected from the group consisting of hydrogen, halogen, saturated and unsaturated haloakyl, saturated and unsaturated haloalkyloxy, alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, substituted aryloxy, and lower alicyclic-oxy groups which are optionally substituted with one or more hydroxy or lower alkoxy groups; or a mimetic, stereoisomer, enantiomer, or pharmaceutically acceptable salt thereof.

In another embodiment, the invention further provides a compound having the formula (V):

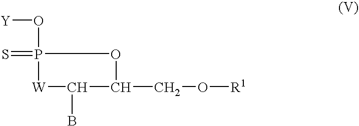

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, B is selected from the group consisting of hydrogen, hydroxyl, and halogen, W is oxygen or a bond, Y is selected from the group consisting of halogen, saturated and unsaturated haloakyl, saturated and unsaturated haloalkyloxy, alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, substituted aryloxy, and lower alicyclic-oxy groups which are optionally substituted with one or more hydroxy or lower alkoxy groups; or a mimetic, stereoisomer, enantiomer, or pharmaceutically acceptable salt thereof.

In another embodiment, the invention further provides a compound having the formula (IV):

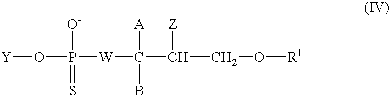

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, A is selected from the group consisting of hydrogen, hydroxyl, and halogen, B is selected from the group consisting of hydrogen, hydroxyl, and halogen, W is oxygen or a bond, Z is selected from the group consisting of halogen, haloakyl, haloalkyloxy, alkyl, alkenyl, alkylnyl, saturated acyl, unsaturated acyl, alkoxy, alkenyloxy, and alkynyloxy, Y is selected from the group consisting of cyano alkyl, cyano alkenyl, cyano alkylnyl, cyano acyl, cyano alkoxy, cyano alkenyloxy, cyano alkynyloxy, cyano aryl, cyano aryloxy, cyano heteroaryl, cyano heteroaryloxy, cyano aralkyl, cyano aralkyloxy, and lower cyano alicyclic-oxy optionally substituted with one or more hydroxy or lower alkoxy groups; or a mimetic, stereoisomer, enantiomer, or pharmaceutically acceptable salt thereof.

In another embodiment, the invention further provides a compound having the formula (V):

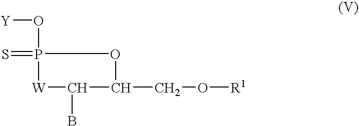

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, B is selected from the group consisting of hydrogen, hydroxyl, and halogen, W is oxygen or a bond, Y is selected from the group consisting of cyano alkyl, cyano alkenyl, cyano alkylnyl, cyano acyl, cyano alkoxy, cyano alkenyloxy, cyano alkynyloxy, cyano aryl, cyano aryloxy, cyano heteroaryl, cyano heteroaryloxy, cyano aralkyl, cyano aralkyloxy, and lower cyano alicyclic-oxy optionally substituted with one or more hydroxy or lower alkoxy groups; or a mimetic, stereoisomer, enantiomer, or pharmaceutically acceptable salt thereof.

In yet another embodiment, the invention provides a pharmaceutical composition for treating a disease. The pharmaceutical composition includes a therapeutically effective amount of a compound having the formula (I):

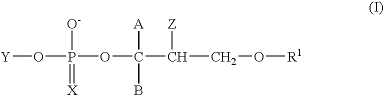

or a mimetic, stereoisomer, enantiomer, or pharmaceutically acceptable salt thereof. In another embodiment, the pharmaceutical composition includes a therapeutically effective amount of a compound having the formula (II):

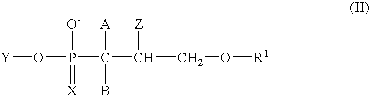

or a mimetic, stereoisomer, enantiomer, or pharmaceutically acceptable salt thereof. In still another embodiment, the pharmaceutical composition includes a therapeutically effective amount of a compound having the formula (III):

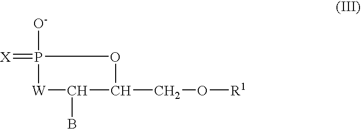

or a mimetic, stereoisomer, enantiomer, or pharmaceutically acceptable salt thereof. In still another embodiment, the pharmaceutical composition includes a therapeutically effective amount of a compound having the formula (IV):

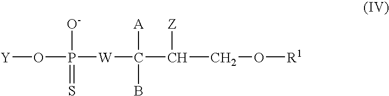

### In still another embodiment, the pharmaceutical composition includes a therapeutically effective amount of a compound having the formula (V):

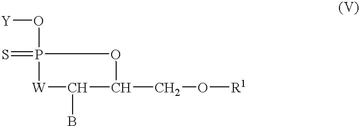

In yet another embodiment, the invention further provides a method for treating a disease, including administering a pharmaceutically effective amount of a therapeutically effective amount of a compound having the formula (I):

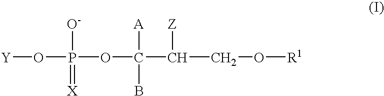

or a mimetic, stereoisomer, enantiomer, or pharmaceutically acceptable salt thereof. In another embodiment, the method includes administering a pharmaceutically effective amount of a therapeutically effective amount of a compound having the formula (II):

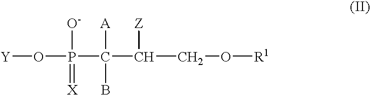

or a mimetic, stereoisomer, enantiomer, or pharmaceutically acceptable salt thereof. In still another embodiment, the method includes administering a pharmaceutically effective amount of a therapeutically effective amount of a compound having the formula (III):

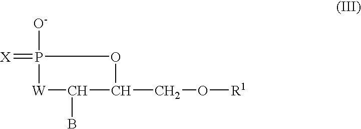

or a mimetic, stereoisomer, enantiomer, or pharmaceutically acceptable salt thereof. In still another embodiment, the method includes administering a pharmaceutically effective amount of a therapeutically effective amount of a compound having the formula (IV):

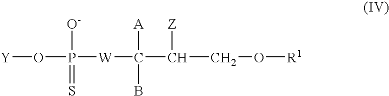

or a mimetic, stereoisomer, enantiomer, or pharmaceutically acceptable salt thereof. In still another embodiment, the method includes administering a pharmaceutically effective amount of a therapeutically effective amount of a compound having the formula (V):

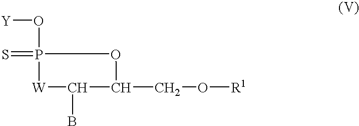

or a mimetic, stereoisomer, enantiomer, and pharmaceutically acceptable salt thereof.

In yet another embodiment, the invention provides a method for treating an androgen insensitive prostate cancer, including administering a pharmaceutically effective amount of a compound of a LPA derivative to a subject.

In yet another embodiment, the invention further provides a method for treating a cancer disease. The method includes administering a pharmaceutically effective amount of a LPA derivative to bind to a specific subtype of LPA receptor and inhibit cell growth.

The compound and/or LPA derivative of the invention includes 1-alkyl-sn2-hydroxide-rac-glycero-3-phosphothionate, 1-alkenyl-sn2-hydroxide-rac-glycero-3-phosphothionate, 1-alkynyl-sn2-hydroxide-rac-glycero-3-phosphothionate, 1-acyl-sn2-hydroxide-rac-glycero-3-phosphothionate, 1-alkyl-sn2-O-methyl-rac-glycero-3-phosphothionate, 1-alkenyl-sn2-O-methyl-rac-glycero-3-phosphothionate, 1-alkynyl-sn2-O-methyl-rac-glycero-3-phosphothionate, and derivatives thereof.

In addition, the compound and/or LPA derivative of the invention includes 2-alkyl-sn-1-hydroxide-rac-glycero-3-phosphothionate, 2-alkenyl-sn-1-hydroxide-rac-glycero-3-phosphothionate, 2-alkynyl-sn-1-hydroxide-rac-glycero-3-phosphothionate, 2-acyl-sn-1-hydroxide-rac-glycero-3-phosphothionate, 2-alkyl-sn-1-O-methyl-rac-glycero-3-phosphothionate, 2-alkenyl-sn-1-O-methyl-rac-glycero-3-phosphothionate, 2-alkynyl-sn-1-O-methyl-rac-glycero-3-phosphothionate, 2-acyl-sn-1-O-methyl-rac-glycero-3-phosphothionate, and derivatives thereof.

Further, the compound and/or LPA derivative of the invention includes 1-alkyl-sn2-hydroxide-rac-glycero-3-halophosphate, 1-alkenyl-sn2-hydroxide-rac-glycero-3-halophosphate, 1-alkynyl-sn2-hydroxide-rac-glycero-3-halophosphate, 1-acyl-sn2-hydroxide-rac-glycero-3-halophosphate, 1-alkyl-sn2-O-methyl-rac-glycero-3-halophosphate, 1-alkenyl-sn2-O-methyl-rac-glycero-3-halophosphate, 1-alkynyl-sn2-O-methyl-rac-glycero-3-halophosphate, 1-acyl-sn2-O-methyl-rac-glycero-3-halophosphate, 1-alkyl-sn2-hydroxide-rac-glycero-3-halophosphothionate, 1-alkenyl-sn2-hydroxide-rac-glycero-3-halophosphothionate, 1-alkynyl-sn2-hydroxide-rac-glycero-3-halophosphothionate, 1-acyl-sn2-hydroxide-rac-glycero-3-halophosphothionate, 1-alkyl-sn2-O-methyl-rac-glycero-3-halophosphothionate, 1-alkenyl-sn2-O-methyl-rac-glycero-3-halophosphothionate, 1-alkynyl-sn2-O-methyl-rac-glycero-3-halophosphothionate, 1-acyl-sn2-O-methyl-rac-glycero-3-halophosphothionate, and derivatives thereof.

Still further, the compound and/or LPA derivative of the invention includes 1-lauroyl-sn2-O-methyl-rac-glycero-D-3-deoxy-myo-inositol-3-phosphate, 1-myristoyl-sn2-O-methyl-rac-glycero-D-3-deoxy-myo-inositol-3-phosphate, 1-palmitoyl-sn2-O-methyl-rac-glycero-D-3-deoxy-myo-inositol-3-phosphate, 1-stearoyl-sn2-O-methyl-rac-glycero-D-3-deoxy-myo-inositol-3-phosphate, 1-oleoyl-sn2-O-methyl-rac-glycero-D-3-deoxy-myo-inositol-3-phosphate, 1-linoleoyl-sn2-O-methyl-rac-glycero-D-3-deoxy-myo-inositol-3-phosphate, 1-linolenoyl-sn2-O-methyl-rac-glycero-D-3-deoxy-myo-inositol-3-phosphate, 1-eleostearoyl-sn2-O-methyl-rac-glycero-D-3-deoxy-myo-inositol-3-phosphate and derivatives thereof.

Additionally, the compound and/or LPA derivative of the invention includes 1-acyl-2-hydroxy-sn-glycero-3-[phospho-rac-(1-glycerol)], 1-lauroyl-2-hydroxy-sn-glycero-3-[phospho-rac-(1-glycerol)], 1-myristoyl-2-hydroxy-sn-glycero-3-[phospho-rac-(1-glycerol)], 1-palmitoyl-2-hydroxy-sn-glycero-3-[phospho-rac-(1-glycerol)], 1-stearoyl-2-hydroxy-sn-glycero-3-[phospho-rac-(1-glycerol)], 1-oleoyl-2-hydroxy-sn-glycero-3-[phospho-rac-(1-glycerol)], 1-linoleoyl-2-hydroxy-sn-glycero-3-[phospho-rac-(1-glycerol)], 1-linolenoyl-2-hydroxy-sn-glycero-3-[phospho-rac-(1-glycerol)], 1-eleosteroyl-2-hydroxy-sn-glycero-3-[phospho-rac-(1-glycerol)], and derivatives thereof.

Furthermore, the compound and/or LPA derivative of the invention includes 1-alkyl-2-hydroxy-sn-glycero-3-[phospho-rac-(1-glycerol)], 1-lauryl-2-hydroxy-sn-glycero-3-[phospho-rac-(1-glycerol)], 1-myristyl-2-hydroxy-sn-glycero-3-[phospho-rac-(1-glycerol)], 1-palmityl-2-hydroxy-sn-glycero-3-[phospho-rac-(1-glycerol)], 1-stearyl-2-hydroxy-sn-glycero-3-[phospho-rac-(1-glycerol)], 1-oleyl-2-hydroxy-sn-glycero-3-[phospho-rac-(1-glycerol)], 1-linoleyl-2-hydroxy-sn-glycero-3-[phospho-rac-(1-glycerol)], 1-linolenyl-2-hydroxy-sn-glycero-3-[phospho-rac-(1-glycerol)], 1-eleosteryl-2-hydroxy-sn-glycero-3-[phospho-rac-(1-glycerol)], and derivatives thereof.

Also, the compound and/or LPA derivative of the invention further includes 1-alkyl-sn2-hydroxide-rac-glycero-3-phosphonate, 1-alkenyl-sn2-hydroxide-rac-glycero-3-phosphonate, 1-alkynyl-sn2-hydroxide-rac-glycero-3-phosphonate, 1-acyl-sn2-hydroxide-rac-glycero-3-phosphonate, 1-alkyl-sn2-O-methyl-rac-glycero-3-phosphonate, 1-alkenyl-sn2-O-methyl-rac-glycero-3-phosphonate, 1-alkynyl-sn2-O-methyl-rac-glycero-3-phosphonate, 1-acyl-sn2-O-methyl-rac-glycero-3-phosphonate, and derivatives thereof.

Still further, the compound and/or LPA derivative of the invention includes 1-alkyl-sn2-hydroxide-rac-glycero-3-halophosphonate, 1-alkenyl-sn2-hydroxide-rac-glycero-3-halophosphonate, 1-alkynyl-sn2-hydroxide-rac-glycero-3-halophosphonate, 1-acyl-sn2-hydroxide-rac-glycero-3-halophosphonate, 1-alkyl-sn2-O-methyl-rac-glycero-3-halophosphonate, 1-alkenyl-sn2-O-methyl-rac-glycero-3-halophosphonate, 1-alkynyl-sn2-O-methyl-rac-glycero-3-halophosphonate, 1-acyl-sn2-O-methyl-rac-glycero-3-halophosphonate, and derivatives thereof.

Still further, the compound and/or LPA derivative of the invention includes 1-alkyl-sn2-hydroxide-rac-glycero-3-thiophosphonate, 1-alkenyl-sn2-hydroxide-rac-glycero-3-thiophosphonate, 1-alkynyl-sn2-hydroxide-rac-glycero-3-thiophosphonate, 1-acyl-sn2-hydroxide-rac-glycero-3-thiophosphonate, 1-alkyl-sn2-O-methyl-rac-glycero-3-thiophosphonate, 1-alkenyl-sn2-O-methyl-rac-glycero-3-thiophosphonate, 1-alkynyl-sn2-O-methyl-rac-glycero-3-thiophosphonate, 1-acyl-sn2-O-methyl-rac-glycero-3-thiophosphonate, and derivatives thereof.

The compound and/or LPA derivative of the invention further includes 1-alkyl-sn-2,3-cyclic-glycero-3-phosphothionate, 1-alkenyl-sn-2,3-cyclic-glycero-3-phosphothionate, 1-alkynyl-sn-2,3-cyclic-glycero-3-phosphothionate, 1-acyl-sn-2,3-cyclic-glycero-3-phosphothionate, 1-alkyl-sn-2,3-cyclic-glycero-3-phosphonate, 1-alkenyl-sn-2,3-cyclic-glycero-3-phosphonate, 1-alkynyl-sn-2,3-cyclic-glycero-3-phosphonate, 1-acyl-sn-2,3-cyclic-glycero-3-phosphonate, and derivatives thereof.

Further, the compound and/or LPA derivative of the invention includes 1-alkyl-sn-2,3-cyclic-glycero-3-phosphonate, 1-alkenyl-sn-2,3-cyclic-glycero-3-phosphonate, 1-alkynyl-sn-2,3-cyclic-glycero-3-phosphonate, 1-acyl-sn-2,3-cyclic-glycero-3-phosphonate, 1-alkyl-sn-2,3-cyclic-glycero-3-phosphonate, 1-alkenyl-sn-2,3-cyclic-glycero-3-phosphonate, 1-alkynyl-sn-2,3-cyclic-glycero-3-phosphonate, 1-acyl-sn-2,3-cyclic-glycero-3-phosphonate, and derivatives thereof.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates the chemical structures of LPAs.

FIG. 2A illustrates the chemical structure of DPIEL.

FIG. 2B illustrates the chemical structure of LPA derivatives, LPGs.

FIG. 3 demonstrates the effect of OMPT-induced and 18:1 LPA-induced calcium mobilization in colon cancer cells (HT29).

FIG. 4 demonstrates the concentration-response curves of OMPT and 18:1 LPA on calcium mobilization in OVCAR3 and HT 29 cells.

FIG. 5 demonstrates the effect of DPIEL on OMPT-induced calcium mobilization in ovarian cancer cells (OVCAR3).

FIG. 6 demonstrates the effect of DPIEL on 18:1 LPA-induced calcium mobilization in colon cancer cells (HT29).

FIG. 7 demonstrates the effect of DPIEL on 18:1 LPA-induced calcium mobilization in androgen insensitive prostate cancer cells (PC-3).

FIG. 8A shows that DPIEL inhibit phosphorylation of ERK1/2 activated by 18:1 LPA in androgen insensitive prostate cancer cells (PC-3).

FIG. 8B shows that DPIEL does not inhibit phosphorylation of ERK1/2 activated by EGF in androgen sensitive prostate cancer cells (LNCaP).

FIG. 8C demonstrates OMPT activation of the specific LPA3 receptor subtype is linked to MAPK kinase activation in mammalian cells.

FIG. 8D demonstrates confirmation of the expression of FLAG-tagged various LPA receptors in transfected cells.

FIG. 9 illustrates chemical structures of various LPGs and their derivatives.

FIG. 10 shows the mRNA expression levels of various LPA receptors in different cancer cells.

FIG. 11 is a graph showing that 14:0 LPG inhibits 14:0 LPA-induced calcium mobilization in androgen insensitive prostate cancer DU145 cells.

FIG. 12 demonstrates that 14:0 LPG inhibits 14:0 LPA signaling in androgen insensitive prostate cancer DU145 cells.

FIG. 13 demonstrates the normalized response of the inhibition of 14:0 LPA signaling by 14:0 LPG in androgen insensitive prostate cancer DU145 cells.

FIG. 14 is a graph showing 18:1 LPA-induced calcium mobilization in androgen insensitive prostate cancer DU145 cells.

FIG. 15 is a graph showing 18:1 LPA-induced calcium mobilization in the presence of 10 μM 18:1-acyl-LPG in androgen insensitive prostate cancer DU145 cells.

FIG. 16 is a graph showing 18:1 LPA-induced calcium mobilization in the presence of 30 μM 18:1-acyl-LPG in androgen insensitive prostate cancer DU145 cells.

FIG. 17 demonstrates concentration-dependent inhibition of 18:1 LPA signaling by 18:1-acyl-LPG in androgen insensitive prostate cancer DU145 cells.

FIG. 18 demonstrates normalized response of the inhibition of 18:1 LPA signaling by 18:1-acyl-LPG in androgen insensitive prostate cancer DU145 cells.

FIG. 19 demonstrates the effect of 14:0 LPG and 18:1-acyl-LPG on OMPT-induced calcium mobilization in androgen insensitive prostate cancer PC-3 cells.

FIG. 20 demonstrates the normalized response of the inhibition of 14:0 LPG and 18:1-acyl-LPG on OMPT-induced calcium mobilization in androgen insensitive prostate cancer PC-3 cells.

FIG. 21 demonstrates the effect of 14:0 LPG, 18:0 LPG, and 18:1-acyl-LPG on 18:1 LPA-induced calcium mobilization in colon cancer HT29 cells.

FIG. 22 demonstrates normalized response of the inhibition of 14:0 LPG, 18:0 LPG, and 18:1-acyl-LPG on 18:1 LPA-induced calcium mobilization in colon cancer HT29 cells.

FIG. 23 demonstrates LPA2 receptor mediated lamellipodia formation for colon cancer HT29 cells in serum-free medium control.

FIG. 24 demonstrates the effect of 10 μM 18:0-acyl-LPG on serum-starvation mediated lamellipodia formation in colon cancer HT29 cells.

FIG. 25 demonstrates the effect of 30 μM 18:0-acyl-LPG on serum-starvation mediated lamellipodia formation in colon cancer HT29 cells.

FIG. 26 demonstrates that 14:0 LPA induces LPA2 receptor mediated lamellipodia formation for colon cancer HT29 cells.

FIG. 27 demonstrates the inhibition of 14:0 LPA-induced LPA2 receptor mediated lamellipodia formation by 10 μM 18:0-acyl-LPG in colon cancer HT29 cells.

FIG. 28 demonstrates the inhibition of 14:0 LPA-induced LPA2 receptor mediated lamellipodia formation by 30 μM 18:0-acyl-LPG in colon cancer HT29 cells.

FIG. 29 demonstrates that 1% fetal bovine serum (FBS) induces LPA2 receptor mediated lamellipodia formation in colon cancer HT29 cells.

FIG. 30 demonstrates the inhibition of 1% FBS-induced LPA2 receptor mediated lamellipodia formation by 10 μM 18:0-acyl-LPG in colon cancer HT29 cells.

FIG. 31 demonstrates the inhibition of 1% FBS-induced LPA2 receptor mediated lamellipodia formation by 30 μM 18:0-acyl-LPG in colon cancer HT29 cells.

FIG. 32 demonstrates that 10% FBS induces LPA2 receptor mediated lamellipodia formation for colon cancer HT29 cells.

FIG. 33 demonstrates that there is no inhibition of 10% FBS-induced LPA2 receptor mediated lamellipodia formation by 10 μM 18:0-acyl-LPG in colon cancer HT29 cells.

FIG. 34 demonstrates that there is no inhibition of 10% FBS-induced LPA2 receptor mediated lamellipodia formation by 30 μM 18:0-acyl-LPG in colon cancer HT29 cells.

FIG. 35 demonstrates the inhibition of cell growth (cell viability) at high concentrations of 18:0-acyl-LPG in the presence of 10 μM of 14:0 LPA in colon cancer HT29 cells.

FIG. 36 demonstrates the inhibition of cell growth (cell viability) at high concentrations of 18:0-acyl-LPG only in the presence of low concentrations of FBS (1%) but not in the presence of high concentration of FBS (10%) in colon cancer HT29 cells.

FIG. 37 demonstrates LPA2 receptor mediated lamellipodia formation for androgen insensitive prostate cancer PC-3 cells in serum-free medium control.

FIG. 38 demonstrates the effect of 30 μM 14:0-LPG on LPA2 receptor mediated lamellipodia formation in androgen insensitive prostate cancer PC-3 cells.

FIG. 39 demonstrates the effect of 30 μM 18:0-acyl-LPG on LPA2 receptor mediated lamellipodia formation in androgen insensitive prostate cancer PC-3 cells.

FIG. 40 demonstrates the effect of 30 μM 18:1-acyl-LPG on LPA2 receptor mediated lamellipodia formation in androgen insensitive prostate cancer PC-3 cells.

FIG. 41 demonstrates that 18:1 LPA induces LPA2 receptor mediated lamellipodia formation for androgen insensitive prostate cancer PC-3 cells.

FIG. 42 demonstrates the inhibition of 18:1 LPA-induced LPA2 receptor mediated lamellipodia formation by 30 μM 14:0-acyl-LPG in androgen insensitive prostate cancer PC-3 cells.

FIG. 43 demonstrates the inhibition of 18:1 LPA-induced LPA2 receptor mediated lamellipodia formation by 30 μM 18:0-acyl-LPG in androgen insensitive prostate cancer PC-3 cells.

FIG. 44 demonstrates the inhibition of 18:1 LPA-induced LPA2 receptor mediated lamellipodia formation by 30 μM 18:1-acyl-LPG in androgen insensitive prostate cancer PC-3 cells.

FIG. 45 demonstrates the inhibition of cell growth (cell viability) at high concentrations of 14:0-acyl-LPG in the presence of 10 μM of 18:1 LPA in androgen insensitive prostate cancer PC-3 cells.

FIG. 46 demonstrates inhibition of cell growth (cell viability) at high concentrations of 18:0-acyl-LPG, and also in the presence of 10 μM of 18:1 LPA in androgen insensitive prostate cancer PC-3 cells.

FIG. 47 demonstrates inhibition of cell growth (cell viability) at high concentrations of 18:1-acyl-LPG, and also in the presence of 10 μM of 18:1 LPA in androgen insensitive prostate cancer PC-3 cells.

FIG. 48 summarizes the inhibition of cell growth by various LPA derivatives with and without the presence of LPA in androgen insensitive prostate cancer PC-3 cells.

FIG. 49 demonstrates the inhibition of cell growth by various LPA derivatives with and without the presence of LPA in androgen insensitive prostate cancer DU145 cells.

FIG. 50 summarizes the inhibition of cell growth by various LPA derivatives with and without the presence of LPA in androgen insensitive prostate cancer DU145 cells.

FIG. 51 shows that there is no calcium mobilization in the presence of 18:1 LPA in androgen sensitive prostate cancer LNCaP cells, proving that LNCaP is a LPA insensitive cell line.

FIG. 52 demonstrates that there is no phosphorylation of p42 and p44 MAP kinase in the presence of 18:1 LPA in androgen sensitive prostate cancer LNCaP cells, confirming that LNCaP is a LPA insensitive cell line.

FIG. 53 demonstrates that there is no inhibition of cell viability in the presence of various LPA derivatives in androgen sensitive, LPA insensitive prostate cancer LNCaP cells after about 24 hours, confirming that these LPA derivatives are selective LPA inhibitors.

FIG. 54 further demonstrates only minor inhibition of cell viability in the presence of some LPA derivatives in androgen sensitive, LPA insensitive prostate cancer LNCaP cells even after about 48 hours, confirming that these LPA derivatives are selective LPA inhibitors.

FIG. 55 demonstrates LPA derivatives reduce focal adhesion in androgen insensitive prostate cancer DU145 cells.

FIG. 56 demonstrates LPA derivatives reduce focal adhesion in androgen insensitive prostate cancer PC-3 cells.

FIG. 57 compares the chemical structures of LPA and OMPT, a LPA agonist specific for a subtype of LPA receptor.

FIG. 58A demonstrates that OMPT induces calcium mobilization in Sf9 cells through the LPA3 receptor.

FIG. 58B demonstrates that OMPT does not induce calcium mobilization through the LPA2 receptor.

FIG. 58C demonstrates that OMPT does not induce calcium mobilization in Sf9 cells through the LPA1/LPA2 chimera receptor.

FIG. 59A demonstrates that OMPT does not activate mammalian cells transfected with the LPA1 receptor.

FIG. 59B demonstrates that OMPT does not activate mammalian cells transfected with the LPA2 receptor.

FIG. 59C demonstrates that OMPT activates mammalian cells transfected with the LPA3 receptor.

FIG. 59D demonstrates that OMPT does not activate mammalian cells transfected with the S1P3 receptor as a control.

### DETAILED DESCRIPTION

LPA is a phosphatidic acid in which the hydroxyl group of the first carbon of the glycerol is esterified to a fatty acid, the second carbon is not esterified, and the third carbon is bound to a phosphate group, O—PO₃H₂. In the case of a pharmaceutically acceptable salt of the invention, one or more hydrogens are replaced, for example, with sodium ions (Na⁺) and other ions. The first carbon typically contains an acyl ester of fatty acids. Studies on the effects of the presence or absence of LPA and LPA signaling in various types of cells have revealed the involvement of LPA in cancer, cardiovascular functions, ischemia/reperfusion injury, atherosclerosis, wound healing, prevention of toxicity of chemotherapy and radiation therapy, immunological functions, for example. Thus, the design and identification of modulators of LPA signaling may provide novel therapeutic approaches in the management of these pathological states.

### I. Structures of Compounds

In one embodiment, the invention provides a compound having the formula (I):

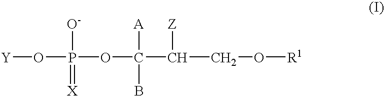

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, A is selected from the group consisting of hydrogen, hydroxyl, and halogen, B is selected from the group consisting of hydrogen, hydroxyl, and halogen, Z is selected from the group consisting of hydrogen, hydroxyl, halogen, haloakyl, haloalkyloxy, alkyl, alkenyl, alkylnyl, saturated acyl, unsaturated acyl, alkoxy, alkenyloxy, and alkynyloxy, X is selected from the group consisting of oxygen and sulfur, Y is selected from the group consisting of hydrogen, halogen, saturated and unsaturated haloakyl, saturated and unsaturated haloalkyloxy, alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, substituted aryloxy, and lower alicyclic-oxy groups which are optionally substituted with one or more hydroxy or lower alkoxy groups; or a mimetic, stereoisomer, enantiomer, or pharmaceutically acceptable salt thereof, and when X is oxygen and A and B are both hydrogen, then Y is not hydrogen.

In another embodiment, the invention provides a compound having the formula (II):

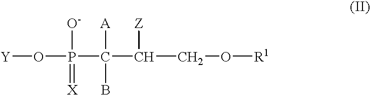

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, A is selected from the group consisting of hydrogen, hydroxyl, and halogen, B is selected from the group consisting of hydrogen, hydroxyl, and halogen, Z is selected from the group consisting of hydrogen, hydroxyl, halogen, haloakyl, haloalkyloxy, alkyl, alkenyl, alkylnyl, saturated acyl, unsaturated acyl, alkoxy, alkenyloxy, and alkynyloxy, X is selected from the group consisting of oxygen and sulfur, Y is selected from the group consisting of halogen, saturated and unsaturated haloakyl, saturated and unsaturated haloalkyloxy, alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, substituted aryloxy, and lower alicyclic-oxy groups which are optionally substituted with one or more hydroxy or lower alkoxy groups; or a mimetic, stereoisomer, enantiomer, or pharmaceutically acceptable salt thereof.

In still another embodiment, the invention further provides a compound having the formula (III):

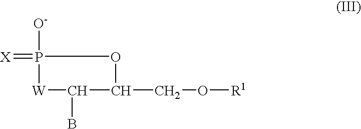

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, B is selected from the group consisting of hydrogen, hydroxyl, and halogen, W is oxygen or a bond, X is selected from the group consisting of oxygen and sulfur, Y is selected from the group consisting of halogen, saturated and unsaturated haloakyl, saturated and unsaturated haloalkyloxy, alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, substituted aryloxy, and lower alicyclic-oxy groups which are optionally substituted with one or more hydroxy or lower alkoxy groups; or a mimetic, stereoisomer, enantiomer, or pharmaceutically acceptable salt thereof.

In still another embodiment, the invention further provides a compound having the formula (IV):

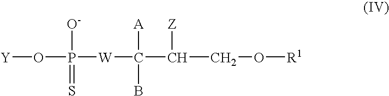

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, A is selected from the group consisting of hydrogen, hydroxyl, and halogen, B is selected from the group consisting of hydrogen, hydroxyl, and halogen, W is oxygen or a bond, Z is selected from the group consisting of halogen, haloakyl, haloalkyloxy, alkyl, alkenyl, alkylnyl, saturated acyl, unsaturated acyl, alkoxy, alkenyloxy, and alkynyloxy, Y is selected from the group consisting of hydrogen, halogen, saturated and unsaturated haloakyl, saturated and unsaturated haloalkyloxy, alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, substituted aryloxy, and lower alicyclic-oxy groups which are optionally substituted with one or more hydroxy or lower alkoxy groups; or a mimetic, stereoisomer, enantiomer, or pharmaceutically acceptable salt thereof. Additionally, Y is selected from the group consisting of cyano alkyl, cyano alkenyl, cyano alkylnyl, cyano acyl, cyano alkoxy, cyano alkenyloxy, cyano alkynyloxy, cyano aryl, cyano aryloxy, cyano heteroaryl, cyano heteroaryloxy, cyano aralkyl, cyano aralkyloxy, and lower cyano alicyclic-oxy optionally substituted with one or more hydroxy or lower alkoxy groups.

In another embodiment, the invention further provides a compound having the formula (V):

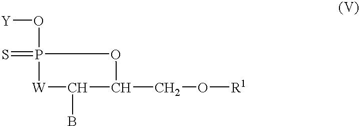

wherein R¹ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, B is selected from the group consisting of hydrogen, hydroxyl, and halogen, W is oxygen or a bond, Y is selected from the group consisting of halogen, saturated and unsaturated haloakyl, saturated and unsaturated haloalkyloxy, alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, substituted aryloxy, and lower alicyclic-oxy groups which are optionally substituted with one or more hydroxy or lower alkoxy groups; or a mimetic, stereoisomer, enantiomer, or pharmaceutically acceptable salt thereof. In addition, Y is selected from the group consisting of cyano alkyl, cyano alkenyl, cyano alkylnyl, cyano acyl, cyano alkoxy, cyano alkenyloxy, cyano alkynyloxy, cyano aryl, cyano aryloxy, cyano heteroaryl, cyano heteroaryloxy, cyano aralkyl, cyano aralkyloxy, and lower cyano alicyclic-oxy optionally substituted with one or more hydroxy or lower alkoxy groups.

The invention provides LPA modulators, derivatives, and/or analogs having the above various general formula. R¹ can be an unsubstituted or substituted, saturated or unsaturated, straight or branched chain alkyl having from about 10 to about 24 carbon atoms. For all of the structures referenced herein, R¹ can have between 0 and (n−2)/2 unsaturated bonds, wherein n is the number of carbon atoms in R¹. Substitutions include, but are not limited to, halogen, hydroxy, phenyl, amino and acylamino. The term “unsaturated” is used in reference to the various structures herein to describe the number of unsaturated carbon atoms in R¹. For example, if R¹ is an eighteen carbon alkyl with one unsaturated carbon-carbon bond at any of the possible carbon-carbon bond, it is herein referred to as 18:1 LPA.

As used herein, LPA includes LPA having any one of a variety of fatty acids esterified at the C1 position. Examples include LPA wherein the fatty acid ester is lauroyl, myristoyl, palmitoyl, stearoyl, palmitoleoyl, oleoyl, or linoleoyl, among others. For a representative example of suitable phospholipids, the reader is directed to any chemical catalog of a phospholipid supplier, for instance, the Avanti Polar Lipids Inc., catalog.

Suitable “alkyl”, “alkenyl”, and “alkynyl” is straight or branched, and may contain single, double, triple carbon to carbon bonds of one to twenty five carbon atoms or longer and may include methyl, ethyl, propyl, isopropyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, lauryl, octadecyl, myristyl, palmityl, stearyl, palmitoleyl, oleyl, linoleyl, linolenyl, eleostearyl, among others.

Suitable “alkoxy” may include alkyl-O-groups, alkenyl-O-groups, and alkynyl-O-groups, wherein the alkyl, alkenyl, or alkynyl moiety is the same as defined above, but preferably the higher ones, such as octadecyl, myristyl, myristoyl, palmityl, stearyl, palmitoleyl, oleyl, linoleyl, among others. Preferred “alkoxy” for Z may include o-methyl groups.

Suitable “acyl” may include CO-alkyl, CO-alkenyl, and CO-alkynyl groups, wherein the alkyl, alkenyl, or alkynyl moiety is the same as defined above, but preferably the higher ones, such as dodecoyl, tridecoyl, tetradecoyl, pentadecoyl, hexadecoyl, heptadecoyl, octadecoyl, nonadecoyl, eicosoyl, heneicosoyl, docosoyl, tricosoyl, tetracosoyl, pentacosoyl, lauroyl, octadecoyl, myristoyl, palmitoyl, stearoyl, palmitoleoyl, oleoyl, linoleoyl, linolenoyl, eleostearoyl, among others.

Suitable “aryl” may include ring-like functional group having five or more carbon atoms, e.g., benzene, naphthalene, phenanthrene, anthracene, etc. Each carbon of the functional group may be substituted with long or short alkyl chain or others (also called “hetero” substitutions, e.g., hydroxyl and halogen), among others. Suitable “aralkyl” may include both aliphatic and aromatic structures, and may substitute with atoms other than carbon, e.g., alkyl benzenesulfonate, among others.

Suitable “lower alkoxy substituted with one or more hydroxy groups” may include monohydroxypropoxy, monohydroxybutoxy, monohydroxypentyloxy, monohydroxyhexyloxy, dihydroxypropoxy, 1-hydroxymethyl-2-hydroxyethoxy, 2,3-, 2,4- or 3,4-dihydroxybutoxy, 2,3,4-trihydroxybutoxy, di-, tri-, tetra- or penta-hydroxypentyloxy, di-, tri-, tetra-, penta- or hexahydroxyhexyloxy, and the like. These hydroxy groups may be protected by protective groups and/or two adjacent hydroxy groups may be protected as a cyclic acetal (e.g., methyleneacetal, ethylideneacetal, benzylideneacetal, isopropylideneacetal, etc.), and the like. The above “lower alkoxy” group may be further substituted with lower alkoxy group(s) (e.g., methoxy, ethoxy, propoxy, isopropoxy, butoxy, pentyloxy, hexyloxy, etc.).

Suitable “lower alicyclic-oxy group substituted with one or more hydroxy groups” may include monohydroxycyclobutoxy, monohydroxycyclopentyloxy, monohydroxycyclohexyloxy, 2,3-, 2,4- or 3,4-dihydroxycyclobutoxy, 2,3,4-trihydroxycyclobutoxy, di-, tri- or tetra-hydroxycyclopentyloxy, cis-, epi-, allo-, myo-, muco-, neo, scyllo- or chiro-inosityl, di-, tri-, tetra- or penta-hydroxycyclohexyloxy and the like. The hydroxy groups contained in these groups may be protected with protective groups known in the art.

Suitable “halogen” or “halo” group may include fluoro, chloro, bromo, and iodo.

As used herein, “modulators of LPA” encompasses LPA derivatives, antagonists, inhibitors, stimulators, agonists, modulators, modulators, and analogs. Given the examples provided herein, it can be determined readily if an LPA analog exerts a positive or negative effect on the function of a specific LPA receptor or different binding specificity on various LPA receptors, and/or exhibits sufficient growth inhibition or anti-cancer activity suitable for medical use. Suitable LPA derivatives and analogs may be synthesized by methods known in the art and/or are commercially available from various sources, such as Avanti Polar Lipids Inc. from Alabaster, Ala. For example, modulators of LPA include any of the LPA derivatives/analogs having the formula I, II, III, IV, or V.

In one embodiment, LPA derivatives/analogs of the invention include substitutions by small molecules at the sn3 position of the glycerol backbone. One example of such compound is D-3-deoxy-phosphophatidyl-myo-inositol ether lipid (DPIEL), having a tri-hydroxyl-myo-inositol ring at the sn3 position of the glycerol backbone. However, DPIEL contains an ether linkage at the sn1 position of the glycerol backbone rather than an acyl linkage at the sn1 position of the glycerol backbone like other LPA compounds. Therefore, LPA derivatives/analogs of the invention are designed to include either acyl or ether linkages in order to test their effects on LPA signaling. Further, it is contemplated that small molecule substitutions at the sn3 position of the glycerol backbone of LPA compounds may exhibit an effect on LPA signaling. Such LPA derivatives may be used to test their effects on specific subtype of LPA receptors and, ultimately, their effect for treating a disease, e.g., their ability to stimulate or inhibit cancer growth. Furthermore, it is contemplated that LPA derivatives of the invention with small molecule substitutions at the sn3 position of the glycerol backbone may become more chemically or metabolically stable, more druggable (i.e., structurally stable such that it is suitable to be used as a drug).

In another embodiment, LPA derivatives/analogs of the invention include substitutions by small molecules at the sn3 position of the glycerol backbone, such as substitution at the functional group, Y, to generate antagonist and/or agonist for LPA receptors, e.g., LPA 1, LPA2, LPA3, and/or LPA4, etc. In another embodiment, substitutions at Y functional group create receptor subtype specific antagonists and/or agonists, which may be antagonists and/or agonists for one LPA receptor subtype but may not be very responsive to other LPA receptor subtype, e.g., specific for LPA3 but not for LPA1 or LPA2. In still another embodiment, it is contemplated that, while the substitutions at Y functional group create LPA receptor subtype specific antagonists and/or agonists, substitutions at R¹ functional group with long fatty acid chains create selectivity for LPA receptors.

Such LPA derivatives/analogs having small molecule substitutions at the sn3 position of the glycerol backbone may include compounds having the formula I, II, III, IV, or V, where Y may be an alicyclic ring, including one, di-, tri-, tetra-, penta-, hexahydroxyhexyloxy, and derivatives thereof. In addition, Y may be saturated or unsaturated, straight or branched chain of alkoxy, acyl, aryl, heteroaryl, and aralkyl, having six or more carbon atoms and optionally being substituted with one or more hydroxyl, halo, or lower alkoxy or haloalkyl groups, among others. Additionally, Y is selected from the group consisting of cyano alkyl, cyano alkenyl, cyano alkylnyl, cyano acyl, cyano alkoxy, cyano alkenyloxy, cyano alkynyloxy, cyano aryl, cyano aryloxy, cyano heteroaryl, cyano heteroaryloxy, cyano aralkyl, cyano aralkyloxy, and lower cyano alicyclic-oxy optionally substituted with one or more hydroxy or lower alkoxy groups. Exemplary LPA derivatives/analogs include, but are not limited to, 1-lauroyl-sn2-O-methyl-rac-glycero-D-3-deoxy-myo-inositol-3-phosphate, 1-myristoyl-sn2-O-methyl-rac-glycero-D-3-deoxy-myo-inositol-3-phosphate, 1-palmitoyl-sn2-O-methyl-rac-glycero-D-3-deoxy-myo-inositol-3-phosphate, 1-stearoyl-sn2-O-methyl-rac-glycero-D-3-deoxy-myo-inositol-3-phosphate, 1-oleoyl-sn2-O-methyl-rac-glycero-D-3-deoxy-myo-inositol-3-phosphate, 1-linoleoyl-sn2-O-methyl-rac-glycero-D-3-deoxy-myo-inositol-3-phosphate, 1-linolenoyl-sn2-O-methyl-rac-glycero-D-3-deoxy-myo-inositol-3-phosphate, 1-eleosteroyl-sn2-O-methyl-rac-glycero-D-3-deoxy-myo-inositol-3-phosphate, and derivatives thereof. Other examples include 1-acyl-2-hydroxy-sn-glycero-3-[phospho-rac-(1-glycerol)] and 1-alkyl-2-hydroxy-sn-glycero-3-[phospho-rac-(1-glycerol)], e.g., 1-lauroyl-2-hydroxy-sn-glycero-3-[phospho-rac-(1-glycerol)], 1-myristoyl-2-hydroxy-sn-glycero-3-[phospho-rac-(1-glycerol)], 1-palmitoyl-2-hydroxy-sn-glycero-3-[phospho-rac-(1-glycerol)], 1-stearoyl-2-hydroxy-sn-glycero-3-[phospho-rac-(1-glycerol)], 1-oleoyl-2-hydroxy-sn-glycero-3-[phospho-rac-(1-glycerol)], 1-linoleoyl-2-hydroxy-sn-glycero-3-[phospho-rac-(1-glycerol)], 1-linolenoyl-2-hydroxy-sn-glycero-3-[phospho-rac-(1-glycerol)], 1-elesteroyl-2-hydroxy-sn-glycero-3-[phospho-rac-(1-glycerol)], 1-lauryl-2-hydroxy-sn-glycero-3-[phospho-rac-(1-glycerol)], 1-myristyl-2-hydroxy-sn-glycero-3-[phospho-rac-(1-glycerol)], 1-palmityl-2-hydroxy-sn-glycero-3-[phospho-rac-(1-glycerol)], 1-stearyl-2-hydroxy-sn-glycero-3-[phospho-rac-(1-glycerol)], 1-oleyl-2-hydroxy-sn-glycero-3-[phospho-rac-(1-glycerol)], 1-linoleyl-2-hydroxy-sn-glycero-3-[phospho-rac-(1-glycerol)], 1-linolenyl-2-hydroxy-sn-glycero-3-[phospho-rac-(1-glycerol)], 1-eleosteryl-2-hydroxy-sn-glycero-3-[phospho-rac-(1-glycerol)], and derivatives thereof.

In addition, compounds having substitutions at the sn1 position are also contemplated. For example, in formula I, II, III, IV, or V, R¹ may be saturated or unsaturated, substituted or unsubstituted, straight or branched chain of alkyl, alkenyl, alkylnyl, and acyl, having six or more carbon atoms, such as an alkyl or acyl having nine or more carbon atoms and including saturated carbon-carbon bonds, one unsaturated carbon bond, and two or more unsaturated carbon bonds, among others. In one embodiment, it is contemplated that the substitutions at R¹ functional group create selectivity for LPA receptors.

Furthermore, compounds having substitutions at the sn2 position are also contemplated. For example, in formula I, II, III, IV, or V, Z may be hydroxyl, halogen, haloakyl, haloalkyloxy, alkoxy, alkenyloxy, and alkynyloxy, among others. Preferably, Z may be hydroxyl and methoxyl. Such LPA derivatives may further include other substitutions at other positions of the glycerol backbone; for example, X may be sulfur and/or Y may be an alicyclic ring having one, di-, tri-, tetra-, penta-, hexahydroxyhexyloxy, among others. As an example, compounds having R¹ as alkyl, alkenyl, alkylnyl or acyl, Z as a hydroxyl group, and Y as halogen, saturated and unsaturated haloakyl, saturated and unsaturated haloalkyloxy, alkoxy, alkenyloxy, alkynyloxy, aryl, or aryloxy, optionally substituted with one or more hydroxy or lower alkoxy groups, may be included. As another example, other compound include those when R¹ is an alkyl, alkenyl, alkylnyl or acyl, Z is a methoxy group, and Y is a halogen, saturated and unsaturated haloakyl, saturated and unsaturated haloalkyloxy, alkoxy, alkenyloxy, alkynyloxy, aryl, heteroaryl, aryloxy, or lower alicyclic-oxy groups, optionally substituted with one or more hydroxy or lower alkoxy groups.

In another embodiment, the phosphate group in the sn3 position can be substituted with other functional groups, e.g., X and Y. Also, the sn3 position can include a phosphonate group, as represented in formula II, III, IV, and V, when W is a bond. For example, the LPA derivatives/analogs of the invention include, but are not limited to, 1-alkyl-sn2-hydroxide-rac-glycero-3-phosphonate, 1-alkenyl-sn2-hydroxide-rac-glycero-3-phosphonate, 1-alkynyl-sn2-hydroxide-rac-glycero-3-phosphonate, 1-acyl-sn2-hydroxide-rac-glycero-3-phosphonate, 1-alkyl-sn2-O-methyl-rac-glycero-3-phosphonate, 1-alkenyl-sn2-O-methyl-rac-glycero-3-phosphonate, 1-alkynyl-sn2-O-methyl-rac-glycero-3-phosphonate, 1-acyl-sn2-O-methyl-rac-glycero-3-phosphonate, and derivatives thereof.

Exemplary LPA derivatives/analogs include, but are not limited to, 1-lauryl-sn2-hydroxide-rac-glycero-3-phosphonate, 1-myristyl-sn2-hydroxide-rac-glycero-3-phosphonate, 1-palmityl-sn2-hydroxide-rac-glycero-3-phosphonate, 1-stearyl-sn2-hydroxide-rac-glycero-3-phosphonate, 1-oleyl-sn2-hydroxide-rac-glycero-3-phosphonate, 1-linoleyl-sn2-hydroxide-rac-glycero-3-phosphonate, 1-linolenyl-sn2-hydroxide-rac-glycero-3-phosphonate, 1-eleosteryl-sn2-hydroxide-rac-glycero-3-phosphonate, 1-lauryl-sn2-O-methyl-rac-glycero-3-phosphonate, 1-myristyl-sn2-O-methyl-rac-glycero-3-phosphonate, 1-palmityl-sn2-O-methyl-rac-glycero-3-phosphonate, 1-stearyl-sn2-O-methyl-rac-glycero-3-phosphonate, 1-oleyl-sn2-O-methyl-rac-glycero-3-phosphonate, 1-linoleyl-sn2-O-methyl-rac-glycero-3-phosphonate, 1-linolenyl-sn2-O-methyl-rac-glycero-3-phosphonate, 1-eleosteryl-sn2-O-methyl-rac-glycero-3-phosphonate, 1-lauroyl-sn2-hydroxide-rac-glycero-3-phosphonate, 1-myristoyl-sn2-hydroxide-rac-glycero-3-phosphonate, 1-palmitoyl-sn2-hydroxide-rac-glycero-3-phosphonate, 1-stearoyl-sn2-hydroxide-rac-glycero-3-phosphonate, 1-oleoyl-sn2-hydroxide-rac-glycero-3-phosphonate, 1-linoleoyl-sn2-hydroxide-rac-glycero-3-phosphonate, 1-linolenoyl-sn2-hydroxide-rac-glycero-3-phosphonate, 1-eleosteroyl-sn2-hydroxide-rac-glycero-3-phosphonate, 1-lauroyl-sn2-O-methyl-rac-glycero-3-phosphonate, 1-myristoyl-sn2-O-methyl-rac-glycero-3-phosphonate, 1-palmitoyl-sn2-O-methyl-rac-glycero-3-phosphonate, 1-stearoyl-sn2-O-methyl-rac-glycero-3-phosphonate, 1-oleoyl-sn2-O-methyl-rac-glycero-3-phosphonate, 1-linoleoyl-sn2-O-methyl-rac-glycero-3-phosphonate, 1-linolenoyl-sn2-O-methyl-rac-glycero-3-phosphonate, 1-eleosteroyl-sn2-O-methyl-rac-glycero-3-phosphonate, and derivatives thereof.

In another embodiment, when the functional group X is sulfur, the LPA derivatives/analogs of the invention include LPA derivatives having phosphothionate and thiophosphonate groups including, but not limited to, 1-alkyl-sn2-hydroxide-rac-glycero-3-phosphothionate, 1-alkenyl-sn2-hydroxide-rac-glycero-3-phosphothionate, 1-alkynyl-sn2-hydroxide-rac-glycero-3-phosphothionate, 1-acyl-sn2-hydroxide-rac-glycero-3-phosphothionate, 1-alkyl-sn2-O-methyl-rac-glycero-3-phosphothionate, 1-alkenyl-sn2-O-methyl-rac-glycero-3-phosphothionate, 1-alkynyl-sn2-O-methyl-rac-glycero-3-phosphothionate, 2-alkyl-sn-1-hydroxide-rac-glycero-3-phosphothionate, 2-alkenyl-sn-1-hydroxide-rac-glycero-3-phosphothionate, 2-alkynyl-sn-1-hydroxide-rac-glycero-3-phosphothionate, 2-acyl-sn-1-hydroxide-rac-glycero-3-phosphothionate, 2-alkyl-sn-1-O-methyl-rac-glycero-3-phosphothionate, 2-alkenyl-sn-1-O-methyl-rac-glycero-3-phosphothionate, 2-alkynyl-sn-1-O-methyl-rac-glycero-3-phosphothionate, 2-acyl-sn-1-O-methyl-rac-glycero-3-phosphothionate, and derivatives thereof.

Exemplary LPA derivatives/analogs further include, but are not limited to, 1-lauryl-sn2-hydroxide-rac-glycero-3-phosphothionate, 1-myristyl-sn2-hydroxide-rac-glycero-3-phosphothionate, 1-palmityl-sn2-hydroxide-rac-glycero-3-phosphothionate, 1-stearyl-sn2-hydroxide-rac-glycero-3-phosphothionate, 1-oleyl-sn2-hydroxide-rac-glycero-3-phosphothionate, 1-linoleyl-sn2-hydroxide-rac-glycero-3-phosphothionate, 1-linolenyl-sn2-hydroxide-rac-glycero-3-phosphothionate, 1-eleosteryl-sn2-hydroxide-rac-glycero-3-phosphothionate, 1-lauryl-sn2-O-methyl-rac-glycero-3-phosphothionate, 1-myristyl-sn2-O-methyl-rac-glycero-3-phosphothionate, 1-palmityl-sn2-O-methyl-rac-glycero-3-phosphothionate, 1-stearyl-sn2-O-methyl-rac-glycero-3-phosphothionate, 1-oleyl-sn2-O-methyl-rac-glycero-3-phosphothionate, 1-linoleyl-sn2-O-methyl-rac-glycero-3-phosphothionate, 1-linolenyl-sn2-O-methyl-rac-glycero-3-phosphothionate, 1-eleosteryl-sn2-O-methyl-rac-glycero-3-phosphothionate, 1-lauroyl-sn2-hydroxide-rac-glycero-3-phosphothionate, 1-myristoyl-sn2-hydroxide-rac-glycero-3-phosphothionate, 1-palmitoyl-sn2-hydroxide-rac-glycero-3-phosphothionate, 1-stearoyl-sn2-hydroxide-rac-glycero-3-phosphothionate, 1-oleoyl-sn2-hydroxide-rac-glycero-3-phosphothionate, 1-linoleoyl-sn2-hydroxide-rac-glycero-3-phosphothionate, 1-linolenoyl-sn2-hydroxide-rac-glycero-3-phosphothionate, 1-eleosteroyl-sn2-hydroxide-rac-glycero-3-phosphothionate, 1-lauroyl-sn2-O-methyl-rac-glycero-3-phosphothionate, 1-myristoyl-sn2-O-methyl-rac-glycero-3-phosphothionate, 1-palmitoyl-sn2-O-methyl-rac-glycero-3-phosphothionate, 1-stearoyl-sn2-O-methyl-rac-glycero-3-phosphothionate, 1-oleoyl-sn2-O-methyl-rac-glycero-3-phosphothionate (OMPT), 1-linoleoyl-sn2-O-methyl-rac-glycero-3-phosphothionate, 1-linolenoyl-sn2-O-methyl-rac-glycero-3-phosphothionate, 1-eleosteroyl-sn2-O-methyl-rac-glycero-3-phosphothionate, 2-lauryl-sn-1-hydroxide-rac-glycero-3-phosphothionate, 2-myristyl-sn-1-hydroxide-rac-glycero-3-phosphothionate, 2-palmityl-sn-1-hydroxide-rac-glycero-3-phosphothionate, 2-stearyl-sn-1-hydroxide-rac-glycero-3-phosphothionate, 2-oleyl-sn-1-hydroxide-rac-glycero-3-phosphothionate, 2-linoleyl-sn-1-hydroxide-rac-glycero-3-phosphothionate, 2-linolenyl-sn-1-hydroxide-rac-glycero-3-phosphothionate, 2-eleosteryl-sn-1-hydroxide-rac-glycero-3-phosphothionate, 2-lauryl-sn-1-O-methyl-rac-glycero-3-phosphothionate, 2-myristyl-sn-1-O-methyl-rac-glycero-3-phosphothionate, 2-palmityl-sn-1-O-methyl-rac-glycero-3-phosphothionate, 2-stearoyl-sn-1-O-methyl-rac-glycero-3-phosphothionate, 2-oleyl-sn-1-O-methyl-rac-glycero-3-phosphothionate, 2-linoleyl-sn-1-O-methyl-rac-glycero-3-phosphothionate, 2-linolenyl-sn-1-O-methyl-rac-glycero-3-phosphothionate, 2-eleosteryl-sn-1-O-methyl-rac-glycero-3-phosphothionate, 2-lauroyl-sn-1-hydroxide-rac-glycero-3-phosphothionate, 2-myristoyl-sn-1-hydroxide-rac-glycero-3-phosphothionate, 2-palmitoyl-sn-1-hydroxide-rac-glycero-3-phosphothionate, 2-stearoyl-sn-1-hydroxide-rac-glycero-3-phosphothionate, 2-oleoyl-sn-1-hydroxide-rac-glycero-3-phosphothionate, 2-linoleoyl-sn-1-hydroxide-rac-glycero-3-phosphothionate, 2-linolenoyl-sn-1-hydroxide-rac-glycero-3-phosphothionate, 2-eleosteroyl-sn-1-hydroxide-rac-glycero-3-phosphothionate, 2-lauroyl-sn-1-O-methyl-rac-glycero-3-phosphothionate, 2-myristoyl-sn-1-O-methyl-rac-glycero-3-phosphothionate, 2-palmitoyl-sn-1-O-methyl-rac-glycero-3-phosphothionate, 2-stearoyl-sn-1-O-methyl-rac-glycero-3-phosphothionate, 2-oleoyl-sn-1-O-methyl-rac-glycero-3-phosphothionate, 2-linoleoyl-sn-1-O-methyl-rac-glycero-3-phosphothionate, 2-linolenoyl-sn-1-O-methyl-rac-glycero-3-phosphothionate, 2-eleosteroyl-sn-1-O-methyl-rac-glycero-3-phosphothionate, and derivatives thereof.

Additional exemplary LPA derivatives/analogs include, but are not limited to, 1-alkyl-sn2-hydroxide-rac-glycero-3-thiophosphonate, 1-alkenyl-sn2-hydroxide-rac-glycero-3-thiophosphonate, 1-alkynyl-sn2-hydroxide-rac-glycero-3-thiophosphonate, 1-acyl-sn2-hydroxide-rac-glycero-3-thiophosphonate, 1-alkyl-sn2-O-methyl-rac-glycero-3-thiophosphonate, 1-alkenyl-sn2-O-methyl-rac-glycero-3-thiophosphonate, 1-alkynyl-sn2-O-methyl-rac-glycero-3-thiophosphonate, 1-acyl-sn2-O-methyl-rac-glycero-3-thiophosphonate, and derivatives thereof.

In another embodiment, combinations of the substitutions at different functional groups result in additional compounds of the invention. For example, when the functional groups Y and X are both substituted, the LPA derivatives/analogs of the invention include LPA derivatives having phosphothionate or thiophosphonate groups with myo-inositol, cyano, and other substitutions, among others. Such LPA derivatives/analogs include, but are not limited to, 1-lauryl-sn2-O-methyl-rac-glycero-D-3-deoxy-myo-inositol-3-phosphothionate, 1-myristyl-sn2-O-methyl-rac-glycero-D-3-deoxy-myo-inositol-3-phosphothionate, 1-palmityl-sn2-O-methyl-rac-glycero-D-3-deoxy-myo-inositol-3-phosphothionate, 1-stearyl-sn2-O-methyl-rac-glycero-D-3-deoxy-myo-inositol-3-phosphothionate, 1-oleyl-sn2-O-methyl-rac-glycero-D-3-deoxy-myo-inositol-3-phosphothionate, 1-linoleyl-sn2-O-methyl-rac-glycero-D-3-deoxy-myo-inositol-3-phosphothionate, 1-linolenyl-sn2-O-methyl-rac-glycero-D-3-deoxy-myo-inositol-3-phosphothionate, 1-eleosteryl-sn2-O-methyl-rac-glycero-D-3-deoxy-myo-inositol-3-phosphothionate, 1-lauroyl-sn2-O-methyl-rac-glycero-D-3-deoxy-myo-inositol-3-phosphothionate 1-myristoyl-sn2-O-methyl-rac-glycero-D-3-deoxy-myo-inositol-3-phosphothionate, 1-palmitoyl-sn2-O-methyl-rac-glycero-D-3-deoxy-myo-inositol-3-phosphothionate, 1-stearoyl-sn2-O-methyl-rac-glycero-D-3-deoxy-myo-inositol-3-phosphothionate, 1-oleoyl-sn2-O-methyl-rac-glycero-D-3-deoxy-myo-inositol-3-phosphothionate, 1-linoleoyl-sn2-O-methyl-rac-glycero-D-3-deoxy-myo-inositol-3-phosphothionate, 1-linolenoyl-sn2-O-methyl-rac-glycero-D-3-deoxy-myo-inositol-3-phosphothionate, 1-eleosteroyl-sn2-O-methyl-rac-glycero-D-3-deoxy-myo-inositol-3-phosphothionate, 1-lauryl-sn2-hydroxide-rac-glycero-D-3-deoxy-myo-inositol-3-phosphothionate, 1-myristyl-sn2-hydroxide-rac-glycero-D-3-deoxy-myo-inositol-3-phosphothionate, 1-palmityl-sn2-hydroxide-rac-glycero-D-3-deoxy-myo-inositol-3-phosphothionate, 1-stearyl-sn2-hydroxide-rac-glycero-D-3-deoxy-myo-inositol-3-phosphothionate, 1-oleyl-sn2-hydroxide-rac-glycero-D-3-deoxy-myo-inositol-3-phosphothionate, 1-linoleyl-sn2-hydroxide-rac-glycero-D-3-deoxy-myo-inositol-3-phosphothionate, 1-linolenyl-sn2-hydroxide-rac-glycero-D-3-deoxy-myo-inositol-3-phosphothionate, 1-eleosteryl-sn2-hydroxide-rac-glycero-D-3-deoxy-myo-inositol-3-phosphothionate, 1-lauroyl-sn2-hydroxide-rac-glycero-D-3-deoxy-myo-inositol-3-phosphothionate 1-myristoyl-sn2-hydroxide-rac-glycero-D-3-deoxy-myo-inositol-3-phosphothionate, 1-palmitoyl-sn2-hydroxide-rac-glycero-D-3-deoxy-myo-inositol-3-phosphothionate, 1-stearoyl-sn2-hydroxide-rac-glycero-D-3-deoxy-myo-inositol-3-phosphothionate, 1-oleoyl-sn2-hydroxide-rac-glycero-D-3-deoxy-myo-inositol-3-phosphothionate, 1-linoleoyl-sn2-hydroxide-rac-glycero-D-3-deoxy-myo-inositol-3-phosphothionate, 1-linolenoyl-sn2-hydroxide-rac-glycero-D-3-deoxy-myo-inositol-3-phosphothionate, 1-eleosteroyl-sn2-hydroxide-rac-glycero-D-3-deoxy-myo-inositol-3-phosphothionate, and derivatives thereof.

Other examples include derivatives of 1-alkyl-2-hydroxide-rac-glycerophosphothionate, 1-acyl-2-hydroxide-rac-glycerophosphothionate, 1-alkyl-2-O-methyl-rac-glycerophosphothionate, 1-acyl-2-O-methyl-rac-glycerophosphothionate, among others, such as, 1-alkyl-2-hydroxide-rac-glycero-methylcyano-phosphothionate, 1-acyl-2-hydroxide-rac-glycero-methylcyano-phosphothionate, 1-alkyl-2-O-methyl-rac-glycero-methylcyano-phosphothionate, 1-acyl-2-O-methyl-rac-glycero-methylcyano-phosphothionate, 1-alkyl-2-hydroxide-rac-glycero-ethylcyano-phosphothionate, 1-acyl-2-hydroxide-rac-glycero-ethylcyano-phosphothionate, 1-alkyl-2-O-methyl-rac-glycero-ethylcyano-phosphothionate, 1-acyl-2-O-methyl-rac-glycero-ethylcyano-phosphothionate, and derivatives thereof.

In another embodiment, LPA derivatives/analogs may include a halogen group at any of the sn1, sn2, sn3 position as represented by Y, R¹, Z, A, and/or B. For example, in the formula I, II, III, IV, and V, Y can be a halogen, saturated and unsaturated haloakyl, saturated and unsaturated haloalkyloxy, when a halo group includes fluoro, chloro, bromo, and iodo, among others.

Examples of such LPA derivatives/analogs include, but are not limited to, 1-alkyl-sn2-hydroxide-rac-glycero-3-halophosphate, 1-alkenyl-sn2-hydroxide-rac-glycero-3-halophosphate, 1-alkynyl-sn2-hydroxide-rac-glycero-3-halophosphate, 1-acyl-sn2-hydroxide-rac-glycero-3-halophosphate, 1-alkyl-sn2-O-methyl-rac-glycero-3-halophosphate, 1-alkenyl-sn2-O-methyl-rac-glycero-3-halophosphate, 1-alkynyl-sn2-O-methyl-rac-glycero-3-halophosphate, 1-acyl-sn2-O-methyl-rac-glycero-3-halophosphate, 1-alkyl-sn2-hydroxide-rac-glycero-3-halophosphothionate, 1-alkenyl-sn2-hydroxide-rac-glycero-3-halophosphothionate, 1-alkynyl-sn2-hydroxide-rac-glycero-3-halophosphothionate, 1-acyl-sn2-hydroxide-rac-glycero-3-halophosphothionate, 1-alkyl-sn2-O-methyl-rac-glycero-3-halophosphothionate, 1-alkenyl-sn2-O-methyl-rac-glycero-3-halophosphothionate, 1-alkynyl-sn2-O-methyl-rac-glycero-3-halophosphothionate, 1-acyl-sn2-O-methyl-rac-glycero-3-halophosphothionate, 1-alkyl-sn2-hydroxide-rac-glycero-3-halophosphonate, 1-alkenyl-sn2-hydroxide-rac-glycero-3-halophosphonate, 1-alkynyl-sn2-hydroxide-rac-glycero-3-halophosphonate, 1-acyl-sn2-hydroxide-rac-glycero-3-halophosphonate, 1-alkyl-sn2-O-methyl-rac-glycero-3-halophosphonate, 1-alkenyl-sn2-O-methyl-rac-glycero-3-halophosphonate, 1-alkynyl-sn2-O-methyl-rac-glycero-3-halophosphonate, 1-acyl-sn2-O-methyl-rac-glycero-3-halophosphonate, and derivatives thereof.

Such haloderivatives of LPA analogs include, but are not limited to, 1-alkyl-sn2-hydroxide-rac-glycero-3-fluorophosphate, 1-alkenyl-sn2-hydroxide-rac-glycero-3-fluorophosphate, 1-alkynyl-sn2-hydroxide-rac-glycero-3-fluorophosphate, 1-acyl-sn2-hydroxide-rac-glycero-3-fluorophosphate, 1-alkyl-sn2-O-methyl-rac-glycero-3-fluorophosphate, 1-alkenyl-sn2-O-methyl-rac-glycero-3-fluorophosphate, 1-alkynyl-sn2-O-methyl-rac-glycero-3-fluorophosphate, 1-acyl-sn2-O-methyl-rac-glycero-3-fluorophosphate, 1-alkyl-sn2-hydroxide-rac-glycero-3-bromophosphate, 1-alkenyl-sn2-hydroxide-rac-glycero-3-bromophosphate, 1-alkynyl-sn2-hydroxide-rac-glycero-3-bromophosphate, 1-acyl-sn2-hydroxide-rac-glycero-3-bromophosphate, 1-alkyl-sn2-O-methyl-rac-glycero-3-bromophosphate, 1-alkenyl-sn2-O-methyl-rac-glycero-3-bromophosphate, 1-alkynyl-sn2-O-methyl-rac-glycero-3-bromophosphate, 1-acyl-sn2-O-methyl-rac-glycero-3-bromophosphate, and derivatives thereof.

Additionally, 1-lauryl-sn2-hydroxide-rac-glycero-3-fluorophosphate, 1-myristyl-sn2-hydroxide-rac-glycero-3-fluorophosphate, 1-palmityl-sn2-hydroxide-rac-glycero-3-fluorophosphate, 1-stearyl-sn2-hydroxide-rac-glycero-3-fluorophosphate, 1-oleyl-sn2-hydroxide-rac-glycero-3-fluorophosphate, 1-linoleyl-sn2-hydroxide-rac-glycero-3-fluorophosphate, 1-linolenyl-sn2-hydroxide-rac-glycero-3-fluorophosphate, 1-eleosteryl-sn2-hydroxide-rac-glycero-3-fluorophosphate, 1-lauryl-sn2-O-methyl-rac-glycero-3-fluorophosphate, 1-myristyl-sn2-O-methyl-rac-glycero-3-fluorophosphate, 1-palmityl-sn2-O-methyl-rac-glycero-3-fluorophosphate, 1-stearyl-sn2-O-methyl-rac-glycero-3-fluorophosphate, 1-oleyl-sn2-O-methyl-rac-glycero-3-fluorophosphate, 1-linoleyl-sn2-O-methyl-rac-glycero-3-fluorophosphate, 1-linolenyl-sn2-O-methyl-rac-glycero-3-fluorophosphate, 1-eleosteryl-sn2-O-methyl-rac-glycero-3-fluorophosphate, 1-myristoyl-sn2-hydroxide-rac-glycero-3-fluorophosphate, 1-palmitoyl-sn2-hydroxide-rac-glycero-3-fluorophosphate, 1-stearoyl-sn2-hydroxide-rac-glycero-3-fluorophosphate, 1-oleoyl-sn2-hydroxide-rac-glycero-3-fluorophosphate, 1-linoleoyl-sn2-hydroxide-rac-glycero-3-fluorophosphate, 1-linolenoyl-sn2-hydroxide-rac-glycero-3-fluorophosphate, 1-eleosteroyl-sn2-hydroxide-rac-glycero-3-fluorophosphate, 1-lauroyl-sn2-O-methyl-rac-glycero-3-fluorophosphate, 1-myristoyl-sn2-O-methyl-rac-glycero-3-fluorophosphate, 1-palmitoyl-sn2-O-methyl-rac-glycero-3-fluorophosphate, 1-stearoyl-sn2-O-methyl-rac-glycero-3-fluorophosphate, 1-oleoyl-sn2-O-methyl-rac-glycero-3-fluorophosphate, 1-linoleoyl-sn2-O-methyl-rac-glycero-3-fluorophosphate, 1-linolenoyl-sn2-O-methyl-rac-glycero-3-fluorophosphate, 1-eleosteroyl-sn2-O-methyl-rac-glycero-3-fluorophosphate, and derivatives thereof may be included.

Other examples may include 1-lauryl-sn2-hydroxide-rac-glycero-3-bromophosphate, 1-myristyl-sn2-hydroxide-rac-glycero-3-bromophosphate, 1-palmityl-sn2-hydroxide-rac-glycero-3-bromophosphate, 1-stearyl-sn2-hydroxide-rac-glycero-3-bromophosphate, 1-oleyl-sn2-hydroxide-rac-glycero-3-bromophosphate, 1-linoleyl-sn2-hydroxide-rac-glycero-3-bromophosphate, 1-linolenyl-sn2-hydroxide-rac-glycero-3-bromophosphate, 1-eleosteryl-sn2-hydroxide-rac-glycero-3-bromophosphate, 1-lauryl-sn2-O-methyl-rac-glycero-3-bromophosphate, 1-myristyl-sn2-O-methyl-rac-glycero-3-bromophosphate, 1-palmityl-sn2-O-methyl-rac-glycero-3-bromophosphate, 1-stearyl-sn2-O-methyl-rac-glycero-3-bromophosphate, 1-oleyl-sn2-O-methyl-rac-glycero-3-bromophosphate, 1-linoleyl-sn2-O-methyl-rac-glycero-3-bromophosphate, 1-linolenyl-sn2-O-methyl-rac-glycero-3-bromophosphate, 1-eleosteryl-sn2-O-methyl-rac-glycero-3-bromophosphate, 1-lauroyl-sn2-hydroxide-rac-glycero-3-bromophosphate, 1-myristoyl-sn2-hydroxide-rac-glycero-3-bromophosphate, 1-palmitoyl-sn2-hydroxide-rac-glycero-3-bromophosphate, 1-stearoyl-sn2-hydroxide-rac-glycero-3-bromophosphate, 1-oleoyl-sn2-hydroxide-rac-glycero-3-bromophosphate, 1-linoleoyl-sn2-hydroxide-rac-glycero-3-bromophosphate, 1-linolenoyl-sn2-hydroxide-rac-glycero-3-bromophosphate, 1-eleosteroyl-sn2-hydroxide-rac-glycero-3-bromophosphate, 1-lauroyl-sn2-O-methyl-rac-glycero-3-bromophosphate, 1-myristoyl-sn2-O-methyl-rac-glycero-3-bromophosphate, 1-palmitoyl-sn2-O-methyl-rac-glycero-3-bromophosphate, 1-stearoyl-sn2-O-methyl-rac-glycero-3-bromophosphate, 1-oleoyl-sn2-O-methyl-rac-glycero-3-bromophosphate, 1-linoleoyl-sn2-O-methyl-rac-glycero-3-bromophosphate, 1-linolenoyl-sn2-O-methyl-rac-glycero-3-bromophosphate, 1-eleosteroyl-sn2-O-methyl-rac-glycero-3-bromophosphate, and derivatives thereof.

Further, LPA derivatives, such as 1-lauryl-sn2-hydroxide-rac-glycero-3-fluorophosphonate, 1-myristyl-sn2-hydroxide-rac-glycero-3-fluorophosphonate, 1-palmityl-sn2-hydroxide-rac-glycero-3-fluorophosphonate, 1-stearyl-sn2-hydroxide-rac-glycero-3-fluorophosphonate, 1-oleyl-sn2-hydroxide-rac-glycero-3-fluorophosphonate, 1-linoleyl-sn2-hydroxide-rac-glycero-3-fluorophosphonate, 1-linolenyl-sn2-hydroxide-rac-glycero-3-fluorophosphonate, 1-eleosteryl-sn2-hydroxide-rac-glycero-3-fluorophosphonate, 1-lauroyl-sn2-O-methyl-rac-glycero-3-fluorophosphonate, 1-myristoyl-sn2-O-methyl-rac-glycero-3-fluorophosphonate, 1-palmityl-sn2-O-methyl-rac-glycero-3-fluorophosphonate, 1-stearyl-sn2-O-methyl-rac-glycero-3-fluorophosphonate, 1-oleyl-sn2-O-methyl-rac-glycero-3-fluorophosphonate, 1-linoleyl-sn2-O-methyl-rac-glycero-3-fluorophosphonate, 1-linolenyl-sn2-O-methyl-rac-glycero-3-fluorophosphonate, 1-eleosteryl-sn2-O-methyl-rac-glycero-3-fluorophosphonate, 1-lauroyl-sn2-hydroxide-rac-glycero-3-fluorophosphonate, 1-myristoyl-sn2-hydroxide-rac-glycero-3-fluorophosphonate, 1-palmitoyl-sn2-hydroxide-rac-glycero-3-fluorophosphonate, 1-stearoyl-sn2-hydroxide-rac-glycero-3-fluorophosphonate, 1-oleoyl-sn2-hydroxide-rac-glycero-3-fluorophosphonate, 1-linoleoyl-sn2-hydroxide-rac-glycero-3-fluorophosphonate, 1-linolenoyl-sn2-hydroxide-rac-glycero-3-fluorophosphonate, 1-eleosteroyl-sn2-hydroxide-rac-glycero-3-fluorophosphonate, 1-lauroyl-sn2-O-methyl-rac-glycero-3-fluorophosphonate, 1-myristoyl-sn2-O-methyl-rac-glycero-3-fluorophosphonate, 1-palmitoyl-sn2-O-methyl-rac-glycero-3-fluorophosphonate, 1-stearoyl-sn2-O-methyl-rac-glycero-3-fluorophosphonate, 1-oleoyl-sn2-O-methyl-rac-glycero-3-fluorophosphonate, 1-linoleoyl-sn2-O-methyl-rac-glycero-3-fluorophosphonate, 1-linolenoyl-sn2-O-methyl-rac-glycero-3-fluorophosphonate, 1-eleosteroyl-sn2-O-methyl-rac-glycero-3-fluorophosphonate, and derivatives thereof, may be included.

Additional LPA derivatives include 1-lauryl-sn2-hydroxide-rac-glycero-3-bromophosphonate, 1-myristyl-sn2-hydroxide-rac-glycero-3-bromophosphonate, 1-palmityl-sn2-hydroxide-rac-glycero-3-bromophosphonate, 1-stearyl-sn2-hydroxide-rac-glycero-3-bromophosphonate, 1-oleyl-sn2-hydroxide-rac-glycero-3-bromophosphonate, 1-linoleyl-sn2-hydroxide-rac-glycero-3-bromophosphonate, 1-linolenyl-sn2-hydroxide-rac-glycero-3-bromophosphonate, 1-eleosteryl-sn2-hydroxide-rac-glycero-3-bromophosphonate, 1-lauryl-sn2-O-methyl-rac-glycero-3-bromophosphonate, 1-myristyl-sn2-O-methyl-rac-glycero-3-bromophosphonate, 1-palmityl-sn2-O-methyl-rac-glycero-3-bromophosphonate, 1-stearyl-sn2-O-methyl-rac-glycero-3-bromophosphonate, 1-oleyl-sn2-O-methyl-rac-glycero-3-bromophosphonate, 1-linoleyl-sn2-O-methyl-rac-glycero-3-bromophosphonate, 1-linolenyl-sn2-O-methyl-rac-glycero-3-bromophosphonate, 1-eleosteryl-sn2-O-methyl-rac-glycero-3-bromophosphonate, 1-lauroyl-sn2-hydroxide-rac-glycero-3-bromophosphonate, 1-myristoyl-sn2-hydroxide-rac-glycero-3-bromophosphonate, 1-palmitoyl-sn2-hydroxide-rac-glycero-3-bromophosphonate, 1-stearoyl-sn2-hydroxide-rac-glycero-3-bromophosphonate, 1-oleoyl-sn2-hydroxide-rac-glycero-3-bromophosphonate, 1-linoleoyl-sn2-hydroxide-rac-glycero-3-bromophosphonate, 1-linolenoyl-sn2-hydroxide-rac-glycero-3-bromophosphonate, 1-eleosteroyl-sn2-hydroxide-rac-glycero-3-bromophosphonate, 1-lauroyl-sn2-O-methyl-rac-glycero-3-bromophosphonate, 1-myristoyl-sn2-O-methyl-rac-glycero-3-bromophosphonate, 1-palmitoyl-sn2-O-methyl-rac-glycero-3-bromophosphonate, 1-stearoyl-sn2-O-methyl-rac-glycero-3-bromophosphonate, 1-oleoyl-sn2-O-methyl-rac-glycero-3-bromophosphonate, 1-linoleoyl-sn2-O-methyl-rac-glycero-3-bromophosphonate, 1-linolenoyl-sn2-O-methyl-rac-glycero-3-bromophosphonate, 1-elesteroyl-sn2-O-methyl-rac-glycero-3-bromophosphonate, and derivatives thereof.

In still another embodiment, in the formula I, II, III, IV, and V, each of A and B may be independently a hydrogen, hydroxyl, halogen, saturated and unsaturated haloakyl, saturated and unsaturated haloalkyloxy, when a halo group includes fluoro, chloro, bromo, or iodo, among others. Such haloderivatives of LPA analogs include, but are not limited to, 1-alkyl-sn2-hydroxide-sn3-halo-rac-glycero-3-phosphate, 1-alkenyl-sn2-hydroxide-sn3-halo-rac-glycero-3-phosphate, 1-alkynyl-sn2-hydroxide-sn3-halo-rac-glycero-3-phosphate, 1-acyl-sn2-hydroxide-sn3-halo-rac-glycero-3-phosphate, 1-alkyl-sn2-O-methyl-sn3-halo-rac-glycero-3-phosphate, 1-alkenyl-sn2-O-methyl-sn3-halo-rac-glycero-3-phosphate, 1-alkynyl-sn2-O-methyl-sn3-halo-rac-glycero-3-phosphate, 1-acyl-sn2-O-methyl-sn3-halo-rac-glycero-3-phosphate, 1-alkyl-sn2-hydroxide-sn3-halo-rac-glycero-3-phosphothionate, 1-alkenyl-sn2-hydroxide-sn3-halo-rac-glycero-3-phosphothionate, 1-alkynyl-sn2-hydroxide-sn3-halo-rac-glycero-3-phosphothionate, 1-acyl-sn2-hydroxide-sn3-halo-rac-glycero-3-phosphothionate, 1-alkyl-sn2-O-methyl-sn3-halo-rac-glycero-3-phosphothionate, 1-alkenyl-sn2-O-methyl-sn3-halo-rac-glycero-3-phosphothionate, 1-alkynyl-sn2-O-methyl-sn3-halo-rac-glycero-3-phosphothionate, 1-acyl-sn2-O-methyl-sn3-halo-rac-glycero-3-phosphothionate, 1-alkyl-sn2-hydroxide-sn3-halo-rac-glycero-3-phosphonate, 1-alkenyl-sn2-hydroxide-sn3-halo-rac-glycero-3-phosphonate, 1-alkynyl-sn2-hydroxide-sn3-halo-rac-glycero-3-phosphonate, 1-acyl-sn2-hydroxide-sn3-halo-rac-glycero-3-phosphonate, 1-alkyl-sn2-O-methyl-sn3-halo-rac-glycero-3-phosphonate, 1-alkenyl-sn2-O-methyl-sn3-halo-rac-glycero-3-phosphonate, 1-alkynyl-sn2-O-methyl-sn3-halo-rac-glycero-3-phosphonate, 1-acyl-sn2-O-methyl-sn3-halo-rac-glycero-3-phosphonate, and derivatives thereof.

In addition, A and B may both be a halogen, saturated and unsaturated haloakyl, saturated and unsaturated haloalkyloxy, among others, including 1-alkyl-sn2-hydroxide-sn3-dihalo-rac-glycero-3-phosphate, 1-alkenyl-sn2-hydroxide-sn3-dihalo-rac-glycero-3-phosphate, 1-alkynyl-sn2-hydroxide-sn3-dihalo-rac-glycero-3-phosphate, 1-acyl-sn2-hydroxide-sn3-dihalo-rac-glycero-3-phosphate, 1-alkyl-sn2-O-methyl-sn3-dihalo-rac-glycero-3-phosphate, 1-alkenyl-sn2-O-methyl-sn3-dihalo-rac-glycero-3-phosphate, 1-alkynyl-sn2-O-methyl-sn3-dihalo-rac-glycero-3-phosphate, 1-acyl-sn2-O-methyl-sn3-dihalo-rac-glycero-3-phosphate, 1-alkyl-sn2-hydroxide-sn3-dihalo-rac-glycero-3-phosphothionate, 1-alkenyl-sn2-hydroxide-sn3-dihalo-rac-glycero-3-phosphothionate, 1-alkynyl-sn2-hydroxide-sn3-dihalo-rac-glycero-3-phosphothionate, 1-acyl-sn2-hydroxide-sn3-dihalo-rac-glycero-3-phosphothionate, 1-alkyl-sn2-O-methyl-sn3-dihalo-rac-glycero-3-phosphothionate, 1-alkenyl-sn2-O-methyl-sn3-dihalo-rac-glycero-3-phosphothionate, 1-alkynyl-sn2-O-methyl-sn3-dihalo-rac-glycero-3-phosphothionate, 1-acyl-sn2-O-methyl-sn3-dihalo-rac-glycero-3-phosphothionate, 1-alkyl-sn2-hydroxide-sn3-dihalo-rac-glycero-3-phosphonate, 1-alkenyl-sn2-hydroxide-sn3-dihalo-rac-glycero-3-phosphonate, 1-alkynyl-sn2-hydroxide-sn3-dihalo-rac-glycero-3-phosphonate, 1-acyl-sn2-hydroxide-sn3-dihalo-rac-glycero-3-phosphonate, 1-alkyl-sn2-O-methyl-sn3-dihalo-rac-glycero-3-phosphonate, 1-alkenyl-sn2-O-methyl-sn3-dihalo-rac-glycero-3-phosphonate, 1-alkynyl-sn2-O-methyl-sn3-dihalo-rac-glycero-3-phosphonate, 1-acyl-sn2-O-methyl-sn3-dihalo-rac-glycero-3-phosphonate, and derivatives thereof.

In still another embodiment, it is further contemplated that compounds of LPA derivatives may contain substitutions at both sn2 and sn3 positions to include cyclic glycerol derivatives, such as 1-alkyl-sn-2,3-cyclic-glycero-3-phosphothionate, 1-alkenyl-sn-2,3-cyclic-glycero-3-phosphothionate, 1-alkynyl-sn-2,3-cyclic-glycero-3-phosphothionate, 1-acyl-sn-2,3-cyclic-glycero-3-phosphothionate, 1-alkyl-sn-2,3-cyclic-glycero-3-phosphonate, 1-alkenyl-sn-2,3-cyclic-glycero-3-phosphonate, 1-alkynyl-sn-2,3-cyclic-glycero-3-phosphonate, 1-acyl-sn-2,3-cyclic-glycero-3-phosphonate, 1-alkyl-sn-2,3-cyclic-glycero-3-phosphonate, 1-alkenyl-sn-2,3-cyclic-glycero-3-phosphonate, 1-alkynyl-sn-2,3-cyclic-glycero-3-phosphonate, 1-acyl-sn-2,3-cyclic-glycero-3-phosphonate, 1-alkyl-sn-2,3-cyclic-glycero-3-phosphonate, 1-alkenyl-sn-2,3-cyclic-glycero-3-phosphonate, 1-alkynyl-sn-2,3-cyclic-glycero-3-phosphonate, 1-acyl-sn-2,3-cyclic-glycero-3-phosphonate, and derivatives thereof, among others.

Pharmaceutically acceptable salts of the phospholipids encompassed by the present invention, include, but are not limited to, free acid forms, alkali metal salts, such as sodium and potassium, alkaline earth metal salts, such as calcium and magnesium, non-toxic heavy metal salts, ammonium salts, trialkylammonium salts, such as trimethyl-ammonium and triethylammonium, and alkoxyammonium salts, such as triethanolammonium, tri(2-hydroxyethyl)ammonium, and tromethamine (tris(hydroxymethyl)aminomethane). Particularly preferred are sodium and ammonium salts.

Mimetics encompassed by the present invention, include, but are not limited to, synthetic compounds that are developed using the biological system of LPA signaling. Stereoisomers encompassed by the present invention, include, but are not limited to, compounds that have the same kinds and numbers of atoms but have different molecular arrangements. Enantiomers encompassed by the present invention, include, but are not limited to, a pair of chiral isomers (e.g., R and S isomers) that are direct, nonsuperimposable mirror images of each other.

Derivatives and analogs encompassed by the present invention, include, but are not limited to, substitutions on any of the R, X, Y, and Z groups, such as, among others, saturated or unsaturated alkyl derivatives, straight or branched derivatives, mimetics, stereoisomers, and enantiomers thereof.

### II. Obtaining the Compounds

A suitable LPA derivative can be obtained from any source including, but not limited to, commercially available phospholipids, isolated from a variety of different plants (including plant organs) and animals, and/or created synthetically. Preferably the plants are in the soybean family, but the phospholipids can be isolated from other plants including, but not limited to, those in the leguminosae (beans and peas, etc.). The phospholipids can also be isolated from partially purified plant extracts including, but not limited to, soy molasses, lecithin (fluid, deoiled or other forms), partially purified protein concentrates, partially purified protein hydrolysates, defatted soy flakes, refined soy oils, soy grits, soy flours and other soy fractions from which lipids can be extracted. An example of lipid extraction from soybeans may be found in U.S. Pat. No. 3,365,440. In addition, U.S. Pat. Nos. 5,567,425; 5,602,885; 5,624,675; 5,635,186; 5,635,187 include general descriptions of a variety of techniques useful in the art for synthesizing and obtaining phospholipid compounds.

The LPA derivative can be obtained from plant sources by any method known in the art, provided it results in purification of at least one of the phospholipids of the invention. A variety of methods for purifying and analyzing phospholipids from plant sources are described in Bligh and Dyer (1959) Can. J. Biochem. Physiol. 37:911-917; Patton et al. (1982) J. Lipid Res. 23:190-196; Jungalwala (1985) Recent Developments in Techniques for Phospholipid Analysis, in Phospholipids in Nervous Tissues (ed. Eichberg) John Wiley and Sons, pp. 1-44; Hamilton et al. (1992) in the series, A Practical Approach (Rickwood et al. eds.) IRL Press at Oxford University Press; and Kates (1986) Techniques of Lipidology: Isolation, Analysis and Identification in Laboratory Techniques in Biochemistry and Molecular Biology (Burdon et al. eds.) Elsevier.

The LPA derivative can also be derived from animal sources. Preferably, the animal is a mammal. Even more preferably, the phospholipids are derived from liver cells. Such phospholipids are commercially available or can be purified from animal tissue by methods known in the art, for instance from animal and egg lecithin or from the compositions described in WO 95/15173, which is incorporated herein by reference. Phospholipids in general, and LPAs in particular, can also be derived from blood.

The LPA derivative of the invention can also be synthesized by methods known in the art. Suitable semi-synthetic phospholipids and their synthesis are described in Kates, Techniques of Lipidology (1972). For example, a synthesis of lysophosphatidic acid is described in W. Stoffel and G. D. Wolf, Chemische Synthese von 1-O-[3H]Palmitoyl-L-glycerin-3-phosphate (L-3-Lysophosphatidsaure), Chem. Ber., 347 (1966) 94-101. As another example, the synthesis of various cyclic phosphate LPAs is described in A. J. Slotboom, et al., Synthesis of Lysophosphoglycerides, Chem. Phys. Lipids, 1 (1967) 317-336; PCT Publication No. WO 92/21323; and U.S. Pat. No. 5,565,439, which are incorporated herein by reference.

Procedures for synthesis of functionalized glycerol ether derivatives which can be used in the synthesis of compounds suitable for use in the present invention are described in K. Agarwal, et al., Synthesis of carbamyl and ether analogs of phosphatidylcholines, Chem. Phys. Lipids, 39 (1984) 169-177, and H. Eibl and P. Woolley, A general synthetic method for enantiomerically pure ester and ether lysophospholipids, Chem. Phys. Lipids, 47 (1988) 63-68. A method for the preparation of lysophosphatidic acid or lysophosphatidates by reacting glycidyl esters with anhydrous phosphoric acid is described in U.S. Pat. No. 3,423,440.

### III. LPA Derivatives/Analogs as LPA Receptor Subtype Specific Inhibitor

In one embodiment, the invention provides selective modulators, such as agonists and/or antagonists for various LPA receptor subtypes, such as LPA1, LPA2, LPA3, LPA4, and the like.

1. LPA Receptor Subtypes for LPA Signaling

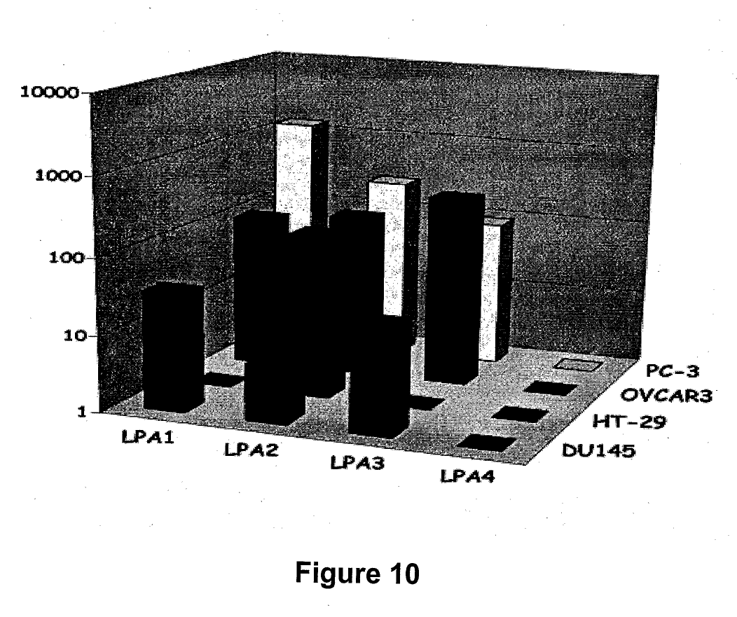

The biological responses to various LPAs are mediated by specific members of the LPA receptor family, such as LPA1, LPA2, LPA3 and LPA4 receptors. These receptors exhibit high affinity for LPAs (e.g., LPA14:0, LPA 18:1, etc.) and their expression levels may vary among different cells. For example, LPA 1 is widely expressed in normal cells and cancer cells, such as the ovarian cancer cell line, OVCAR3, the prostate cancer cell line, PC-3, and the like. LPA2 and LPA3 are expressed at low levels, if at all, in normal adult tissues. However, LPA2 and LPA3 are present in some cancer cell lines, such as ovarian cancer cell lines (OVCAR3) and prostate cancer cell lines (e.g., PC-3 and DU145). For example, ovarian cancer OVCAR3 cells express high levels of LPA3 mRNA. As shown in FIG. 10, quantitative-PCR analysis indicates that OVCAR3 cells express a high level of LPA3 mRNA, a medium level of LPA2 mRNA, a low level of LPA1 mRNA, and negligible expression level of LPA4 mRNA, whereas colon cancer HT29 cells express medium level of LPA2 mRNA and negligible expression levels of LPA1, LPA3, and LPA4 mRNA.

In addition, the invention provides evidence that LPA1, LPA2, and LPA3 mRNA and protein expression are present in prostate cancer cell lines through RT-PCR and functional calcium mobilization assays, as described in more detail below. In contrast, LPA4 mRNA is not expressed in the prostate cancer cell line PC-3, eliminating it as a target for LPA signaling in this prostate cancer cell line) other cells may have different expression). Further, transcriptional profiling data using Affymetrix arrays demonstrates expression of LPA1, LPA2, and LPA3 in prostate cancer patients. Thus, LPA2 and LPA3 may be attractive targets for the design and testing of novel therapeutic compounds for cancer therapy.

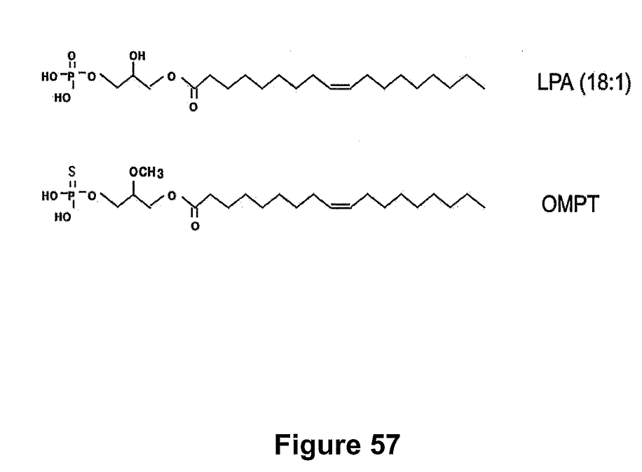

It has been observed that 14:0 LPA is an LPA2 selective agonist that stimulates LPA2 signaling, whereas 18:1 LPA is a pan LPA agonist that stimulates LPA1, LPA2, and LPA3 signaling. In addition, an LPA analog, 1-oleoyl-sn2-O-methyl-rac-glycero-3-phosphothionate (OMPT) stimulates LPA3 signaling and is a selective LPA3 agonist. FIG. 57 compares the structure of 18:1 LPA and OMPT. These findings are confirmed by a calcium mobilization assay, which measures changes in intracellular calcium concentration, [Ca²⁺], which acts as a surrogate for receptor activation since calcium is an important intracellular mediator and LPA is a potent activator for increases in cytosolic calcium.

The procedures for these calcium mobilization assays are as followed: OVCAR3 cells and PC-3 cells were cultured in RPMI 1640 medium with 10% FBS (fetal bovine serum). HT29 cells were cultured in DMEM (high glucose) medium with 10% FBS. All cells were cultured at about 37° C. in a humidified atmosphere with 5% CO₂. After starvation in serum-free medium for about 12-24 hours, cells were harvested and loaded with about 1 μM of Indo-1 AM in serum-free medium for about 45 min at 37° C. Cells were washed in PBS and resuspended at 2×10⁶ cells/ml in a [Ca²⁺]i assay buffer (Sodium chloride, NaCl, about 140 mM, potassium chloride, KCl, about 2 mM, magnesium chloride, MgCl₂, about 1 mM, calcium chloride, CaCl₂, about 2 mM, in about 25 mM HEPES buffer at pH 7.4 with about 10 mM of glucose). Cytoplasmic [Ca²⁺]i was determined at an excitation wavelength of about 331 nm and an emission wavelength of 410 nm using a fluorescence spectrophotometer (Hitachi, F-4000). Approximately 3×10⁶ cells were used for [Ca²⁺]ₗ determination in a stirred quartz cuvette kept at about 37° C. OMPT or 18:1 LPA was dissolved in about 0.1% BSA/PBS solution and applied immediately to the cells. To test other LPA derivatives of the invention, cells were exposed to the derivatives for about 3 minutes or for a period of various times in time course related experiments before a LPA agonist, such as 18:1 LPA, OMPT, or other LPAs was applied into the cuvette.

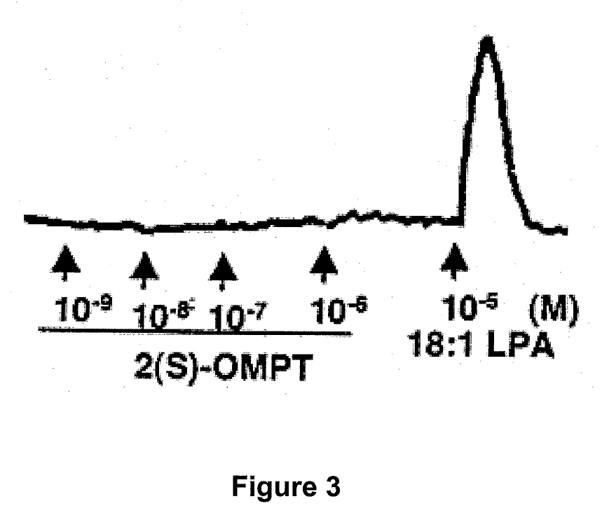

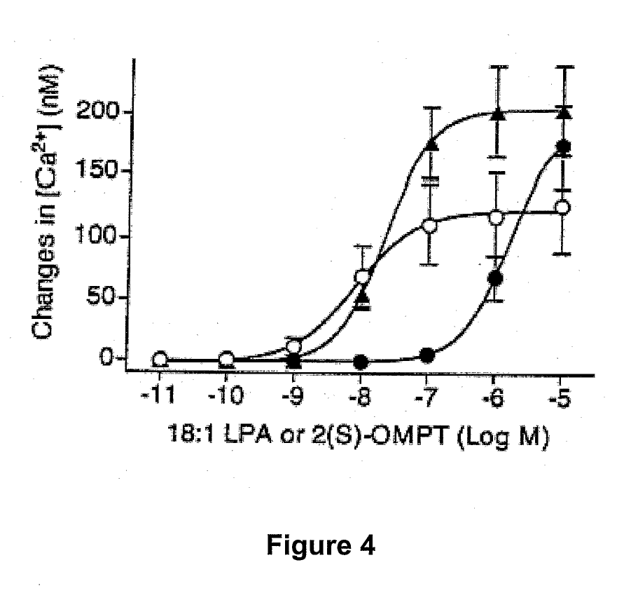

The results of a typical calcium mobilization assay are shown in FIG. 3. FIG. 3 demonstrates the effect of OMPT-induced and 18:1 LPA-induced calcium mobilization in colon cancer cells (HT29). As shown in FIG. 3, 18:1 LPA, but not OMPT, stimulates calcium mobilization in HT29 cells. FIG. 4 demonstrates the concentration-response curves of OMPT and 18:1 LPA on calcium mobilization in OVCAR3 and HT29 cells. The open circles indicate OMPT induction in OVCAR3 cells. The closed circles indicate OMPT induction in HT29 cells. The closed triangles indicate 18:1 LPA induction in HT29 cells. The EC₅₀ values of OMPT and 18:1 LPA in HT29 cells are less than about 1 μM and about 22.1 nM (about 8.2 to about 59.2 nM), respectively. The EC₅₀ values of OMPT in OVCAR3 cells is about 9.0 nM (about 7.0 nM to about 11.5 nM). Thus, LPA3 is not expressed in HT29 cells.

The concentration of calcium mobilization giving the half-maximal response (EC50) was obtained from the concentration-response curve fitted to a sigmoidal logistic equation, with the maximal calcium response set to 100% using the GraphPad Prism. Maximal response value is expressed as mean +/−s.e.m. EC₅₀ value is expressed with 95% confidence.

In addition, calcium mobilization assays for these LPA lysophospholipids can be tested in insect cells, e.g., Sf9 cells, which do not contain LPA receptors in their genome, to provide a sensitive and selective model for dissecting LPA signaling. Each of the lysophospholipids desensitized calcium mobilization, suggesting that the effects of lysophospholipids are mediated by G-protein coupled LPA receptors.

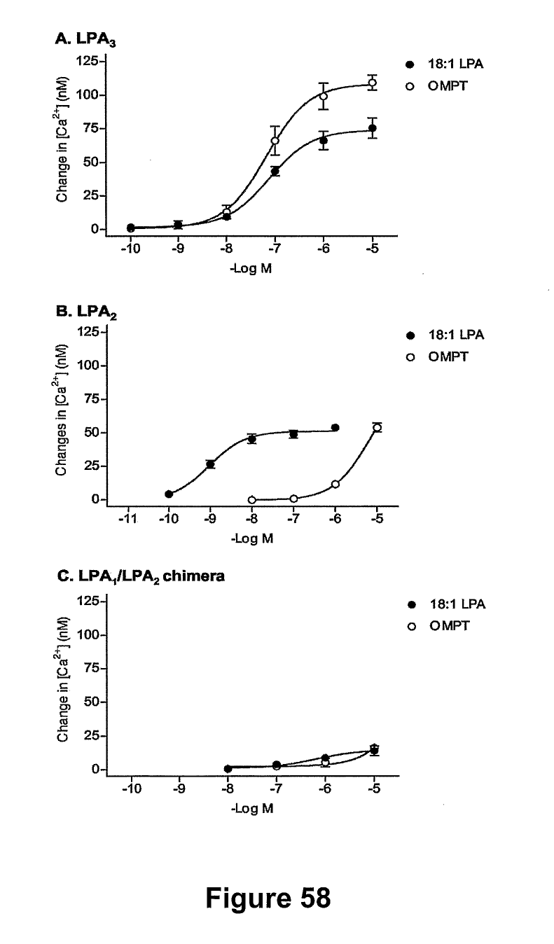

OMPT efficiently activates calcium mobilization in LPA3 expressing Sf9 cells. FIG. 58A demonstrates that OMPT induces calcium mobilization in Sf9 cells transfected to express the LPA3 receptor. FIG. 58B demonstrates that OMPT did not induce calcium mobilization through the LPA2 receptor when Sf9 cells were transfected to express the LPA2 receptor. FIG. 58C demonstrates that OMPT did not induce calcium mobilization in Sf9 cells transfected to express a chimera receptor, LPA1/LPA2. It is concluded that OMPT is a selective LPA3 agonist since OMPT increases intracellular calcium concentration with an EC₅₀ of 69 nM, >10,000 nM, and >10,000 nM in Sf9 insect cells expressing extrageneous LPA3, LPA1, and LPA2 receptor cDNAs, respectively.

Further, 18:1 LPA is an agonist for LPA2 and LPA3, since 18:1 LPA increases intracellular calcium concentration with an EC₅₀ of 0.84 nM and 76 nM in Sf9 insect cells expressing extrageneous LPA2 and LPA3 receptor cDNAs, respectively. On the other hand, 14:0 LPA is a selective LPA2 agonist, since 14:0 LPA increases intracellular calcium concentration with an EC₅₀ of 0.1 nM in Sf9 insect cells expressing extrageneous LPA2 receptor cDNA. However, no elevated intracellular calcium concentration is observed in 14:0 LPA treated Sf9 insect cells expressing extrageneous LPA1 and LPA3 receptor cDNA. Thus, OMPT and 14:0 LPA serve as selective modulators for LPA3 and LPA2 receptors, respectively.

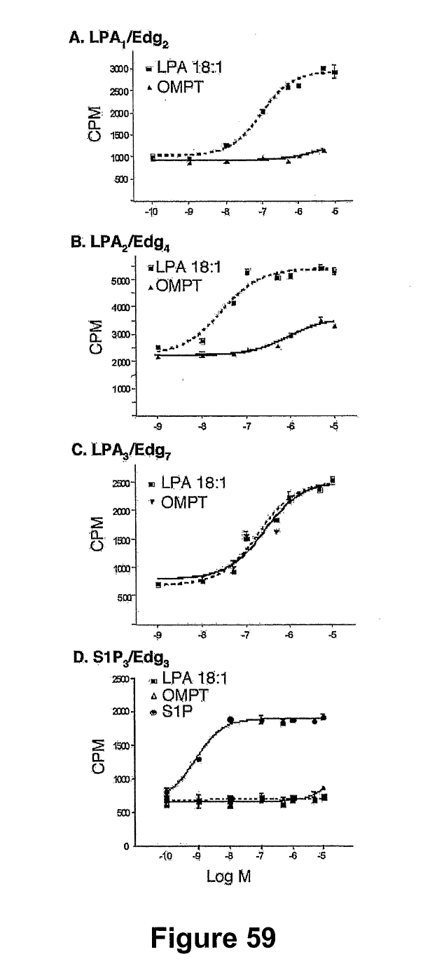

OMPT also enhances GTP [γ-³⁵S] binding in the cell membrane of HEK293 T cells expressing LPA3. The procedures for these GTP [γ-³⁵S] binding assays involve co-transfection of HEK293 T cells with expression vectors encoding one of the receptors for LPA (LPA1, LPA2, or LPA3) or S1P (S1P3/Edg3) by calcium phosphate precipitation, together with plasmids encoding three G proteins (rat Gᵢ₂α, cow β₁, and cow γ₂). After about 48 hours, cells were harvested and crude microsomal membranes were prepared. Membranes containing about 5 μg of protein were incubated in 0.1 ml of GTP-binding buffer (50 mM Hepes, 100 mM NaCl, 10 mM MgCl₂, pH7.5) having 5 μg of saponin, 0.1% fatty acid-free BSA, 10 μM GDP, 0.1 nM GTP[γ-³⁵S] (1200 Ci/mmole) together with indicated concentrations of LPA or OMPT for about 30 min at 30° C. Membranes were collected using a 96-well Brandel Cell Harvester (Gaithersburg, Md.), and bound radionuclide was determined using a Packard TopCount liquid scintillation counter. FIG. 59A demonstrates that OMPT does not activate mammalian cells (HEK293) transfected with LPA1 receptor using GTP [γ-³⁵S] binding assay. FIG. 59B demonstrates that OMPT does not activate mammalian cells (HEK293) transfected with LPA2 receptor. FIG. 59C demonstrates that OMPT activates mammalian cells (HEK293) transfected with LPA3 receptor. FIG. 59D demonstrates that OMPT does not activate mammalian cells transfected with S1P3 receptor, a non-LPA receptor as a negative control.

2. Structures of LPA and LPA Derivatives/Analogs

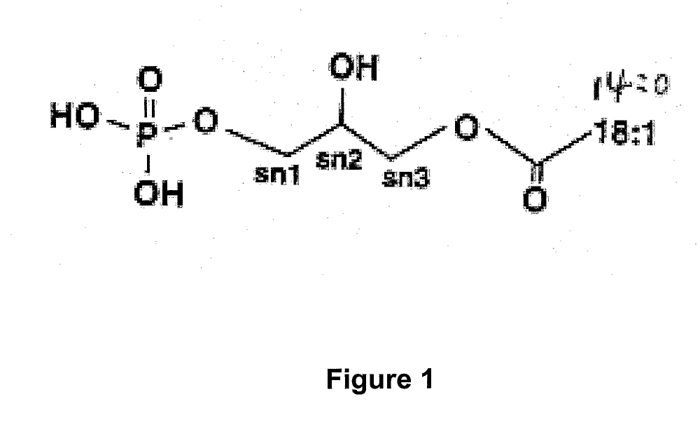

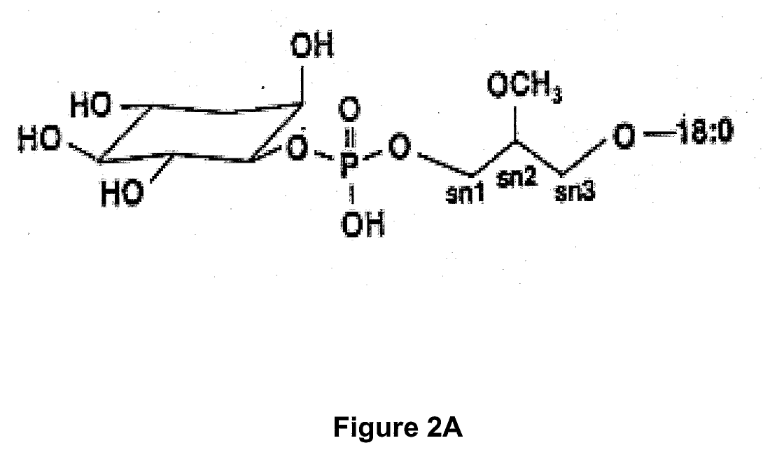

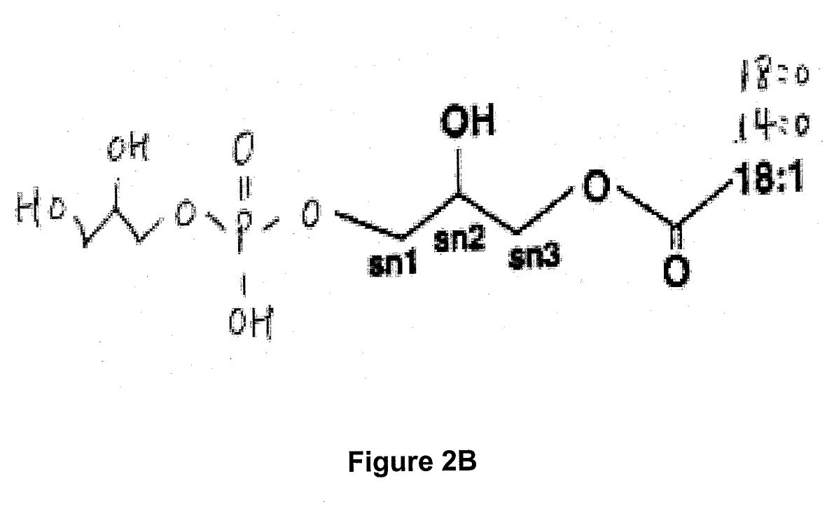

The structure of a representative LPA is shown in FIG. 1. The structure of D-3-deoxy-phosphophatidyl-myo-inositol ether lipid (DPIEL) and a representative lysophosphatidyl glycerol (LPG) are shown in FIGS. 2A and 2B, respectively. Structurally, DPIEL and LPG are derivatives/analogs of LPA. In one embodiment, the invention provides a variety of LPA derivatives/analogs in order to test their functions as modulators, agonists, and/or antagonists for LPA signaling through the interaction with specific LPA receptor subtypes.

As shown in FIG. 1, LPA has a phosphatidic acid at the sn3 position, a hydroxyl group at the sn2 position, and an acyl-linkage fatty acid (such as 18:1 or 14:0 as shown) at the sn1 position of the glycerol backbone. As shown in FIG. 2A, D-3-deoxy-phosphophatidyl-myo-inositol ether lipid (DPIEL) has a phosphatidyl-myo-inositol at the sn3 position and an alkyl ether-linkage fatty acid (18:0) at the sn1 position of the glycerol backbone. Thus, DPIEL is an LPA analogue. It has been reported that DPIEL is an inhibitor of a serine/threonine protooncogene protein kinase, referred to as AKT. It is thought that the phosphatidyl-myo-inositol structure at the sn3 position of DPIEL binds to PH domain of AKT protein. However, the pharmacological functions of substitutions at sn2 and sn1 fatty acid positions are not known. DPIEL can be purchased from Calbiochem (San Diego, Calif., USA).

DPIEL is related in structure to LPG (lysophosphatidyl glycerol). As shown in FIG. 2B, LPG has a phosphatidylglycerol at the sn3 position, a hydroxyl group at the sn2 position, and an alkyl-linkage fatty acid (such as 18:0 as shown) at the sn1 position of the glycerol backbone. We have confirmed that LPG is an inhibitor of LPA signaling in human Jurkat T cells without testing the receptor subtype specificity (Xu Y., Casey, G., and Mills, G. B., 1995 Lysophospholipids activate the human Jurkat T cell line. J. Cell Physiol. 163:441-450, Xu, Y., Fang, X. F., Casey, G., and Mills, G. B., 1995 Lysophospholipids activate ovarian and breast cancer cells. Biochem J. 309:933-940). The invention further provides evidence that LPG has similar activities to DPIEL in decreasing signaling through specific LPA receptors.

In addition, we have developed a novel method to make stable derivatives of LPA, such as OMPT, which is a LPA3 receptor subtype specific agonist (Hasegawa Y, Erickson J R, Goddard G J, Yu S, Liu S, Cheng K W, Eder A, Bandoh K, Aoki J, Jarosz R, Schrier A D, Lynch K R, Mills G B, Fang X. 2003 Identification of a phosphothionate analogue of lysophosphatidic acid as a selective agonist of the LPA3 receptor. J. Biol. Chem. 278:11962-9). FIG. 57 compares the chemical structures of 18:1 LPA and OMPT. OMPT includes a phosphothio bond at the sn3 position and a methyl group at the sn2 position, as compared to 18:1 LPA.

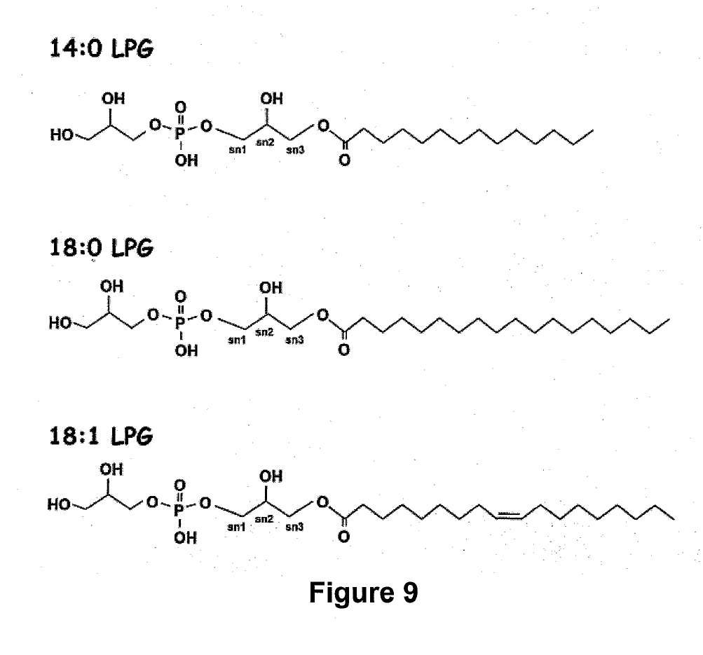

In one embodiment, to develop selective LPA modulators, agonists, and/or antagonists, the invention provides synthesized LPA analogues. Since DPIEL is shown herein as a selective LPA3 antagonist, initially, DPIEL related analogues with methoxyl at the sn2, and an alkyl, alkenyl, or alkynyl linkage at the sn1 position may be used, which will enhance LPA receptor subtype selectivity. To establish selective LPA receptor subtype modulators, replacement of phosphatidyl-myo-inositol at the sn3 position may be necessary. To test this hypothesis, LPG was screened. LPG has a phosphatidylglycerol at the sn3 position and an acyl-linkaged fatty acid at the sn1 position. For example, various LPG (e.g., those shown in FIG. 9, 14:0 LPG and 18:0 LPG, 18:1 LPG, etc.) can be used to test their activity as modulators for selective LPA receptor subtypes. It is hypothesized that replacement of phosphatidyl-myo-inositol with other structures, such as a phosphatidylglycerol group, alkylcyano phosphothionate groups, and others as described above, at the sn3 position will lead to reduced AKT inhibiting activity, and thus reduced crosstalk between LPA signaling and AKT signaling. Based on the structure-activity relationship, LPA derivatives, such as derivatives of OMPT, DPIEL, and LPG, which strongly agonize or antagonize LPA-receptor interaction and enhance or reduce cell growth, are identified. It is inferred from the study as described herein that the substitutions at the Y functional group as described in formula I, II, III, IV, and V create subtype specific antagonists and/or agonists, and substitutions at the R¹ functional group with long fatty acid chains create selectivity for LPA receptors, but not other types of receptors.

In one embodiment, the invention confirms that different LPA derivatives, such as OMPT and others, agonize specific LPA receptor subtypes. In another embodiment, the invention provides that different LPA derivatives, such as DPIEL, 14:0 LPG, 18:0 LPG, 18:1 LPG, inhibit different LPA receptor subtypes. In another embodiment, the invention provides modulators which reduce cell-viability of androgen insensitive prostate cancer DU145 and PC-3 cells, but not that of androgen-dependent prostate cancer LNCaP cells.

3. Design of Subtype Selective Modulators for LPA Receptors

In yet another embodiment, the invention provides a series of LPA derivatives and establishes the structure-bioactivity relationship of the LPA derivatives, which may signal through LPA receptor subtypes. Applicants propose that: unsaturated fatty acids with at least an 18-carbon length at the sn1 position of the glycerol backbone in the structure of LPA are required for optimal LPA3 binding; a saturated fatty acid is preferable for LPA1 and LPA2 binding; a free hydroxide at sn2 position in LPA structure is critical for LPA2 binding; and short carbon length fatty acids at the sn1 position are preferable for LPA1 binding. Derivatives/analogs of LPA, OMPT, DPIEL, and LPG may be synthesized to determine whether the alkyl, alkenyl, or alkynyl-fatty acid linkage group, or the myo-inositol structure is required for LPA receptor binding and subsequently, activation of specific kinases for LPA signaling. For example, derivatives with sn2-OH group may preferably antagonize LPA2 signaling, whereas derivatives with sn2-OCH3 and sn1-alkenyl unsaturated fatty acid may selectively antagonize LPA3 signaling. In addition, derivatives with sn2-OH and sn1 short chain saturated fatty acid may antagonize LPA1 signaling.

Furthermore, it is contemplated that the above compounds can further include small molecule substitutions at the sn3 position of the glycerol backbone in order to generate LPA derivatives that are more chemically or metabolically stable, more drug-like (i.e., structurally stable to have a long half-life in vivo and suitable to be used as a drug), for example, LPA derivatives with a phosphothionate or phosphonate group. Exemplary small molecule substitutions at the sn3 position to be screened for LPA receptor subtype specificity can be found in the structures and compounds of the invention as described above. For example, substitutions at the sn3 position such that in the formula I, II, III, IV, or V, Y is a halo group or a alkylcyano group, may help to stabilize the LPA derivatives synthesized. Similarly, substitutions with a halo group can also be at the sn2 position in order to generate a stable LPA derivative.

Therefore, effects of the LPA derivatives of the invention may be assayed by the LPA-induced calcium mobilization assay as mentioned above and also in insect Sf9 cells, which do not express LPA receptors, with LPA1, LPA2, or LPA3 exogenously expressed. The LPA derivatives of the invention may also be assayed by GTP [γ-³⁵S] binding assay. In addition, kinase activation through LPA receptor signaling can be assayed using various antibodies available for different kinases. Accordingly, 14:0 (myristoyl) LPG, 18:0 (stearoyl) LPG, and 18:1 (oleoyl) LPG, purchased from Avanti Polar Lipids (Alabaster, Ala., USA), were screened. In addition, suitable drugs candidates designed based on the structures of LPA and LPA receptor as positive or negative modulators/regulators for LPA signaling can be assayed accordingly in order to test their ability to bind to LPA receptors and increase and/or inhibit LPA signaling. The results of these assays can help to develop drugs for cancer treatment.

4. Identification of Subtype Selective Modulators for LPA Receptors

We demonstrate that 1-acyl-sn2-O-methyl-rac-glycero-3-phosphothionate (OMPT) is a LPA3 selective positive modulator. We show that the LPA3 receptor can mediate cell growth and survival in human ovarian and prostate cancer cell lines using OMPT.

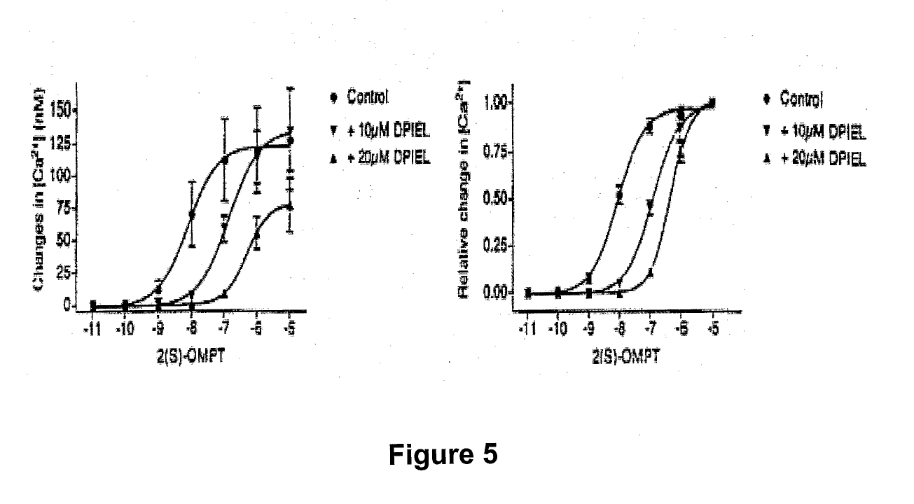

We demonstrate that D-3-deoxy-phosphophatidyl-myo-inositol ether lipid (DPIEL) is a LPA3 selective negative modulator. In addition, we have found that DPIEL inhibits LPA response in ovarian cancer OVCAR3 and androgen insensitive prostate cancer PC-3 and DU145 cells. The ovarian cancer OVCAR3 cell line is characterized by a high level of LPA3 mRNA expression. FIG. 5 demonstrates the effect of DPIEL on LPA-induced calcium mobilization in OVCAR3 cells. The left panels reflect absolute cytoplasmic calcium concentration change and the right panels reflect the relative cytoplasmic calcium change. OMPT was applied in OVCAR3 cells after exposure of the cells to DPIEL for about 3 minutes. OMPT was cumulatively applied to OVCAR3 cells which were exposed to DPIEL throughout the whole experiment.

As shown in FIG. 5, after exposure to DPIEL (10 μM or 20 μM), the concentration-dependent calcium mobilization curve induced by OMPT, which is the LPA3 selective agonist, has shifted 10 fold toward the right in OVCAR3 cells as observed by the direct calcium concentration change or the relative change in calcium concentration as compared to the no DPIEL control. Notably, the maximum responses in both control and DPIEL (10 μM) exposed groups are not changed [control group: about 123.5+/−16.4 nM (N=4), DPIEL (about 10 μM) exposed group: about 136.1+/−16.6 nM], suggesting that DPIEL competitively antagonizes the LPA3 receptor. Also shown in FIG. 5, at about 20 μM of DPIEL, the LPA derivative, DPIEL, shifted the concentration-dependent curves about 50 fold toward to the right with about 36% suppression of the maximum response concentration.

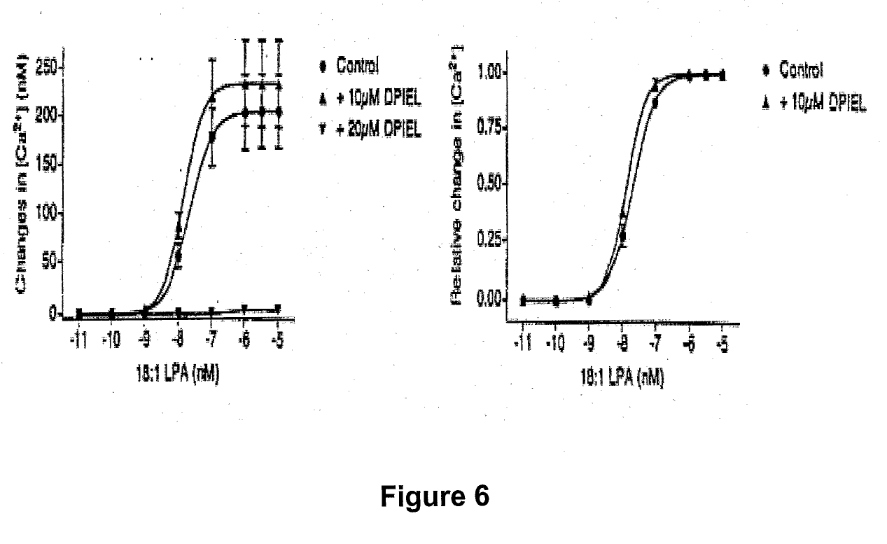

FIG. 6 demonstrates the effect of DPIEL on LPA-induced calcium mobilization in HT29 cells. The left panels reflect absolute cytoplasmic calcium concentration change and the right panels reflect the relative cytoplasmic calcium change. 18:1 LPA was applied to HT29 cells after exposure of the cells to DPIEL for about 3 minutes. 18:1 LPA was cumulatively applied to HT29 cells, which were exposed to DPIEL throughout the experiment. As shown in FIG. 6, DPIEL does not inhibit calcium mobilization induced by 18:1 LPA in colon cancer HT29 cells which express only the LPA2 receptor. Accordingly, these results indicate that LPA2 is not a target receptor of DPIEL and the inhibition of LPA signaling by DPIEL is selective to LPA3.

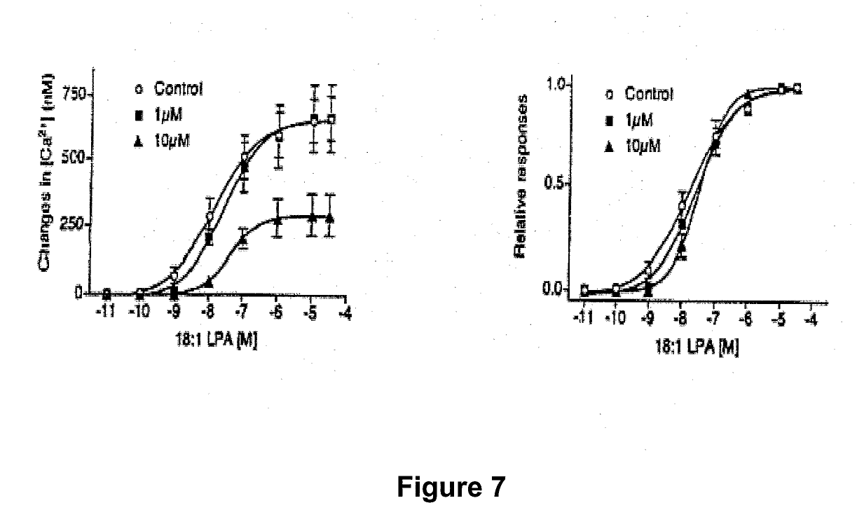

FIG. 7 demonstrates the effect of DPIEL on LPA-induced calcium mobilization in PC-3 cells. The left panels reflect absolute cytoplasmic calcium concentration change and the right panels reflect the relative cytoplasmic calcium change. 18:1 LPA was applied to PC-3 cells after exposure of the cells to DPIEL for about 3 minutes. 18:1 LPA was cumulatively applied to PC-3 cells, which were exposed to DPIEL throughout the experiment. In human androgen insensitive prostate cancer PC-3 cells, which express high level of LPA1 and low levels of LPA2 and LPA3, DPIEL suppress the maximum calcium mobilization induced by 18:1 LPA (a pan LPA agonist) for about 56%, as shown in FIG. 7. The concentration-dependent curve of calcium mobilization induced by 18:1 LPA is not shifted, and the ED₅₀ on the relative concentration-dependent curve of FIG. 7 for a 18:1 LPA-induced calcium mobilization assay is not changed. Accordingly, these results suggest that DPIEL can non-competitively inhibit an LPA1-mediated LPA response in addition to specific inhibition mediated by LPA3.

DPIEL has been reported to inhibit AKT protein activity due to the presence of its myo-inositol structure. Here, we demonstrate that DPIEL inhibits phosphorylation of vasodilator stimulated protein (VASP) and LPA-induced calcium mobilization in androgen insensitive prostate cancer PC-3 cells, suggesting that DPIEL is a potential candidate as a LPA antagonist. We have also studied the time course of phosphorylation levels of endogenous phosphorylated and unphosphorylated AKT and ERK in OVCAR3 cells. We have also compared the phosphorylated and unphosphorylated forms of AKT and ERK1/2 to demonstrate the effect of phosphorylation levels of AKT and extracellular signal-regulating kinase (ERK) when induced with OMPT.

Further, we have also compared the phosphorylated and unphosphorylated forms of AKT and ERK1/2 in androgen sensitive prostate cancer LNCaP cells to demonstrate the effect of phosphorylation levels of AKT and extracellular signal-regulating kinase (ERK) when induced with EGF. The fact that DPIEL inhibits LPA-induced phosphorylation of ERK1/2 in PC-3 cells but fails to inhibit EFG-induced phosphorylation of ERK1/2 in LPA-unresponsive prostate cancer cells, LNCaP, suggesting that DPIEL acts as a selective inhibitor/antagonist for LPA receptors.

For these kinase related phosphorylation experiments, cells were pre-treated with DPIEL for about 30 minutes and then exposed to LPA derivative, such as OMPT, 18:1 LPA, or 14:0 LPA for 10 minutes after starvation in serum-free medium for about 12 to 24 hours. The cells were then lysed in SDA sample buffer or ice-cold X-100 lysis buffer (1% Triton X-100, 50 mM HEPES [pH7.4], 150 mM NaCl, 1.5 mM MgCl₂, 1 mM EGTA, 10% glycerol, 100 mM NaF, 10 mM Na pyrophosphate, and 1 mM aprotinin). Total cellular protein was resolved by SDS/PAGE, transferred to immobilon [poly (vinylidene difluoride)], and immunoblotted with antibodies following the protocols provided by manufactures. Immunocomplexes were visualized with an enhanced chemiluminescence detection kit (Amersham Pharmacia) using horseradish peroxidase-conjugated secondary antibodies (Bio-Rad).

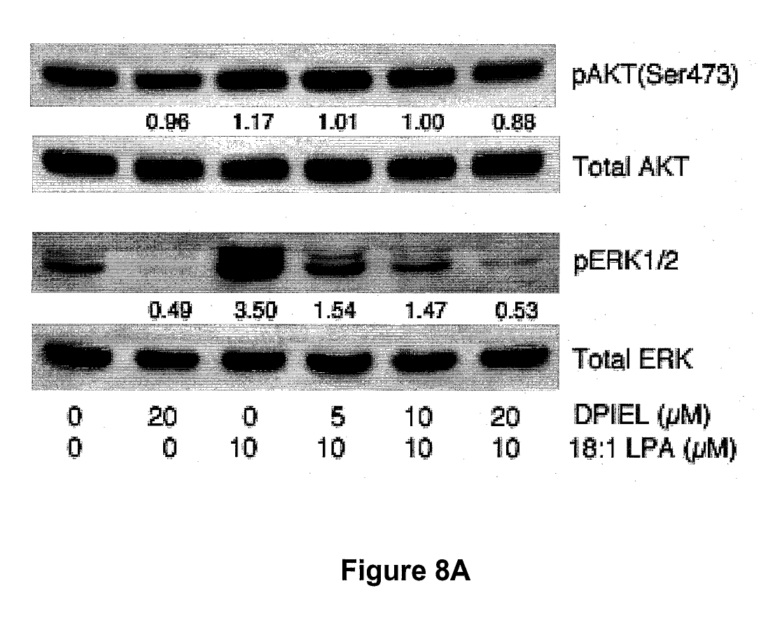

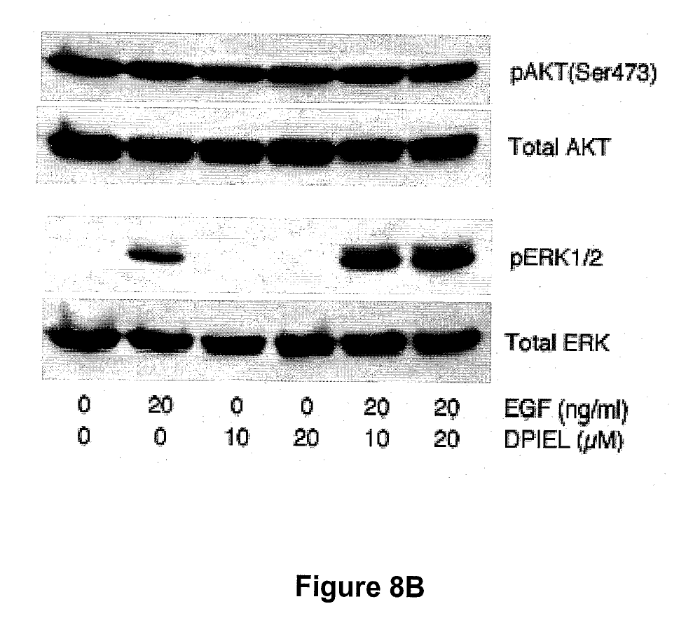

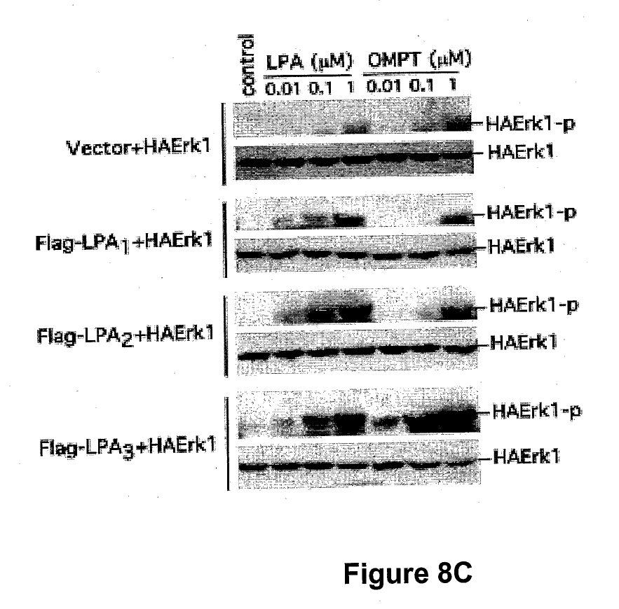

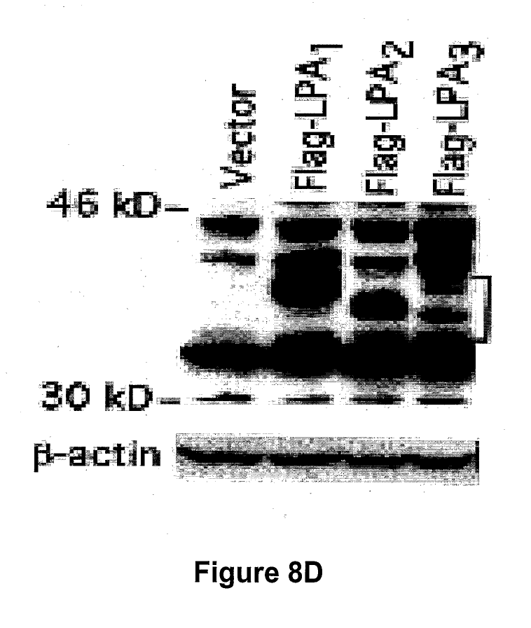

FIG. 8A demonstrates the effect of DPIEL and/or 18:1 LPA on phosphorylation levels of AKT and ERK1/2 (pAKT and pERK1/2 indicated phosphorylated forms of AKT and ERK1/2 kinases) in androgen insensitive prostate cancer PC-3 cells. The cells were first exposed to DPIEL for about 30 minutes and then stimulated by OMPT and/or 18:1 LPA as indicated for about 10 minutes.

As shown in FIG. 8A, DPIEL inhibits phosphorylation of the extracellular signal-regulating kinase (ERK1/2) activated by both 18:1 LPA and 14:0 LPA in androgen insensitive prostate cancer cell line, PC-3. Similar results have been observed for another androgen insensitive prostate cancer cell line, DU145. Interestingly, the level of inhibition of AKT phosphorylation is very weak, compared with the level of inhibition of ERK1/2 phosphorylation. As shown in FIG. 8A, the effect of DPIEL on ERK signaling is more prominent than found in previous studies for the effect of DPIEL on AKT signaling and apoptosis. The exposure of DPIEL in this invention is only for about 30 minutes, while previous experiments by others typically include an exposure time of at least about 16 to 24 hours. Accordingly, these results demonstrate that the inhibition of ERK phosphorylation by such a LPA derivative is faster and more efficient than AKT phosphorylation and other signaling events. The results further demonstrate that DPIEL is a potential candidate for prostate cancer therapy as a LPA antagonist.

To determine if the effects of DPIEL were mediated by LPA receptors, the ability of DPIEL to inhibit signaling was assessed in LNCaP prostate cancer cells, which are LPA unresponsive as assayed by calcium mobilization and non-phosphorylation of ERK1/2 in the presence of LPA. As shown in FIG. 8B, LNCaP cells are EGF responsive, allowing the use of EGF signaling as a control for the effect of DPIEL in LNCaP cells. In LPA-unresponsive LNCaP androgen sensitive prostate cancer cells, DPIEL fails to reduce EGF-induced phosphorylation of ERK1/2. In addition, FIG. 8B also demonstrated that DPEIL failed to alter phosphorylation of phosphorylated forms of pAKT (ser473). Thus, DPIEL selectively inhibits LPA-induced signaling without inhibiting EGF-induced signaling. Further, under the conditions used, DPIEL fails to inhibit AKT phosphorylation.

We have also tested kinase activation by the LPA3 receptor subtype using OMPT as a tool. We determined whether activation of the LPA3 receptor by OMPT can be linked to ERK activation (related to MAP kinase signaling pathway) in mammalian cells, HEK 293 T cells, by co-transfecting hemagglutinin (HA)-tagged Erk1 (HA-Erk1) with either a control vector or an expression vector having LPA1, LPA2, or LPA3. After serum starvation, transfected cells were stimulated with 0.01, 0.1, or 1 μM of LPA or OMPT, as indicated in FIG. 8C. Phosphorylation of transfected HA-Erk1 protein of a molecular mass larger then the endogenous Erk1 was revealed by immunoblotting with anti-phospho-Erk antibody. FIG. 8C demonstrates OMPT activation of specific LPA3 receptor subtype is linked to MAPK kinase activation in mammalian cells. As seen in FIG. 8C, in control vector-HA-Erk1 transfected cells, only trace amount of phosphorylation was observed at high concentration of about 1 μM of LPA or OMPT. There is no phosphorylation of HA-Erk1 at lower concentration of LPA or OMPT in the absence of LPA receptors. In the presence of each of these LPA receptors, LPA compound stimulates phosphorylation of HA-Erk1 in a dose-dependent manner, suggesting that each of the LPA1, LPA2, and LPA3 receptors is functionally expressed in the transfected cells and that each receptor can couple to MAPK activation in response to LPA. Interestingly, OMPT did not increase HA-Erk1 phosphorylation in LPA1 and LPA2 transfected cells. Even at 1 μM of OMPT, the effect of OMPT was similar to that of 0.1 μM of LPA in the presence of LPA1 or LPA2, suggesting that OMPT possesses a reduced agonistic activity at the LPA1 and LPA2 receptors. However, in the presence of LPA3 receptor, OMPT stimulates Erk1 phosphorylation at all concentrations tested and in a dose-dependent manner. FIG. 8D demonstrates confirmation of the expression of FLAG-tagged various LPA receptors in transfected cells. Thus, the data confirmed that OMPT, an LPA derivative, is a selective agonist for LPA3 receptor subtype, capable of inducing MAPK activation.

In addition, we found that 14:0 LPG and 18:0 LPG inhibited calcium mobilization induced by 14:0 LPA, an LPA_{1/2} agonist, in androgen insensitive prostate cancer DU145 cells. 14:0 LPA stimulates both LPA1 and LPA2 receptors but not LPA3 receptor. It has been observed that 18:0 LPG, but not 14:0 LPG, inhibited LPA-induced calcium mobilization in colon cancer HT29 cells (which only express LPA2), which suggests that 14:0 LPG may be a LPA1 antagonist and that 18:0 LPG may be an antagonist for both LPA1 and LPA2 receptors. It has also been observed that 18:1 LPG completely antagonized 18:1 LPA, a pan LPA receptor agonist, in DU145 cells, which suggests that 18:1 LPG may be an antagonist for LPA1, LPA2, and LPA3 receptors.

Therefore, it is desired to synthesize LPA derivatives based on the structure of OMPT, DPIEL, LPG, etc., and test their receptor subtype specificity. Given the major role of LPA in the growth, viability, neovascularization, and metastases of multiple cell lineages, LPA derivatives tested as modulators of LPA signaling are potential therapeutic compounds for the treatment of cancer and other diseases. Other suitable applications include cardiovascular functions, ischemia/reperfusion injury, atherosclerosis, wound healing, prevention of toxicity of chemotherapy and radiation therapy, immunological functions, among others.

5. Determine Whether LPA Receptors are Targets for Therapy in Androgen Insensitive Prostate Cancer

In order to determine the role of specific LPA receptors in prostate cancer cells and to validate them as therapeutic targets, it is necessary to develop a series of receptor-selective agonists and antagonists. For this purpose, a LPA3 selective agonist, 1-acyl-sn2-O-methyl-rac-glycero-3-phosphothionate (OMPT) was first characterized.

In androgen insensitive prostate cancer PC-3 cell line, 18:1 LPA stimulates calcium mobilization with an EC₅₀ of about 5 nM. The LPA2 selective ligand, 14:0 LPA, stimulates calcium mobilization with an EC₅₀ of about 98 nM; whereas the LPA3 selective ligand, OMPT, stimulates calcium mobilization with an EC₅₀ of about 117 nM. Accordingly, these results suggest the presence of functional G-protein coupled LPA receptors in PC-3 cells.

To further evaluate the functionality of LPA receptors in androgen insensitive prostate cancer PC-3 and DU145 cells, we demonstrate that 18:1 LPA activates AKT, p38-, and p42/p44-MAPK as indicated by increased reactivity with phosphospecific antibodies. The selective LPA3 ligand, OMPT, efficiently activates AKT and p42/p44-MAPK but not p38-MAPK. In contrast, the LPA_{1/2} ligand 14:0 LPA efficiently activates p42/p44-MAPK, but only marginal effects on AKT and p38. Accordingly, these results indicate that different LPA receptors couple to specific downstream signaling pathways in prostate cancer cells.

It has been observed that 18:1 LPA and OMPT increase cellular proliferation and prevent growth factor withdrawal-induced apoptosis. The results are consistent with their selective effects on signaling in prostate cancer cells Accordingly, these results suggest that the LPA3 receptor is crucial for cell-proliferation in PC-3 cells. On the other hand, 14:0 LPA does not increase cellular proliferation and prevent growth factor withdrawal-induced apoptosis.

To further evaluate the functionality of LPA receptors in PC-3 cells, it has been observed that 18:1 LPA (a pan agonist) and 14:0 LPA (a LPA2 specific agonist) stimulate membrane ruffling and cell migration in PC-3 cells, which suggests that LPA1, LPA2, or both are critical to cell migration in androgen insensitive prostate cancer cells. In contrast, OMPT (a LPA3 selective agonist) induces neither morphology changes nor migration, supporting OMPT's receptor subtype selective properties.

To determine the mechanisms regulating LPA-induced cell migration, actin filament binding proteins that link receptor signaling to lamellipodia formation were evaluated. For example, 18:1 LPA and 14:0 LPA induced phosphorylation of vasodilator-stimulated protein (VASP), an actin filament capping protein, at the Ser157 PKA phosphorylation site, which suggests that LPA stimulates lamellipodia formation by stabilizing actin filament polymerization in PC-3 cells. Neither OMPT nor EGF increased phosphorylation of VASP. H-89, a protein kinase A (PKA) inhibitor, completely inhibited membrane ruffling and cell migration induced by 18:1 LPA and 14:0 LPA, which suggests that PKA mediates cell migration stimulated by LPA1 and LPA2 receptors.

To further gain the evidence if LPA2 receptor is the mediator that stimulates membrane ruffling, we generated two different cell lines, PC-3 cells overexpressing LPA2 receptor and PC-3 cells having LPA2 receptor knocked down. In PC-3 cells overexpressing LPA2 receptor, the membrane ruffling and phsophorylation of VASP were constitutively activated. In contrast, the phosphorylation level of VASP was reduced in LPA2 knocked down PC-3 cells, showing that LPA2 is critical mediator to activate membrane ruffling, lamellipodia formation, and/or filopodia formation.

Compatible with the effects on cell migration, 18:1 LPA and 14:0 LPA efficiently activate PKA in PC-3 cells, however, OMPT does not. To further assess whether LPA2 contributes to membrane ruffling, we found out that PC-3 cells that were overexpressing LPA2 receptor acquired a round shape with constitutive membrane ruffling, associated with constitutive VASP phosphorylation at the Ser 157 PKA phosphorylation site. These results suggest that LPA 2 may be sufficient to mediate lamellipodia formation leading to cell migration.

To further evaluate the mechanism by which LPA mediates its functions in prostate cancer, the LPA transcriptome is identified through transcriptional profiling. Subsequently, the fact that LPA increases interleukin-8 (IL-8) transcription and stimulates IL-8 secretion was verified. The results suggest that IL-8, which is a potent mediator for neovascularization, proliferation, and migration in PC-3 cells, may contribute to LPA-induced cell migration in PC-3 cells.

In addition, indirect immunofluorescence data suggest that phosphorylated VASP localizes to the tip of the actin filament in lamellipodia, whereas LPA2 and CXCR-1 (IL-8 receptor) co-localize in ruffling membranes. The results suggest that LPA 2 receptor may play a crucial role in initiating cell migration in PC-3 cells. Further, upon knockdown of VASP protein by short double-stranded RNA interference (siRNA), LPA-induced migration in PC-3 cells is reduced, which suggests that phosphorylation of VASP is critical to LPA-induced migration in androgen insensitive prostate cancer.

To further evaluate the function of LPA in prostate cancer, the selective LPA hydrolyzing enzyme, lysophosphatidic acid phosphatase, and the lysophosphatidylcholine hydrolyzing enzyme, lysoPLD, may be knocked down in androgen insensitive prostate cancer PC-3 and DU145 cells in order to evaluate the resulting phenotypical changes.

6. Determine the Role of the Androgen Receptor in the Regulation of LPA Receptor Expression and Function

In androgen-dependent prostate cancers, androgen is sufficient for the survival and proliferation of prostate cancer cells. Functional androgen receptors repress the ability of LPA to stimulate cells either through inhibition of downstream signaling or inhibition of functional LPA receptor expression. Under hormonal ablation therapy, LPA becomes critical to the proliferation and survival of the prostate cancer cells through the expression of various functional LPA receptors or unmasking of LPA signal transduction.

It is proposed that the LPA2 receptor may mediate migration, whereas the LPA3 receptor may mediate survival and proliferation in androgen insensitive prostate cancer cells. Suppression of LPA mRNA expression or LPA signaling may lead to novel effective therapeutic approaches to prostate cancer.

LPA receptors are expressed in androgen-sensitive prostate cancer LNCaP cells and androgen insensitive prostate cancer cells, such as DU145 and PC-3 cells. Strikingly, in androgen-sensitive prostate cancer LNCaP cells, despite the presence of mRNA for LPA receptors, LPA does not induce the increase of intracellular calcium concentration or activate kinases, such as p42-MAPK, p44-MAPK, p38 MAPK or JNK. Nor does LPA induce proliferation or prevent cell death in LNCaP cells. In contrast, LPA activates increases in intracellular calcium concentration, p42-MAPK, p44-MAPK, and cell proliferation in androgen insensitive prostate cancer DU145 and PC-3 cells. The results suggest that the presence of androgen receptor may contribute to the inability of LPA to activate LNCaP cells.

To assess whether the presence of the androgen receptor contributes to the inability of LPA to activate LNCaP cells, an exogenous androgen receptor was stably expressed in PC-3 cells. Strikingly, the introduction of the androgen receptor into PC-3 cells completely blocks the ability of LPA and OMPT to activate PC-3 cells and alter the signaling for survival or proliferation, as indicated by changes in cytosolic calcium, phosphorylation of intracellular targets, induction of proliferation and prevention of apoptosis. Thus, it appears that the androgen receptor modulates the function of LPA receptors.

To further evaluate the role of the androgen receptor in the regulation of LPA receptor, the androgen receptor may be knocked down in androgen-dependent prostate cancer LNCaP cells by siRNA to evaluate the changes in LPA signaling in these cells. In addition, the androgen receptor can be transfected into another androgen insensitive prostate cancer cell line, the DU145 cell line, to evaluate changes in LPA signaling.

In summary, the functionalities of LPA in androgen insensitive prostate cancer cells have been demonstrated. For example, in PC-3 cells, the LPA2 receptor mediates cell migration, whereas LPA3 receptor mediates prolongation of cell viability. In addition, in androgen insensitive prostate cancer DU145 and PC-3 cells, DPIEL inhibits the activation of p42-MAPK and p44-MAPK, and LPA-induced cell migration.

7. Determine if LPA Antagonists are Effective in Androgen Insensitive Prostate Cancer

As indicated above, the androgen insensitive prostate cell line PC-3 can be induced to proliferate by LPA and LPA agonists. In addition, LPA increases cell migration in PC-3 cells. These results suggest that the LPA signaling pathway may mediate proliferation and migration of androgen insensitive prostate cancer cells. These results further suggest that the LPA2 receptor mediates migration, whereas the LPA3 receptor mediates proliferation in androgen insensitive prostate cancer cells.

Further, it has been observed that D-3-deoxy-phosphophatidyl-myo-inositol ether lipid (DPIEL) inhibits the LPA response in ovarian cancer OVCAR3 and androgen insensitive prostate cancer PC-3 cells. Thus, embodiments of the invention identify the pathophysiological function of LPA receptors in prostate and ovarian cancer cells and provide important data support and rationale for the design of potential novel therapeutic approaches to cancer therapy in general and specific types of androgen insensitive prostate cancers. Most importantly, embodiments of the invention provide information related to the conversion of prostate cancer cells to be androgen insensitive.

Modulators of LPA signaling that selectively agonize and/or antagonize LPA signaling may be assessed for their effects on LPA-induced cell growth, cell migration, and IL-8 production in androgen insensitive prostate DU145 and PC-3 cells according to the techniques described above.

In addition, it has been observed that when LPA derivatives, such as various LPGs are screened, 18:0 LPG and 18:1 LPG, but not 14:0 LPG reduced cell viability of DU145 and PC-3 cells. In androgen sensitive, LPA insensitive prostate cancer LNCaP cells, various LPGs tested did not reduce cell viability, which suggests that these LPGs are selective LPA inhibitors. 18:0 LPG could reduce cell migration of androgen insensitive prostate cancer DU145 cells. Thus, these results suggest that inhibitors to LPA receptors will lead to new approaches for androgen insensitive prostate cancer therapy.

The results are shown in FIGS. 9-56. FIG. 9 illustrates chemical structures of various LPGs, including 14:0 LPG, 18:0 LPG, and 18:1 LPG exemplified herein. The 14:0, 18:0, 18:1 represents the structures of the fatty acid chain at the sn3 position of the glycerol backbone. FIG. 10 shows the mRNA expression levels of various LPA receptors in different cancer cells as described above. As shown in FIG. 10, LPA2 and LPA3 are suitable targets to design LPA derivatives affecting LPA signaling.

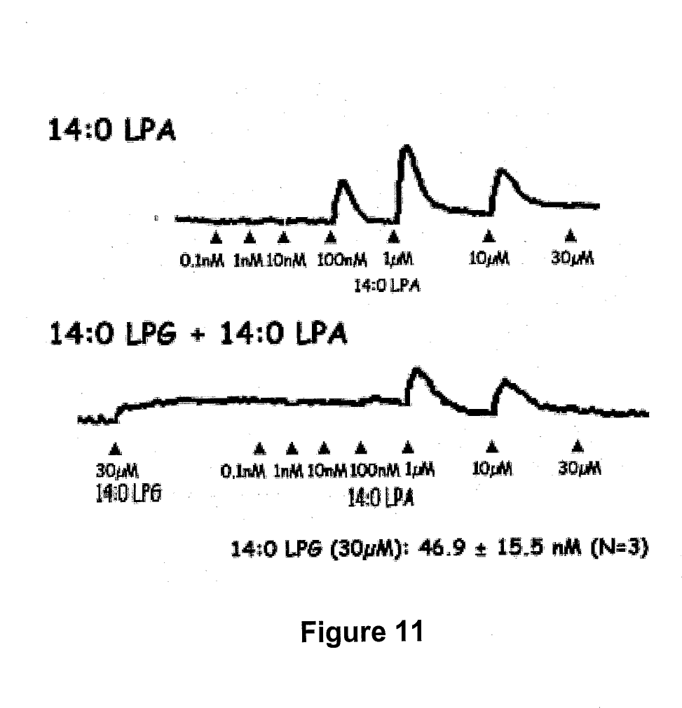

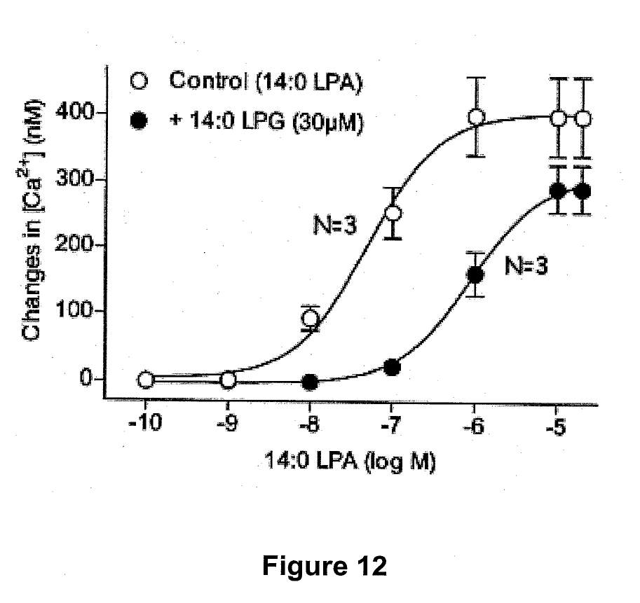

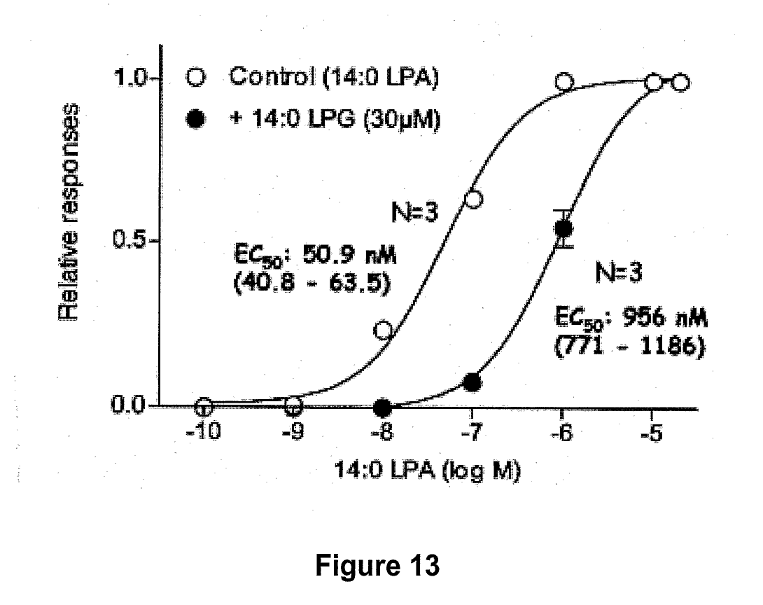

FIG. 11 is a graph showing inhibition of calcium mobilization of 14:0 LPA by 14:0 LPG in androgen insensitive prostate cancer DU145 cancer cells. In each experiment, 14:0 LPA or 14:0 LPG was cumulatively added to the cells. FIG. 12 demonstrates inhibition of 14:0 LPA signaling by 14:0 LPG in androgen insensitive prostate cancer DU145 cancer cells. FIG. 13 demonstrates normalized response of the inhibition of 14:0 LPA signaling by 14:0 LPG in androgen insensitive prostate cancer DU145 cells and shows that 14:0 LPG shifted the normalized calcium response induced by 14:0 LPA to the right. The EC₅₀ value is about 50.9 nM. The results suggest that 14:0 LPG is an effective inhibitor/antagonist for 14:0 LPA-induced signaling in androgen insensitive prostate cancer DU145 cells.

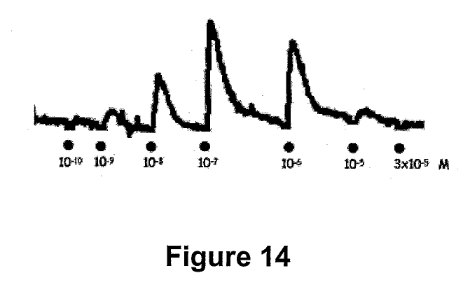

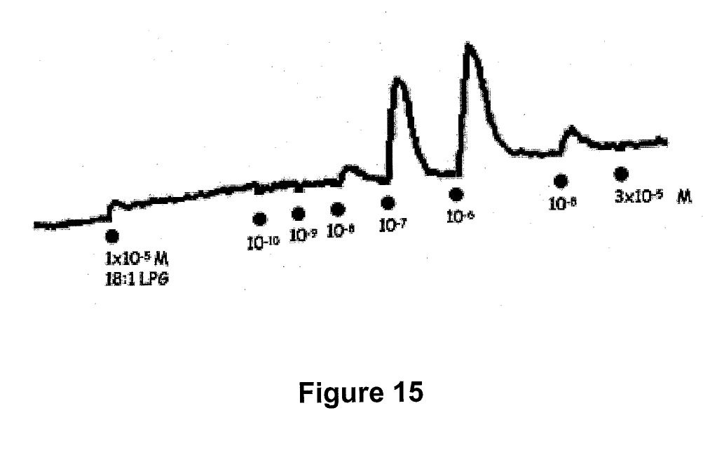

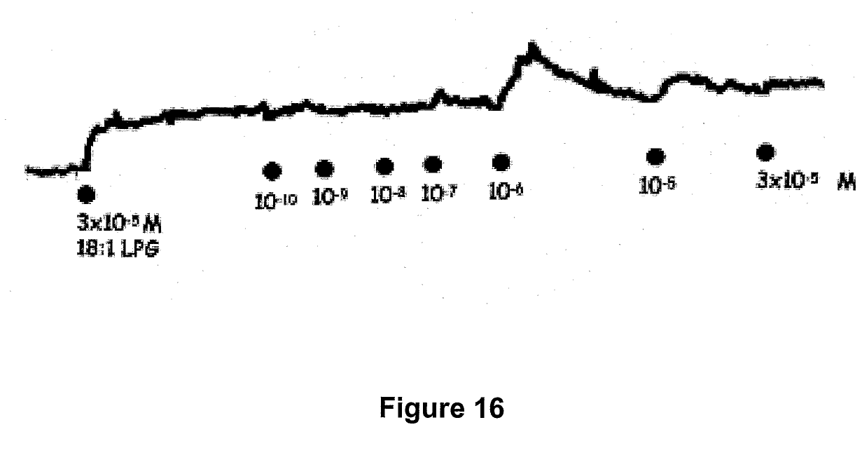

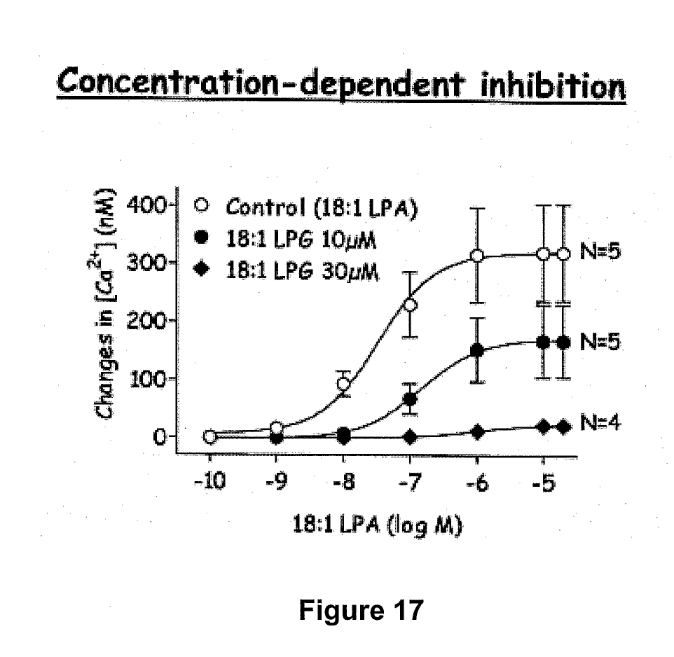

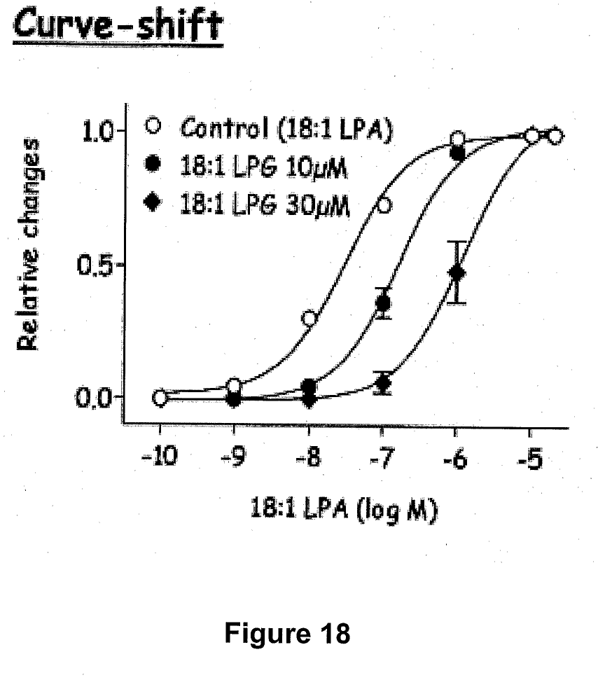

FIG. 14 is a graph showing 18:1 LPA-induced calcium mobilization in androgen insensitive prostate cancer DU145 cells. FIG. 15 is a graph showing 18:1 LPA-induced calcium mobilization in the presence of 10 μM 18:1-acyl-LPG in androgen insensitive prostate cancer DU145 cells. FIG. 16 is a graph showing 18:1 LPA-induced calcium mobilization in the presence of 30 μM 18:1-acyl-LPG in androgen insensitive prostate cancer DU145 cells. FIG. 17 demonstrates concentration-dependent inhibition of 18:1 LPA signaling by 18:1-acyl-LPG in androgen insensitive prostate cancer DU145 cells. FIG. 18 demonstrates a normalized response of the inhibition of 18:1 LPA signaling by 18:1-acyl-LPG in DU145 cancer cells and shows that the normalized calcium response curve of 18:1 LPA was shifted to the right by 18:1-acyl-LPG treatments. These results suggest that 18:1 LPG is an effective inhibitor/antagonist for 18:1 LPA-induced signaling in androgen insensitive prostate cancer DU145 cells.

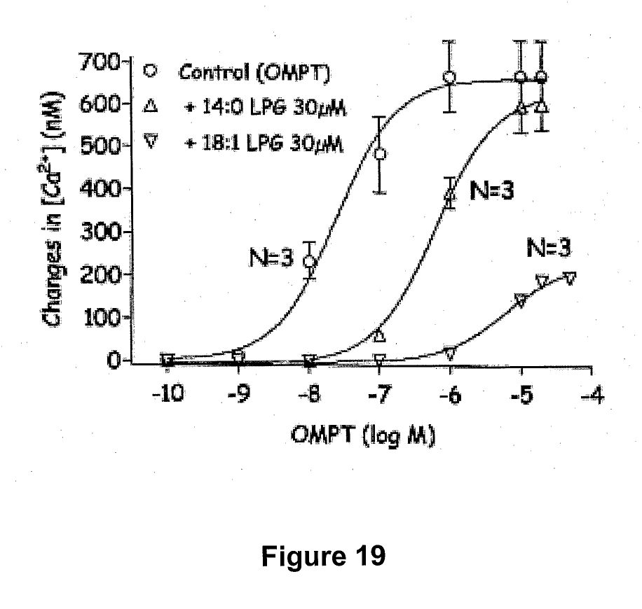

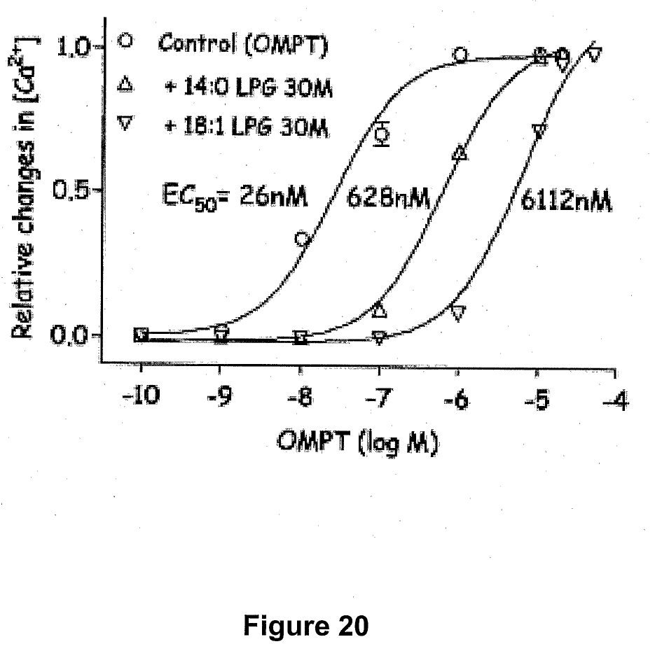

FIG. 19 demonstrates the effect of 14:0 LPG and 18:1-acyl-LPG on OMPT-induced calcium mobilization in androgen insensitive prostate cancer PC-3 cells. FIG. 20 demonstrates the normalized response of the inhibition of 14:0 LPG and 18:1-acyl-LPG on OMPT-induced calcium mobilization in androgen insensitive prostate cancer PC-3 cells. The results suggest that 18:1 LPG is an effective inhibitor/antagonist for 18:1 OMPT-induced signaling in PC-3 cancer cells.

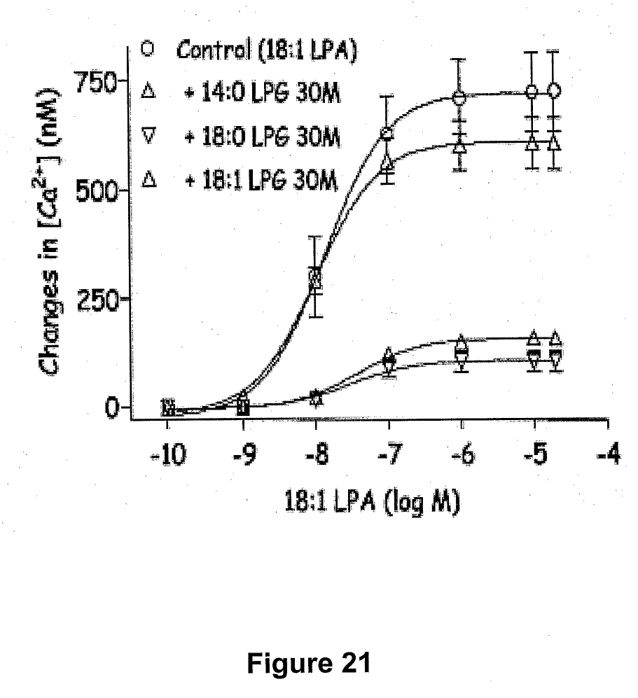

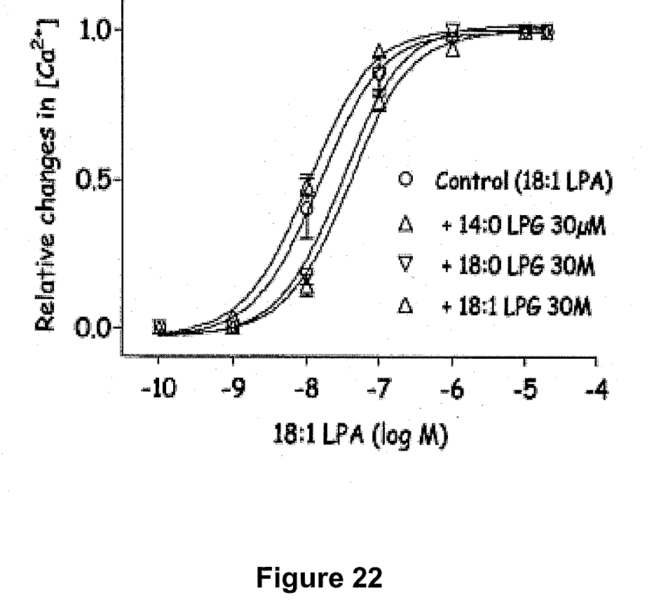

FIG. 21 demonstrates the effect of 14:0 LPG, 18:0 LPG, and 18:1-acyl-LPG on 18:1 LPA-induced calcium mobilization in colon cancer HT29 cells. FIG. 22 demonstrates a normalized response of 18:1 LPA induced calcium mobilization with 14:0 LPG, 18:0 LPG or 18:1-acyl-LPG in colon cancer HT29 cells. The results suggest that 18:0 LPG and 18:1-acyl-LPG, but not 14:0 LPG, are effective inhibitors/antagonists for 18:1 LPA-induced signaling in PC-3 cancer cells.

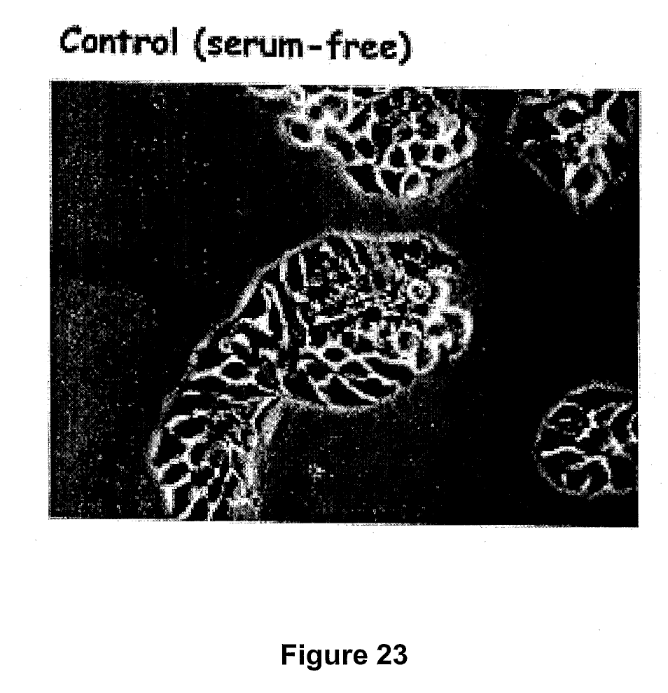

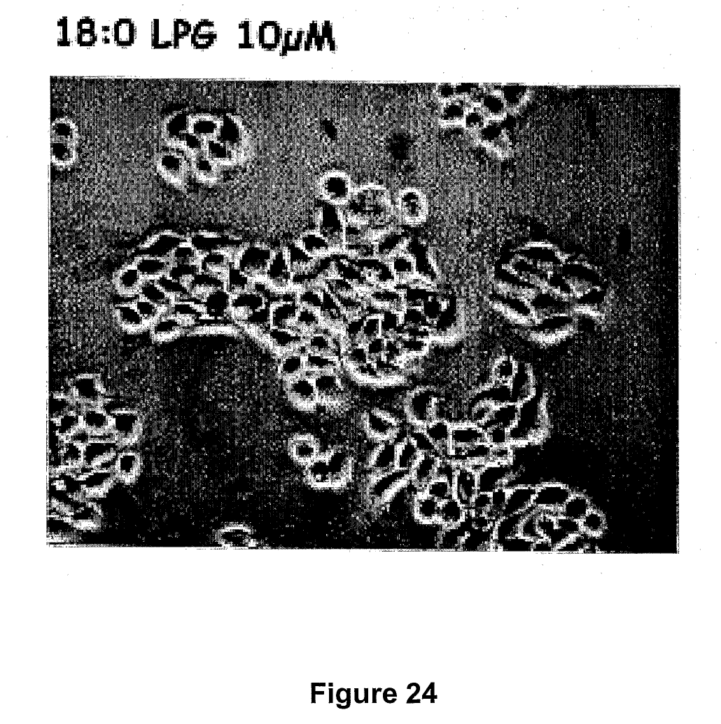

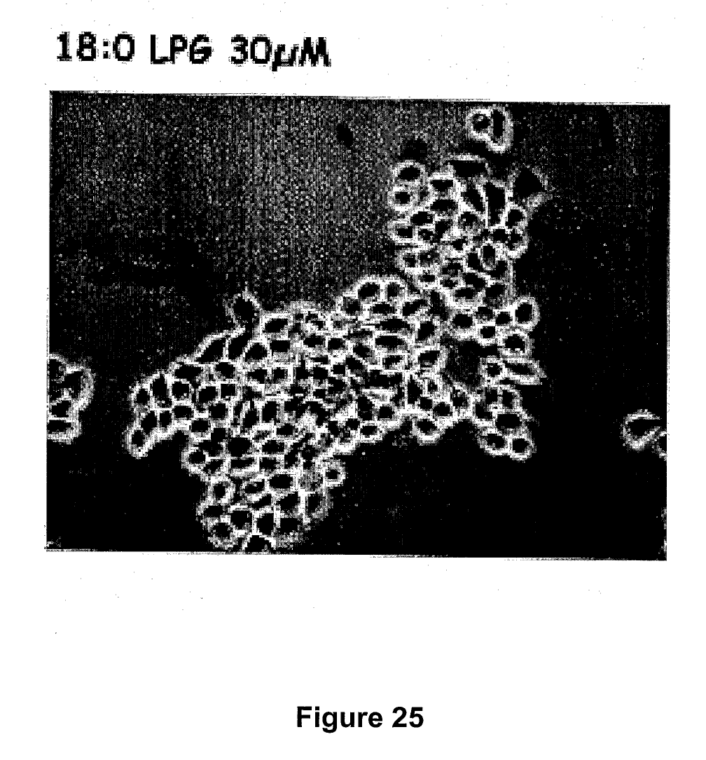

FIGS. 23-25 demonstrate that 18:0-acyl-LPG inhibits lamellipodia in colon cancer HT29 cells. FIG. 23 shows the structure of lamellipodia in colon cancer HT29 cells as a control grown under serum-free medium. FIG. 24 demonstrates the effect of 10 μM 18:0-acyl-LPG on lamellipodia formation in colon cancer HT29 cells. FIG. 25 demonstrates the effect of 30 μM 18:0-acyl-LPG on lamellipodia formation in colon cancer HT29 cells. As seen in FIGS. 24 and 25, 18:0-acyl-LPG inhibits lamellipodia in HT29 cells in a concentration dependent manner (10 and 30 μM).

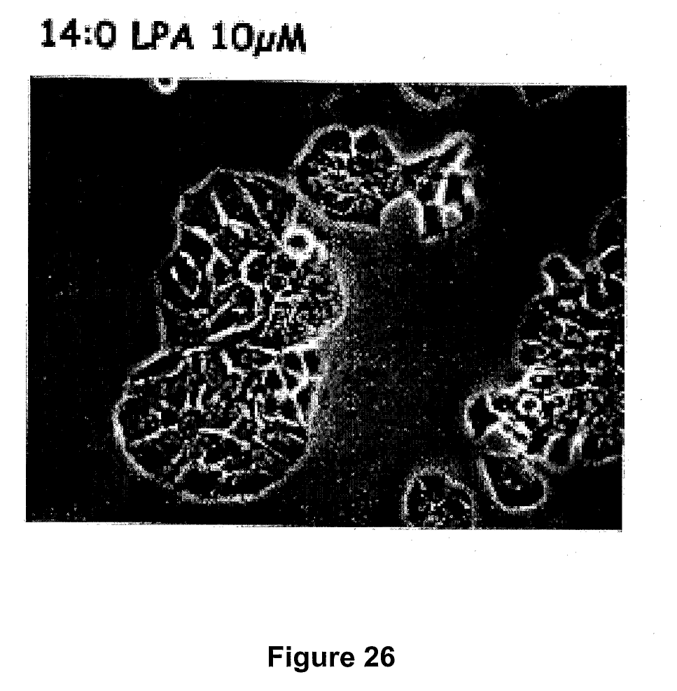

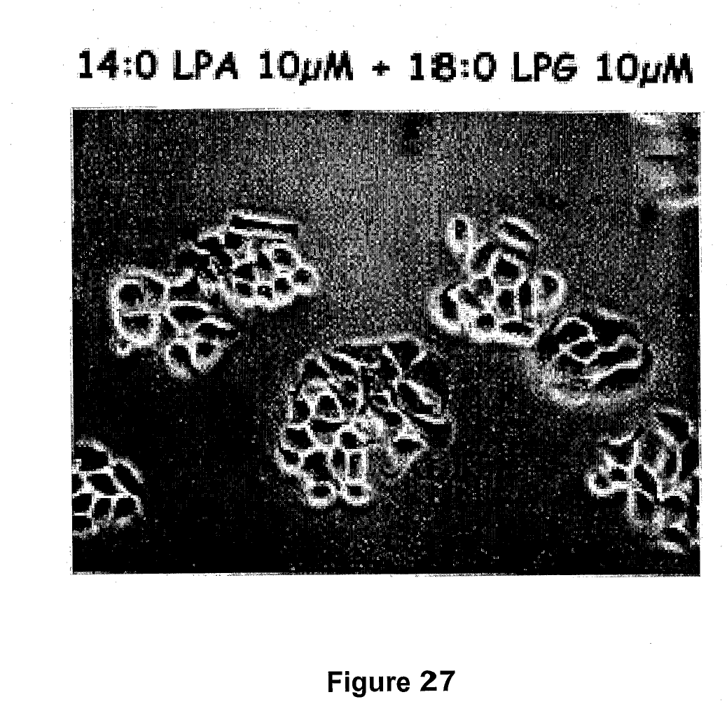

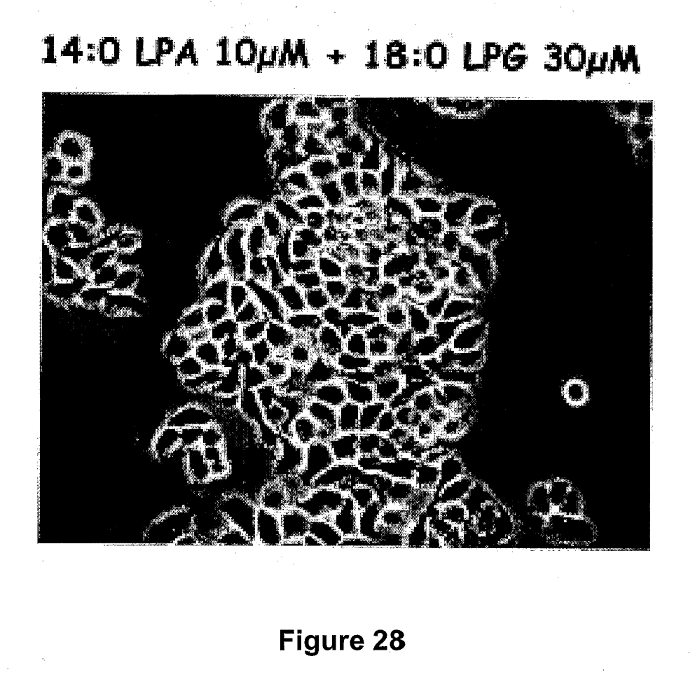

FIG. 26 demonstrates that 14:0 LPA is a strong activator of lamellipodia in colon cancer HT29 cells. As shown in FIG. 12, HT29 expresses only LPA2 receptor, suggesting that the LPA-induced lamellipodia formation is mediated by LPA2 receptor. In addition, FIG. 27 demonstrates the inhibition of 14:0 LPA-induced LPA2 receptor mediated lamellipodia formation by 10 μM 18:0-acyl-LPG in colon cancer HT29 cells. FIG. 28 demonstrates the inhibition of 14:0 LPA-induced LPA2 receptor mediated lamellipodia formation by 30 μM 18:0-acyl-LPG in colon cancer HT29 cells. As demonstrated in FIGS. 27 and 28, 18:0-acy-LPG inhibits the LPA-induced lamellipodia formation in a concentration dependent manner (10 μM and 30 μM, respectively). The results suggest that 18:0 LPG inhibits LPA2-mediated lamellipodia formation in HT29 cancer cells.

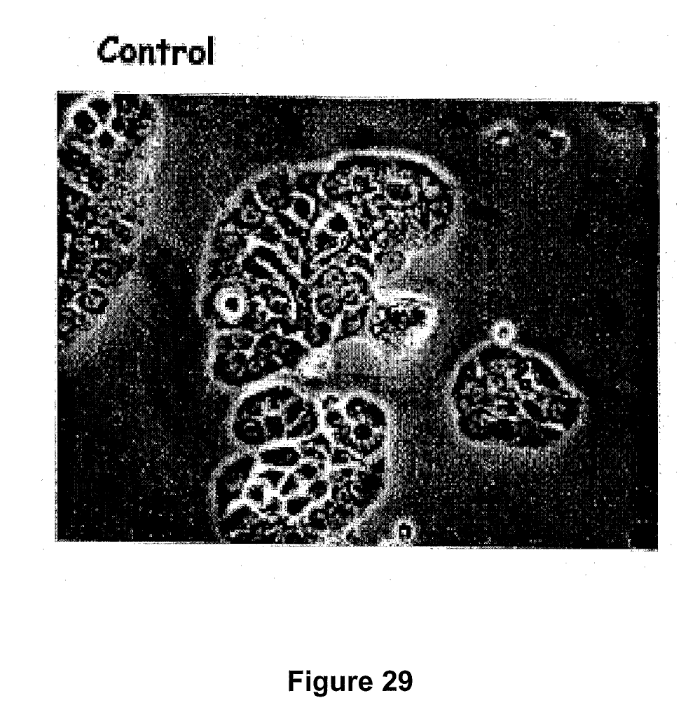

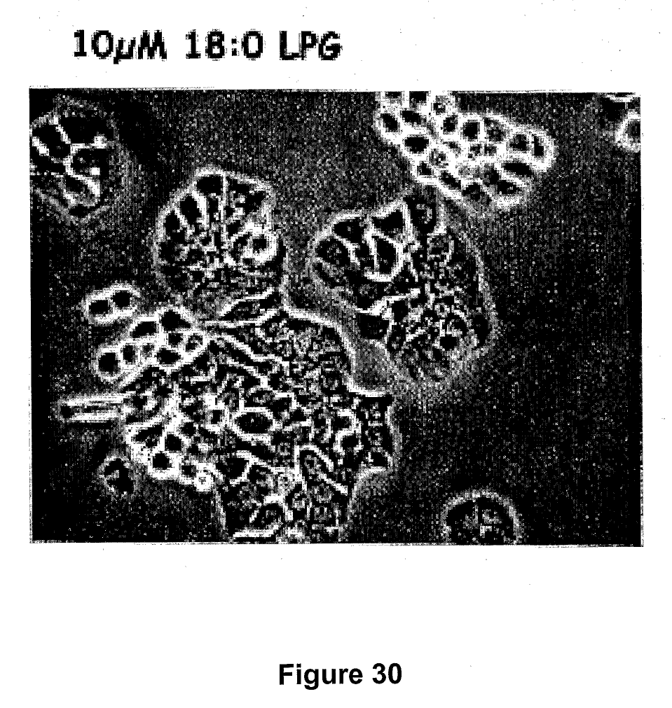

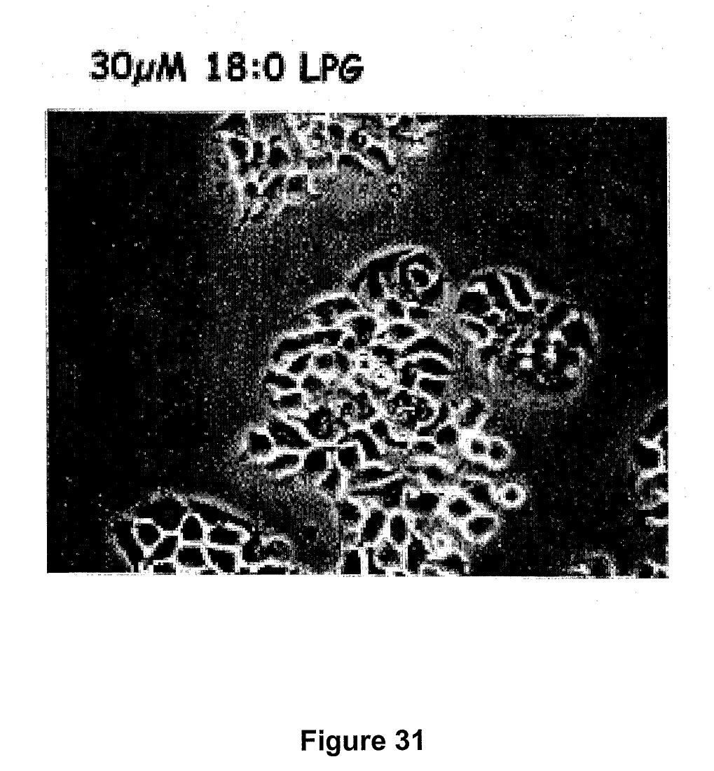

FIGS. 29-31 demonstrate the effect of 18:0-acyl-LPG on 1% fetal bovine serum (FBS)-induced lamellipodia formation in HT29 cells. Fetal bovine serum FBS contains LPAs and can be used as a source for LPA induction. As shown in FIG. 29, HT29 cells form lamellipodia aggressively under 1% FBS, demonstrating that 1% fetal bovine serum (FBS) induces LPA2 receptor mediated lamellipodia formation in colon cancer HT29 cells. FIG. 30 demonstrates the inhibition of 1% FBS-induced LPA2 receptor mediated lamellipodia formation by 10 μM 18:0-acyl-LPG in colon cancer HT29 cells. FIG. 31 demonstrates the inhibition of 1% FBS-induced LPA2 receptor mediated lamellipodia formation by 30 μM 18:0-acyl-LPG in colon cancer HT29 cells. The results support that 18:0 LPG is a strong inhibitor/antagonist to LPA2 receptor.

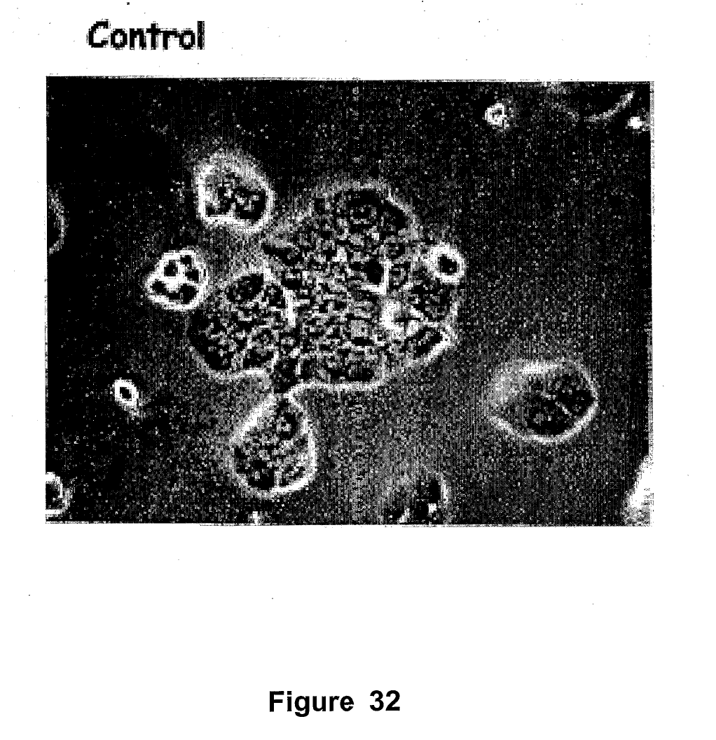

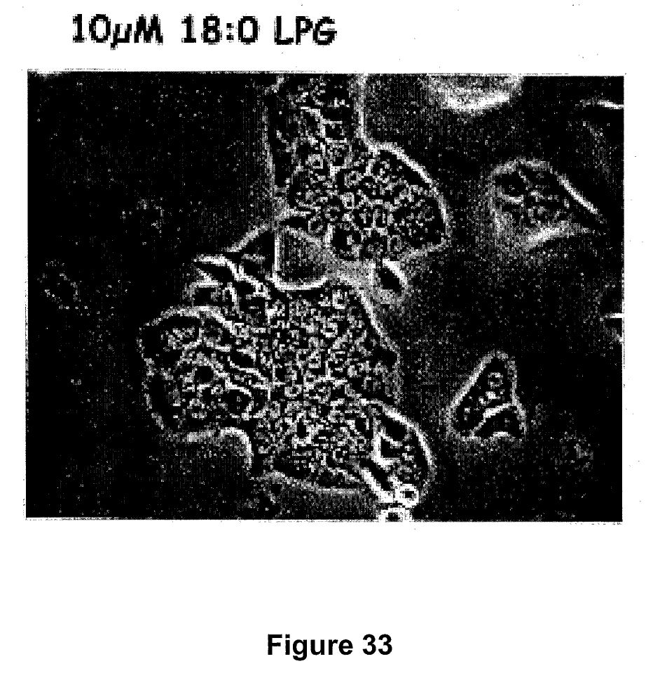

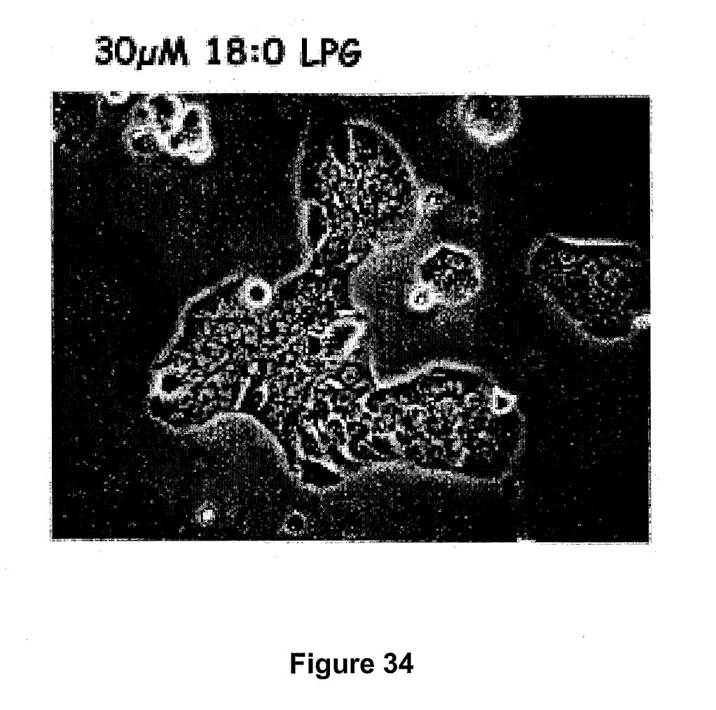

FIG. 32 demonstrates that 10% FBS induces LPA2 receptor mediated lamellipodia formation for colon cancer HT29 cells. FIG. 33 demonstrates that there is no inhibition of 10% FBS-induced LPA2 receptor mediated lamellipodia formation by 10 μM 18:0-acyl-LPG in colon cancer HT29 cells. FIG. 34 demonstrates that there is no inhibition of 10% FBS-induced LPA2 receptor mediated lamellipodia formation by 30 μM 18:0-acyl-LPG in colon cancer HT29 cells.

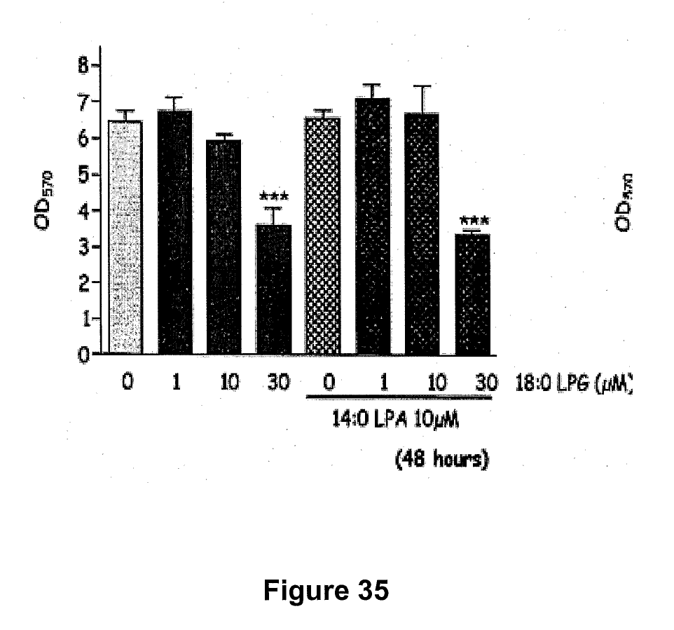

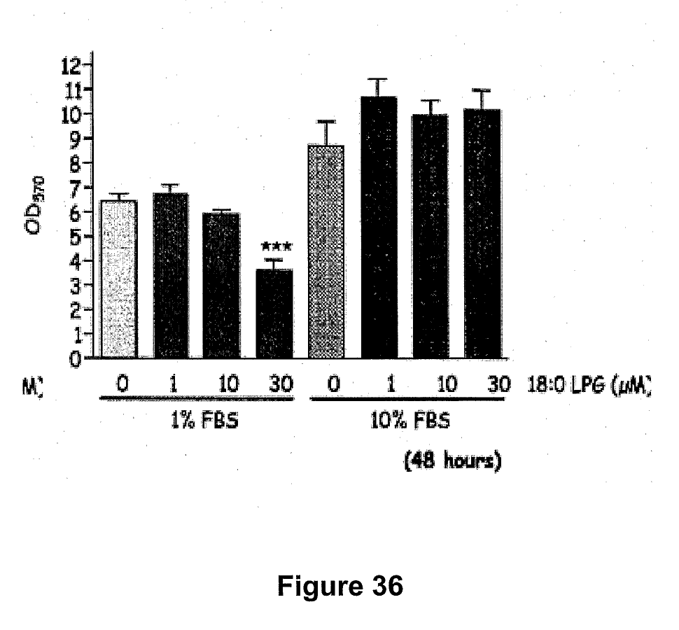

FIG. 35 demonstrates inhibition of cell growth (cell viability) at high concentrations of 18:0-acyl-LPG even in the presence of 10 μM of 14:0 LPA in colon cancer HT29 cells. FIG. 36 demonstrates inhibition of cell growth (cell viability) at high concentrations of 18:0-acyl-LPG only in the presence of low concentrations of FBS (1%) but not in the presence of high concentrations of FBS (10%) in colon cancer HT29 cells.

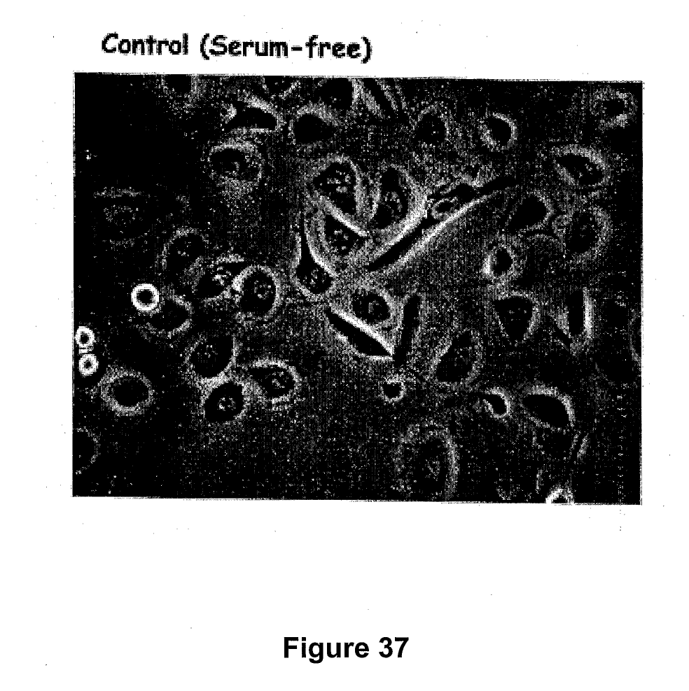

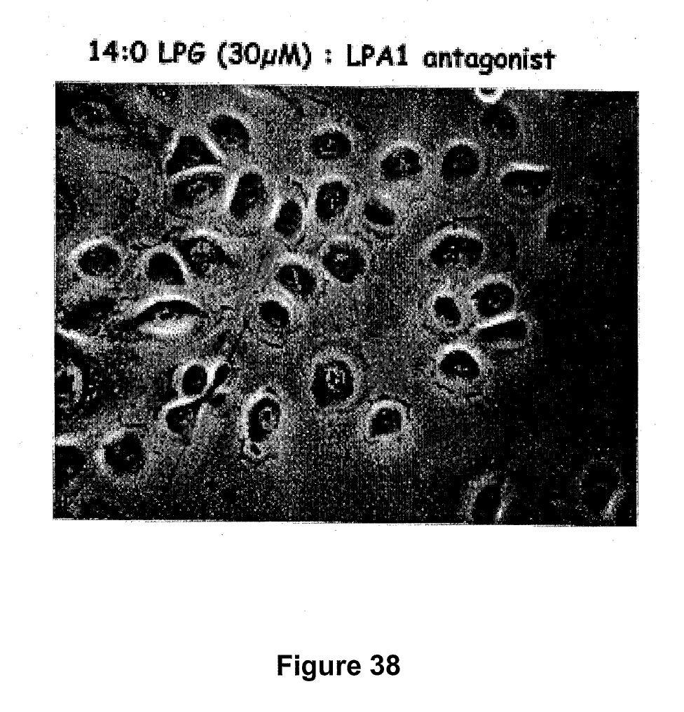

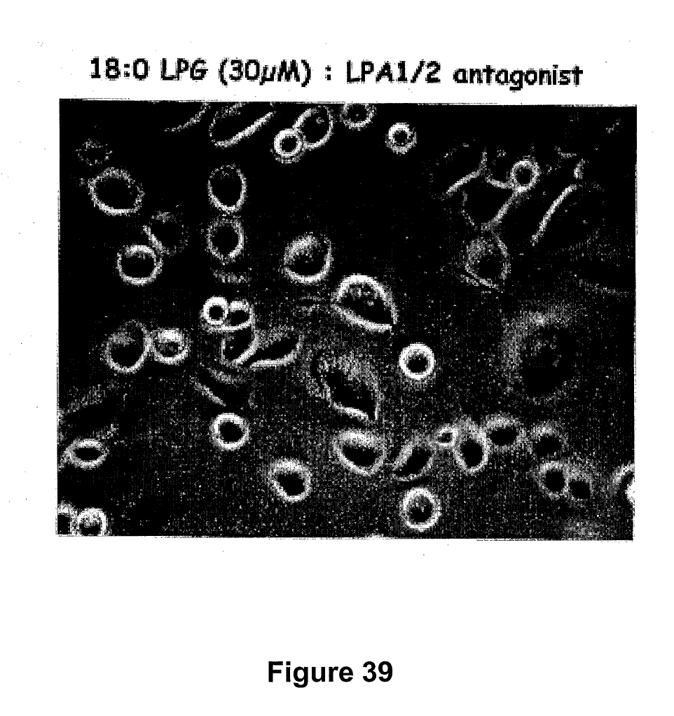

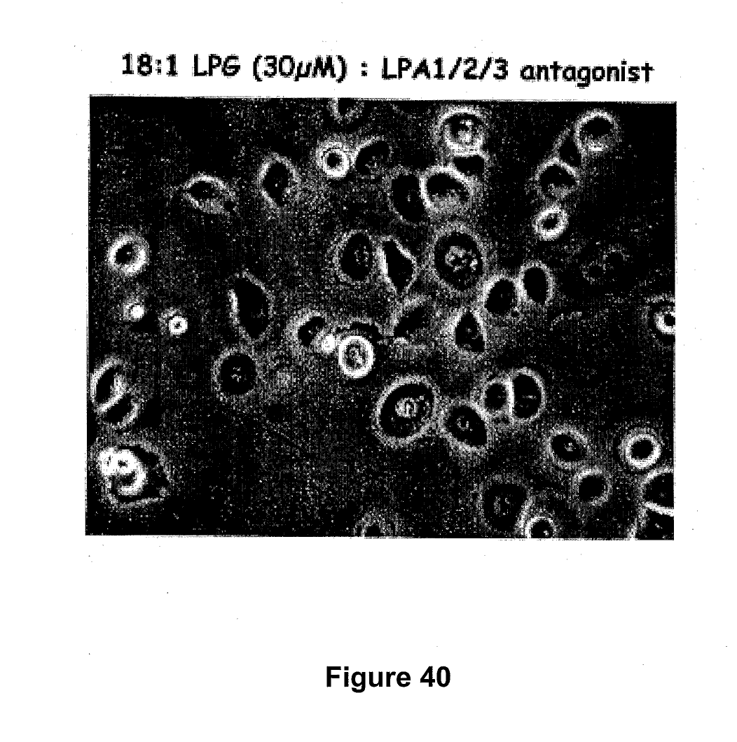

FIGS. 37-40 demonstrate the effect of 18:0-acyl-LPG and 18:1-acyl-LPG on lamellipodia formation in androgen insensitive prostate cancer PC-3 cells. As demonstrated in FIG. 21, 18:0-acyl-LPG and 18:1-acyl-LPG, but not 14:0-acyl-LPG, inhibit LPA2-mediated LPA signaling. FIG. 37 shows the structure of lamellipodia in androgen insensitive prostate cancer PC-3 cells as a control grown under serum-free medium where some lamellipodia are activated and formed. FIGS. 38-40 demonstrate that 18:0-acyl-LPG and 18:1-acyl-LPG are potential candidates for androgen insensitive prostate cancer treatments. FIG. 38 demonstrates the effect of 30 μM 14:0-LPG on LPA2 receptor mediated lamellipodia formation in androgen insensitive prostate cancer PC-3 cells. FIG. 39 demonstrates the effect of 30 μM 18:0-acyl-LPG on LPA2 receptor mediated lamellipodia formation in androgen insensitive prostate cancer PC-3 cells. FIG. 40 demonstrates the effect of 30 μM 18:1-acyl-LPG on LPA2 receptor mediated lamellipodia formation in androgen insensitive prostate cancer PC-3 cells. As shown in FIGS. 39 and 40, fewer lamellipodia were formed, showing that 18:0-acyl-LPG and 18:1-acyl-LPG inhibit spontaneously activated lamellipodia in androgen insensitive prostate cancer PC-3 cells. In contrast, in FIG. 38, 14:0-acyl-LPG shows negligible effect. These results suggest that 18:0-acyl-LPG and 18:1-acyl-LPG, but not 14:0-acyl-LPG, inhibit lamellipodia formation in androgen insensitive prostate cancer PC-3 cells and thus are potential anti-prostate cancer compounds.

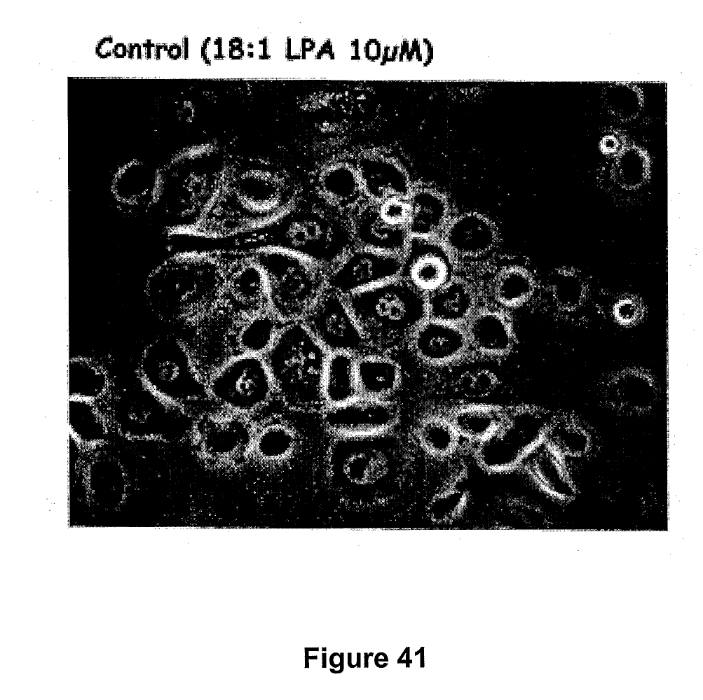

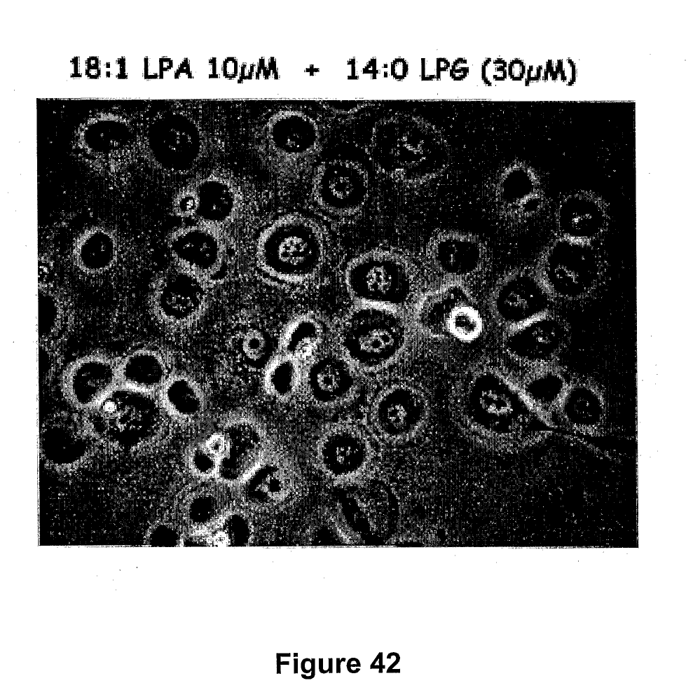

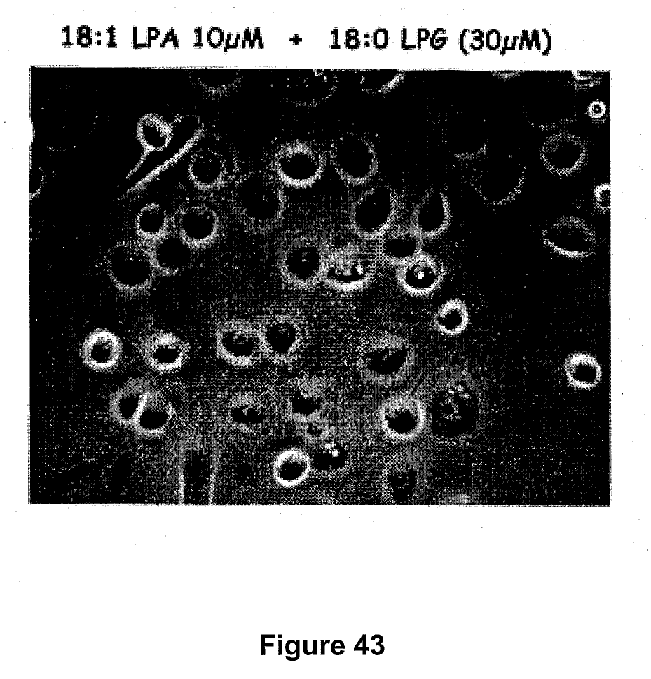

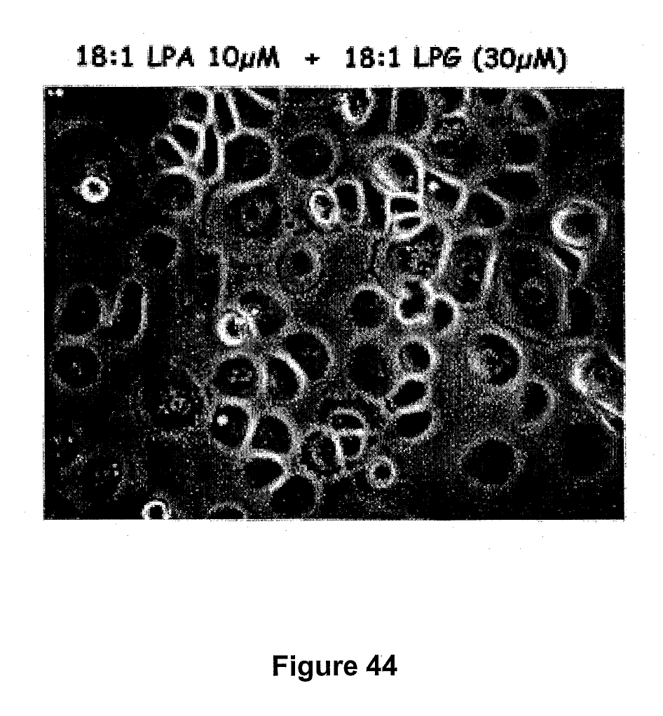

FIGS. 41-43 demonstrate the effect of 18:0-acyl-LPG and 18:1-acyl-LPG on LPA-induced lamellipodia formation in androgen insensitive prostate cancer PC-3 cells. As mentioned above, LPAs play a role as an autocrine mediator in androgen insensitive prostate cancer PC-3 cells. FIG. 41 demonstrates 18:1 LPA induces LPA2 receptor mediated lamellipodia formation for androgen insensitive prostate cancer PC-3 cells since there is more lamellipodia formed as compared to the serum-free control in FIG. 37. FIG. 42 demonstrates that there is no inhibition of 18:1 LPA-induced LPA2 receptor mediated lamellipodia formation by 30 μM 14:0-acyl-LPG in androgen insensitive prostate cancer PC-3 cells. FIG. 43 demonstrates the inhibition of 18:1 LPA-induced LPA2 receptor mediated lamellipodia formation by 30 μM 18:0-acyl-LPG in androgen insensitive prostate cancer PC-3 cells. FIG. 44 demonstrates the inhibition of 18:1 LPA-induced LPA2 receptor mediated lamellipodia formation by 30 μM 18:1-acyl-LPG in androgen insensitive prostate cancer PC-3 cells. Thus, it is concluded that LPA may stimulate lamellipodia formation (FIG. 37: Control PC-3 cells, FIG. 41: PC-3 cells exposed to 18:1 LPA). In addition, 18:0-acyl-LPG and 18:1-acyl-LPG inhibit the LPA-induced lamellipodia formation (FIGS. 42 and 43), although, 14:0-acyl-LPG did not inhibit the LPA-induced lamellipodia formation (FIG. 40). These results demonstrated in androgen insensitive prostate cancer PC-3 cells further confirm that 18:0-acyl-LPG and 18:1-acyl-LPG are inhibitors to LPA2 signaling and can be used as potential anti-prostate cancer compounds.

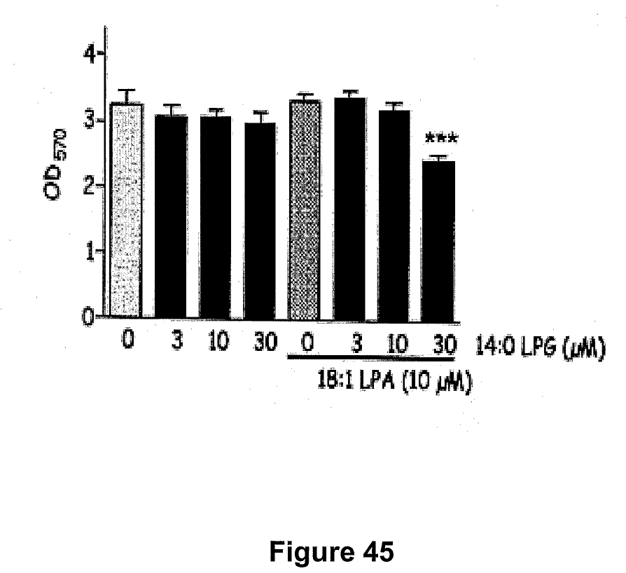

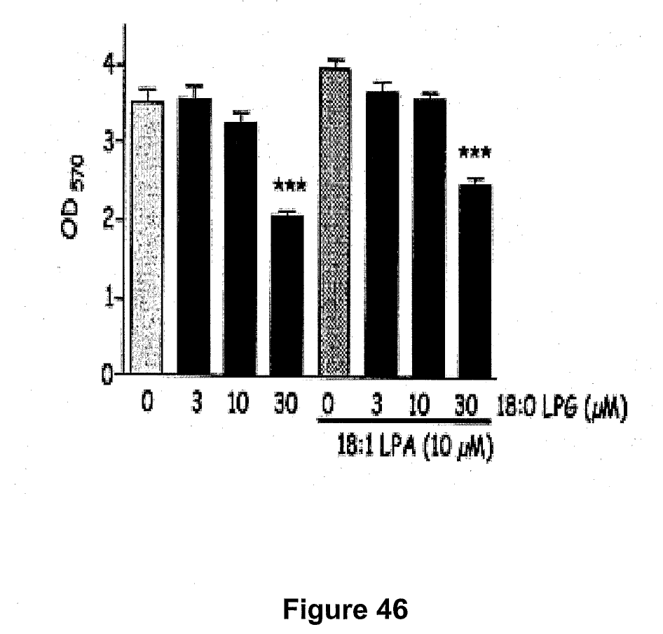

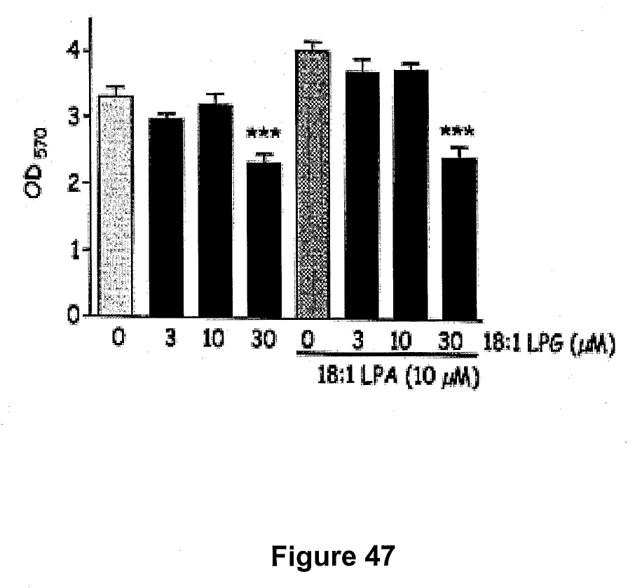

FIG. 45 demonstrates inhibition of cell growth (cell viability) at high concentrations of 14:0-acyl-LPG in the presence of 10 μM of 18:1 LPA in androgen insensitive prostate cancer PC-3 cells. FIG. 46 demonstrates inhibition of cell growth (cell viability) at high concentrations of 18:0-acyl-LPG, and also in the presence of 10 μM of 18:1 LPA in androgen insensitive prostate cancer PC-3 cells. FIG. 47 demonstrates inhibition of cell growth (cell viability) at high concentrations of 18:1-acyl-LPG, and also in the presence of 10 μM of 18:1 LPA in androgen insensitive prostate cancer PC-3 cells. These results support that LPA derivatives, LPGs, are potential anti-prostate cancer compounds.

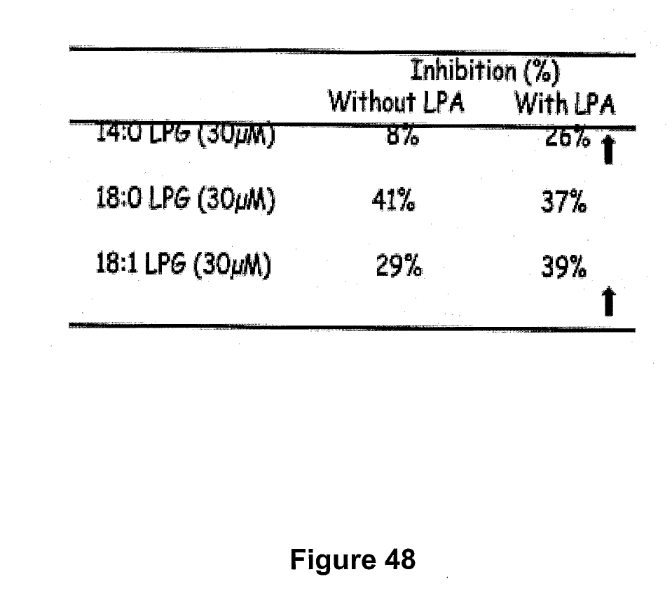

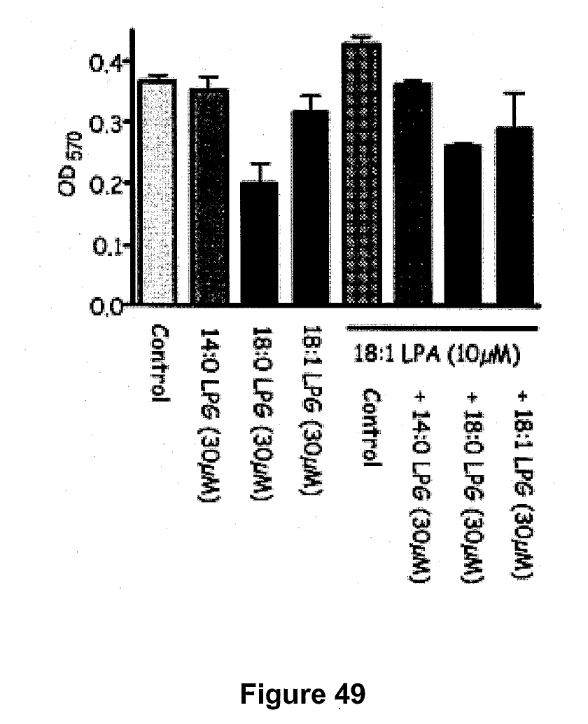

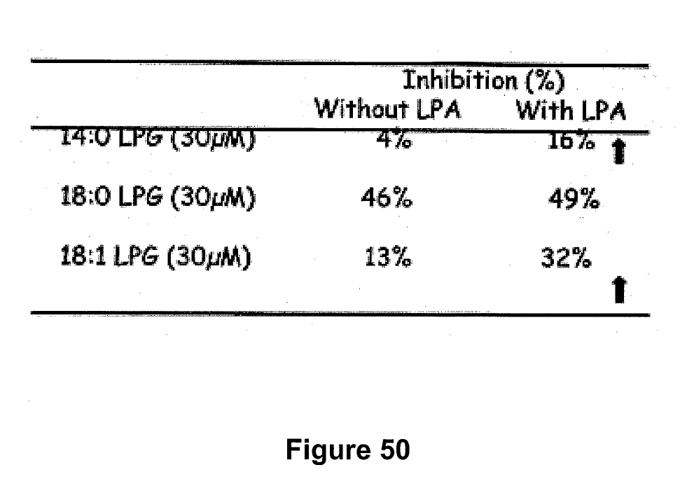

FIG. 48 summarizes the inhibition of cell growth by various LPA derivatives with and without the presence of LPA in androgen insensitive prostate cancer PC-3 cells. FIG. 49 demonstrates the inhibition of cell growth by various LPA derivatives with and without the presence of LPA in androgen insensitive prostate cancer DU145 cells. FIG. 50 summarizes the inhibition of cell growth by various LPA derivatives with and without the presence of LPA in androgen insensitive prostate cancer DU145 cells. These results further support that LPGs can be used as anti-cancer compounds for androgen insensitive prostate cancer.

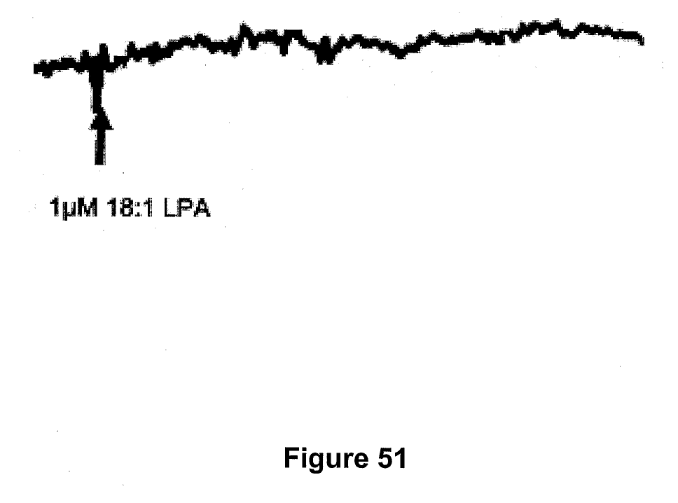

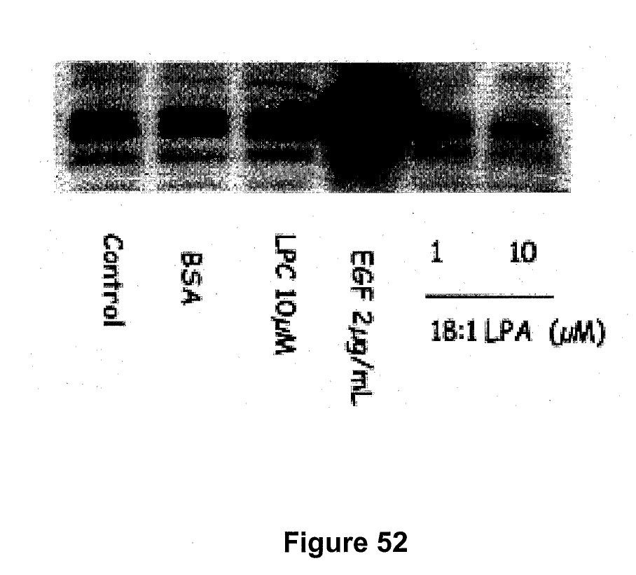

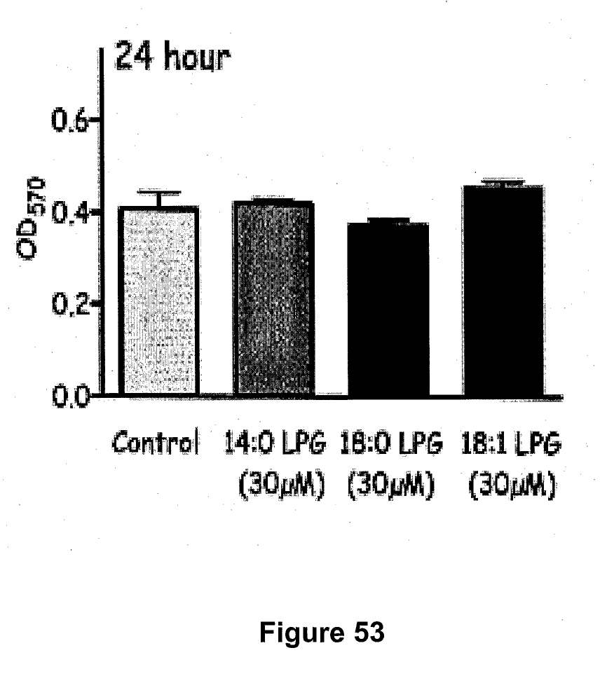

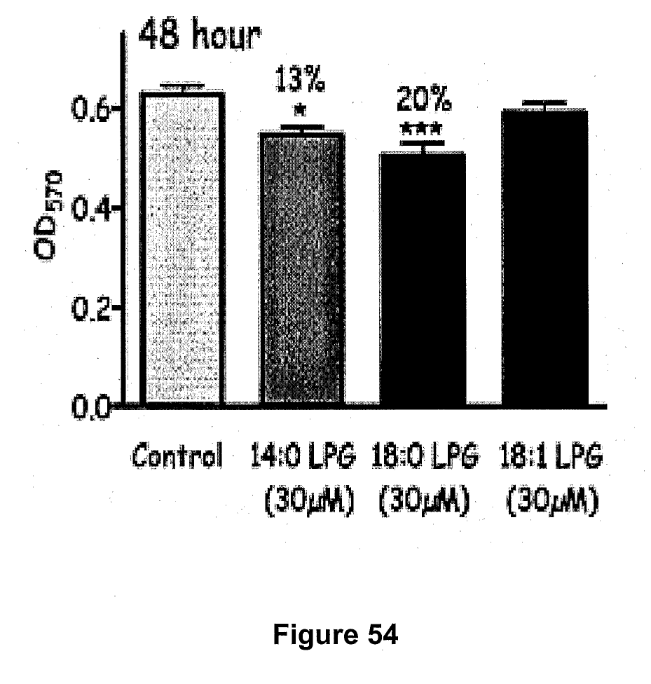

FIGS. 51-54 demonstrate that the androgen sensitive prostate cancer cell line, LNCaP, is a LPA insensitive cell line. FIG. 51 shows no calcium mobilization in the presence of 18:1 LPA in androgen sensitive prostate cancer LNCaP cells. FIG. 52 demonstrates no phosphorylation of p42 and p44 MAP kinase in the presence of 18:1 LPA in androgen sensitive prostate cancer LNCaP cells. FIG. 53 demonstrates no decrease in cell viability in the presence of various LPA derivatives in androgen sensitive prostate cancer LNCaP cells after about 24 hours. FIG. 54 demonstrates a minor reduction of cell viability in the presence of some LPA derivatives in androgen sensitive prostate cancer LNCaP cells after about 48 hours. The results confirm that various LPA derivatives cannot decrease cell viability in LNCaP cells. Even when LNCaP cells were exposed to LPA derivatives for 48 hours, the effects of LPA derivatives are negligible (FIG. 54). The fact that no inhibition in LPA insensitive LNCaP cell line by LPGs further demonstrate that LPA derivatives, LPGs, are selective inhibitors for LPA receptor-directed signaling.

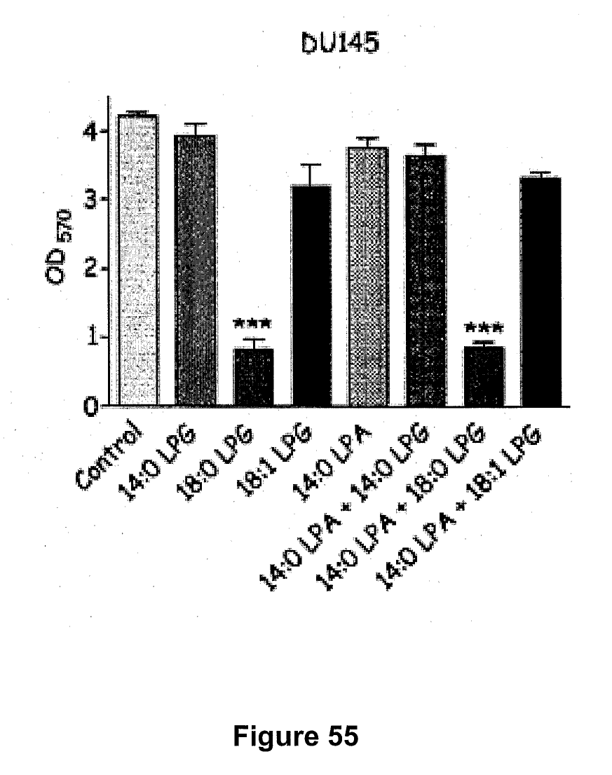

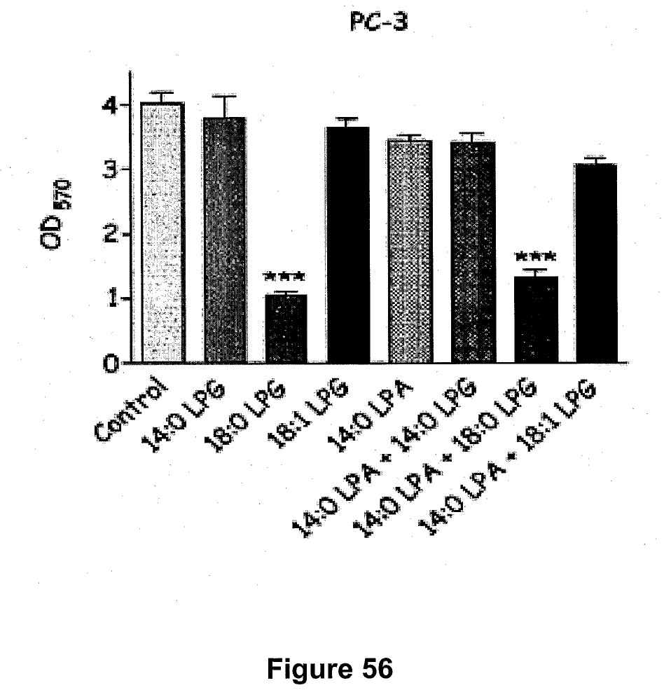

FIG. 55 demonstrates some LPA derivatives (e.g., 18:0-acyl-LPG) reduce focal adhesion in androgen insensitive prostate cancer DU145 cells. FIG. 56 demonstrates some LPA derivatives (e.g., 18:0-acyl-LPG) reduce focal adhesion in androgen insensitive prostate cancer PC-3 cells. These results further support that LPA derivatives are potential anti-prostate cancer compounds

8. In Vivo Pre-Clinical Pharmacology and Animal Studies

Effective DPIEL derivatives and LPG derivatives are assessed in in vivo anti-tumor models for their ability to inhibit solid tumor growth, such as prostate tumor growth. As an example, prostate cancer cell lines, PC-3 and DU145 cells, are implanted subcutaneously or by other means in SCID nude mice. Intraperitoneal injection of compounds of the invention is followed after tumor inoculation. No injection of the compounds is performed as a control. Compounds of the invention can also be delivered by other methods known in the art. These approaches allow assessment of the modulators of LPA signaling on PC-3 and DU145 cells. Tumor growth is measured by the size and/or volume (e.g., in mm³) of the solid tumor developed at the site of the implant of cancer cells of the SCID mice. Anti-tumor and/or tumor promoting activity of the compounds of the invention are observed in comparison with the control without the injection of the compounds using statistical analysis of Bonferroni's multiple t-test, followed by ANOVA.

While the foregoing is directed to embodiments of the present invention, other and further embodiments of the invention may be devised without departing from the basic scope thereof, and the scope thereof is determined by the claims that follow.

1. A compound having the formula: 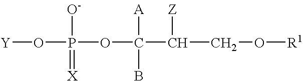
wherein R′ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, A is selected from the group consisting of hydrogen, hydroxyl, and halogen, B is selected from the group consisting of hydrogen, hydroxyl, and halogen, Z is selected from the group consisting of hydrogen, hydroxyl, halogen, haloakyl, haloalkyloxy, alkyl, alkenyl, alkylnyl, saturated acyl, unsaturated acyl, alkoxy, alkenyloxy, and alkynyloxy, X is selected from the group consisting of oxygen and sulfur, Y is selected from the group consisting of hydrogen, halogen, saturated and unsaturated haloakyl, saturated and unsaturated haloalkyloxy, alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, substituted aryloxy, and lower alicyclic-oxy groups which are optionally substituted with one or more hydroxy or lower alkoxy groups; or a mimetic, stereoisomer, enantiomer, or pharmaceutically acceptable salt thereof, and when X is oxygen and A and B are both hydrogen, then Y is not hydrogen.

2. The compound of claim 1, wherein Y is selected from the group consisting of halogen, saturated and unsaturated haloakyl, saturated and unsaturated haloalkyloxy, where a halo group is selected from the group consisting of fluoro, chloro, bromo, and iodo; or a mimetic, stereoisomer, enantiomer, or pharmaceutically acceptable salt thereof.

3. The compound of claim 1, wherein Y is selected from the group consisting of saturated or unsaturated, straight or branched chain of alkoxy, acyl, aryl, heteroaryl, and aralkyl, having six or more carbon atoms and optionally being substituted with one or more hydroxy or lower alkoxy groups; or a mimetic, stereoisomer, enantiomer, or pharmaceutically acceptable salt thereof.

4. The compound of claim 1, wherein Y is an alicyclic ring selected from the group consisting of one, di-, tri-, tetra-, penta-, hexahydroxyhexyloxy, and derivatives thereof.

5. The compound of claim 1, wherein X is sulfur.

6. The compound of claim 5, wherein the compound is selected from the group consisting of 1-alkyl-sn2-hydroxide-rac-glycero-3-phosphothionate, 1-alkenyl-sn2-hydroxide-rac-glycero-3-phosphothionate, 1-alkynyl-sn2-hydroxide-rac-glycero-3-phosphothionate, 1-acyl-sn2-hydroxide-rac-glycero-3-phosphothionate, 1-alkyl-sn2-O-methyl-rac-glycero-3-phosphothionate, 1-alkenyl-sn2-O-methyl-rac-glycero-3-phosphothionate, 1-alkynyl-sn2-O-methyl-rac-glycero-3-phosphothionate, and derivatives thereof.

7. The compound of claim 6, wherein the compound is selected from the group consisting of 1-lauryl-sn2-hydroxide-rac-glycero-3-phosphothionate, 1-myristyl-sn2-hydroxide-rac-glycero-3-phosphothionate, 1-palmityl-sn2-hydroxide-rac-glycero-3-phosphothionate, 1-stearyl-sn2-hydroxide-rac-glycero-3-phosphothionate, 1-oleyl-sn2-hydroxide-rac-glycero-3-phosphothionate, 1-linoleyl-sn2-hydroxide-rac-glycero-3-phosphothionate, 1-linolenyl-sn2-hydroxide-rac-glycero-3-phosphothionate, 1-eleosteryl-sn2-hydroxide-rac-glycero-3-phosphothionate, 1-lauryl-sn2-O-methyl-rac-glycero-3-phosphothionate, 1-myristyl-sn2-O-methyl-rac-glycero-3-phosphothionate, 1-palmityl-sn2-O-methyl-rac-glycero-3-phosphothionate, 1-stearyl-sn2-O-methyl-rac-glycero-3-phosphothionate, 1-oleyl-sn2-O-methyl-rac-glycero-3-phosphothionate, 1-linoleyl-sn2-O-methyl-rac-glycero-3-phosphothionate, 1-linolenyl-sn2-O-methyl-racglycero-3-phosphothionate, 1-eleosteryl-sn2-O-methyl-rac-glycero-3-phosphothionate, and derivatives thereof.

8. The compound of claim 5, wherein the compound is selected from the group consisting of 2-alkyl-sn-1-hydroxide-rac-glycero-3-phosphothionate, 2-alkenyl-sn-1-hydroxide-rac-glycero-3-phosphothionate, 2-alkynyl-sn-1-hydroxide-rac-glycero-3-phosphothionate, 2-acyl-sn-1-hydroxide-rac-glycero-3-phosphothionate, 2-alkyl-sn-1-O-methyl-rac-glycero-3-phosphothionate, 2-alkenyl-sn-1-O-methyl-rac-glycero-3-phosphothionate, 2-alkynyl-sn-1-O-methyl-rac-glycero-3-phosphothionate, 2-acyl-sn-1-O-methyl-rac-glycero-3-phosphothionate, and derivatives thereof.

9. The compound of claim 8, wherein the compound is selected from the group consisting of 2-lauryl-sn-1-hydroxide-rac-glycero-3-phosphothionate, 2-myristyl-sn-1-hydroxide-rac-glycero-3-phosphothionate, 2-palmityl-sn-1-hydroxide-rac-glycero-3-phosphothionate, 2-stearyl-sn-1-hydroxide-rac-glycero-3-phosphothionate, 2-oleyl-sn-1-hydroxide-rac-glycero-3-phosphothionate, 2-linoleyl-sn-1-hydroxide-racglycero-3-phosphothionate, 2-linolenyl-sn-1-hydroxide-rac-glycero-3-phosphothionate, 2-eleosteryl-sn-1-hydroxide-rac-glycero-3-phosphothionate, 2-lauryl-sn-1-O-methyl-rac-glycero-3-phosphothionate, 2-myristyl-sn-1-O-methyl-rac-glycero-3-phosphothionate, 2-palmityl-sn-1-O-methyl-rac-glycero-3-phosphothionate, 2-steaoyl-sn-1-O-methyl-rac-glycero-3-phosphothionate, 2-oleyl-sn-1-O-methyl-rac-glycero-3-phosphothionate, 2-linoleyl-sn-1-O-methyl-rac-glycero-3-phosphothionate, 2-linolenyl-sn-1-O-methyl-rac-glycero-3-phosphothionate, 2-eleosteryl-sn-1-O-methyl-rac-glycero-3-phosphothionate, 2-lauroyl-sn-1-hydroxide-rac-glycero-3-phosphothionate, 2-myristoyl-sn-1-hydroxide-rac-glycero-3-phosphothionate, 2-palmitoyl-sn-1-hydroxide-rac-glycero-3-phosphothionate, 2-stearoyl-sn-1-hydroxide-rac-glycero-3-phosphothionate, 2-oleoyl-sn-1-hydroxide-rac-glycero-3-phosphothionate, 2-linoleoyl-sn-1-hydroxide-rac-glycero-3-phosphothionate, 2-linolenoyl-sn-1-hydroxide-rac-glycero-3-phosphothionate, 2-eleosteroyl-sn-1-hydroxide-rac-glycero-3-phosphothionate, 2-lauroyl-sn-1-O-methyl-rac-glycero-3-phosphothionate, 2-myristoyl-sn-1-O-methyl-rac-glycero-3-phosphothionate, 2-palmitoyl-sn-1-O-methyl-rac-glycero-3-phosphothionate, 2-stearoyl-sn-1-O-methyl-rac-glycero-3-phosphothionate, 2-oleoyl-sn-1-O-methyl-rac-glycero-3-phosphothionate, 2-linoleoyl-sn-1-O-methyl-rac-glycero-3-phosphothionate, 2-linolenoyl-sn-1-O-methyl-rac-glycero-3-phosphothionate, 2-eleosteroyl-sn-1-O-methyl-rac-glycero-3-phosphothionate, and derivatives thereof.

10. The compound of claim 1, wherein Y is halogen selected from the group consisting of fluoro, chloro, bromo, and iodo.

11. The compound of claim 10, wherein the compound is selected from the group consisting of 1-alkyl-sn2-hydroxide-rac-glycero-3-halophosphate, 1-alkenyl-sn2-hydroxide-rac-glycero-3-halophosphate, 1-alkynyl-sn2-hydroxide-rac-glycero-3-halophosphate, 1-acyl-sn2-hydroxide-rac-glycero-3-halophosphate, 1-alkyl-sn2-O-methyl-rac-glycero-3-halophosphate, 1-alkenyl-sn2-O-methyl-rac-glycero-3-halophosphate, 1-alkynyl-sn2-O-methyl-rac-glycero-3-halophosphate, 1-acyl-sn2-O-methyl-rac-glycero-3-halophosphate, 1-alkyl-sn2-hydroxide-rac-glycero-3-halophosphothionate, 1-alkenyl-sn2-hydroxide-rac-glycero-3-halophosphothionate, 1-alkynyl-sn2-hydroxide-rac-glycero-3-halophosphothionate, 1-acyl-sn2-hydroxiderac-glycero-3-halophosphothionate, 1-alkyl-sn2-O-methyl-rac-glycero-3-halophosphothionate, 1-alkenyl-sn2-O-methyl-rac-glycero-3-halophosphothionate, 1-alkynyl-sn2-O-methyl-rac-glycero-3-halophosphothionate, 1-acyl-sn2-O-methyl-rac-glycero-3-halophosphothionate, and derivatives thereof.

12. The compound of claim 11, wherein the compound is selected from the group consisting of 1-alkyl-sn2-hydroxide-rac-glycero-3-fluorophosphate, 1-alkenyl-sn2-hydroxide-rac-glycero-3-fluorophosphate, 1-alkynyl-sn2-hydroxide-rac-glycero-3-fluorophosphate, 1-acyl-sn2-hydroxide-rac-glycero-3-fluorophosphate, 1-alkyl-sn2-O-methyl-rac-glycero-3-fluorophosphate, 1-alkenyl-sn2-O-methyl-rac-glycero-3-fluorophosphate, 1-alkynyl-sn2-O-methyl-rac-glycero-3-fluorophosphate, 1-acyl-sn2-O-methyl-rac-glycero-3-fluorophosphate, 1-alkyl-sn2-hydroxide-rac-glycero-3-bromophosphate, 1-alkenyl-sn2-hydroxide-rac-glycero-3-bromophosphate, 1-alkynyl-sn2-hydroxide-rac-glycero-3-bromophosphate, 1-acyl-sn2-hydroxide-rac-glycero-3-bromophosphate, 1-alkyl-sn2-O-methyl-rac-glycero-3-bromophosphate, 1-alkenyl-sn2-O-methyl-rac-glycero-3-bromophosphate, 1-alkynyl-sn2-O-methyl-rac-glycero-3-bromophosphate, 1-acyl-sn2-O-methyl-rac-glycero-3-bromophosphate, and derivatives thereof.

13. The compound of claim 11, wherein the compound is selected from the group consisting of 1-lauryl-sn2-hydroxide-rac-glycero-3-fluorophosphate, 1-myristyl-sn2-hydroxide-rac-glycero-3-fluorophosphate, 1-palmityl-sn2-hydroxide-rac-glycero-3-fluorophosphate, 1-stearyl-sn2-hydroxide-rac-glycero-3-fluorophosphate, 1-oleyl-sn2-hydroxide-rac-glycero-3-fluorophosphate, 1-linoleyl-sn2-hydroxide-rac-glycero-3-fluorophosphate, 1-linolenyl-sn2-hydroxide-rac-glycero-3-fluorophosphate, 1-eleosteryl-sn2-hydroxide-rac-glycero-3-fluorophosphate, 1-lauryl-sn2-O-methyl-rac-glycero-3-fluorophosphate, 1-myristyl-sn2-O-methyl-rac-glycero-3-fluorophosphate, 1-palmityl-sn2-O-methyl-rac-glycero-3-fluorophosphate, 1-stearyl-sn2-O-methyl-rac-glycero-3-fluorophosphate, 1-oleyl-sn2-O-methyl-rac-glycero-3-fluorophosphate, 1-linoleyl-sn2-O-methyl-rac-glycero-3-fluorophosphate, 1-linolenyl-sn2-O-methyl-racglycero-3-fluorophosphate, 1-eleosteryl-sn2-O-methyl-rac-glycero-3-fluorophosphate, 1-myristoyl-sn2-hydroxide-rac-glycero-3-fluorophosphate, 1-palmitoyl-sn2-hydroxide-rac-glycero-3-fluorophosphate, 1-stearoyl-sn2-hydroxide-rac-glycero-3-fluorophosphate, 1-oleoyl-sn2-hydroxide-rac-glycero-3-fluorophosphate, 1-linoleoyl-sn2-hydroxide-rac-glycero-3-fluorophosphate, 1-linolenoyl-sn2-hydroxide-rac-glycero-3-fluorophosphate, 1-eleosteroyl-sn2-hydroxide-rac-glycero-3-fluorophosphate, 1-lauroyl-sn2-O-methyl-rac-glycero-3-fluorophosphate, 1-myristoyl-sn2-O-methyl-rac-glycero-3-fluorophosphate, 1-palmitoyl-sn2-O-methyl-rac-glycero-3-fluorophosphate, 1-stearoyl-sn2-O-methyl-rac-glycero-3-fluorophosphate, 1-oleoyl-sn2-O-methyl-rac-glycero-3-fluorophosphate, 1-linoleoyl-sn2-O-methyl-racglycero-3-fluorophosphate, 1-linolenoyl-sn2-O-methyl-rac-glycero-3-fluorophosphate, 1-eleosteroyl-sn2-O-methyl-rac-glycero-3-fluorophosphate, and derivatives thereof.

14. The compound of claim 11, wherein the compound is selected from the group consisting of 1-lauryl-sn2-hydroxide-rac-glycero-3-bromophosphate, 1-myristyl-sn2-hydroxide-rac-glycero-3-bromophosphate, 1-palmityl-sn2-hydroxide-rac-glycero-3-bromophosphate, 1-stearyl-sn2-hydroxide-rac-glycero-3-bromophosphate, 1-oleyl-sn2-hydroxide-rac-glycero-3-bromophosphate, 1-linoleyl-sn2-hydroxide-rac-glycero-3-bromophosphate, 1-linolenyl-sn2-hydroxide-rac-glycero-3-bromophosphate, 1-eleosteryl-sn2-hydroxide-rac-glycero-3-bromophosphate, 1-lauryl-sn2-O-methyl-racglycero-3-bromophosphate, 1-myristyl-sn2-O-methyl-rac-glycero-3-bromophosphate, 1-palmityl-sn2-O-methyl-rac-glycero-3-bromophosphate, 1-stearyl-sn2-O-methyl-racglycero-3-bromophosphate, 1-oleyl-sn2-O-methyl-rac-glycero-3-bromophosphate, 1-linoleyl-sn2-O-methyl-rac-glycero-3-bromophosphate, 1-linolenyl-sn2-O-methyl-rac-glycero-3-bromophosphate, 1-eleosteryl-sn2-O-methyl-rac-glycero-3-bromophosphate, 1-lauroyl-sn2-hydroxide-rac-glycero-3-bromophosphate, 1-myristoyl-sn2-hydroxide-rac-glycero-3-bromophosphate, 1-palmitoyl-sn2-hydroxide-rac-glycero-3-bromophosphate, 1-stearoyl-sn2-hydroxide-rac-glycero-3-bromophosphate, 1-oleoyl-sn2-hydroxide-rac-glycero-3-bromophosphate, 1-linoleoyl-sn2-hydroxide-rac-glycero-3-bromophosphate, 1-linolenoyl-sn2-hydroxiderac-glycero-3-bromophosphate, 1-eleosteroyl-sn2-hydroxide-rac-glycero-3-bromophosphate, 1-lauroyl-sn2-O-methyl-rac-glycero-3-bromophosphate, 1-myristoyl-sn2-O-methyl-rac-glycero-3-bromophosphate, 1-palmitoyl-sn2-O-methylrac-glycero-3-bromophosphate, 1-stearoyl-sn2-O-methyl-rac-glycero-3-bromophosphate, 1-oleoyl-sn2-O-methyl-rac-glycero-3-bromophosphate, 1-linoleoyl-sn2-O-methyl-rac-glycero-3-bromophosphate, 1-linolenoyl-sn2-O-methylrac-glycero-3-bromophosphate, 1-eleosteroyl-sn2-O-methyl-rac-glycero-3-bromophosphate, and derivatives thereof.

15. The compound of claim 1, wherein R′ is selected from the group consisting of saturated or unsaturated, substituted or unsubstituted, straight or branched chain of alkyl, alkenyl, alkylnyl, and acyl, having six or more carbon atoms; or a mimetic, stereoisomer, enantiomer, or pharmaceutically acceptable salt thereof.

16. The compound of claim 15, wherein R′ comprises an alkyl or acyl having nine or more carbon atoms selected from the group consisting of saturated carbon-carbon bonds, one unsaturated carbon bond, two or more unsaturated carbon bonds, and derivatives thereof.

17. The compound of claim 1, wherein Z is selected from the group consisting of hydroxyl, halogen, haloakyl, haloalkyloxy, alkoxy, alkenyloxy, and alkynyloxy.

18. The compound of claim 17, wherein Z is selected from the group consisting of hydroxyl and methoxyl.

19. The compound of claim 18, wherein X is sulfur.

20. The compound of claim 19, wherein Y is an alicyclic ring selected from the group consisting of one, di-, tri-, tetra-, penta-, hexahydroxyhexyloxy, and derivatives thereof.

21. The compound of claim 1, wherein R′ is selected from the group consisting of alkyl, alkenyl, alkylnyl and acyl, Z is a hydroxyl group, and Y is selected from the group consisting of halogen, saturated and unsaturated haloakyl, saturated and unsaturated haloalkyloxy, alkoxy, alkenyloxy, alkynyloxy, aryl, aryloxy, which are optionally substituted with one or more hydroxy or lower alkoxy groups, and derivatives thereof.

22. The compound of claim 1, wherein R′ is selected from the group consisting of alkyl, alkenyl, alkylnyl and acyl, Z is a methoxyl group, and Y is selected from the group consisting of halogen, saturated and unsaturated haloakyl, saturated and unsaturated haloalkyloxy, alkoxy, alkenyloxy, alkynyloxy, aryl, heteroaryl, aryloxy, and lower alicyclic-oxy groups which are optionally substituted with one or more hydroxy or lower alkoxy groups; or a mimetic, stereoisomer, enantiomer, or pharmaceutically acceptable salt thereof.

23. The compound of claim 22, wherein Y is an alicyclic ring selected from the group consisting of one, di-, tri-, tetra-, penta-, hexahydroxyhexyloxy, and derivatives thereof.

24. The compound of claim 1, wherein A and B are each independently selected from the group consisting of hydrogen, hydroxyl, and halogen, and the compound comprises a halogen group selected from the group consisting of fluoro, chloro, bromo, and iodo.

25. The compound of claim 24, wherein the compound is selected from the group consisting of 1-alkyl-sn2-hydroxide-sn3-halo-rac-glycero-3-phosphate, 1-alkenyl-sn2-hydroxide-sn3-halo-rac-glycero-3-phosphate, 1-alkynyl-sn2-hydroxide-sn3-halo-rac-glycero-3-phosphate, 1-acyl-sn2-hydroxide-sn3-halo-rac-glycero-3-phosphate, 1-alkyl-sn2-O-methyl-sn3-halo-rac-glycero-3-phosphate, 1-alkenyl-sn2-O-methyl-sn3-halo-rac-glycero-3-phosphate, 1-alkynyl-sn2-O-methyl-sn3-halo-rac-glycero-3-phosphate, 1-acyl-sn2-O-methyl-sn3-halo-rac-glycero-3-phosphate, 1-alkyl-sn2-hydroxide-sn3-halo-rac-glycero-3-phosphothionate, 1-alkenyl-sn2-hydroxide-sn3-halo-rac-glycero-3-phosphothionate, 1-alkynyl-sn2-hydroxide-sn3-halo-rac-glycero-3-phosphothionate, 1-acyl-sn2-hydroxide-sn3-halo-rac-glycero-3-phosphothionate, 1-alkyl-sn2-O-methyl-sn3-halo-rac-glycero-3-phosphothionate, 1-alkenyl-sn2-O-methyl-sn3-halo-rac-glycero-3-phosphothionate, 1-alkynyl-sn2-O-methyl-sn3-halorac-glycero-3-phosphothionate, 1-acyl-sn2-O-methyl-sn3-halo-rac-glycero-3-phosphothionate, 1-alkyl-sn2-hydroxide-sn3-halo-rac-glycero-3-phosphonate, 1-alkenyl-sn2-hydroxide-sn3-halo-rac-glycero-3-phosphonate, 1-alkynyl-sn2-hydroxide-sn3-halo-rac-glycero-3-phosphonate, 1-acyl-sn2-hydroxide-sn3-halo-racglycero-3-phosphonate, 1-alkyl-sn2-O-methyl-sn3-halo-rac-glycero-3-phosphonate, 1-alkenyl-sn2-O-methyl-sn3-halo-rac-glycero-3-phosphonate, 1-alkynyl-sn2-O-methyl-sn3-halo-rac-glycero-3-phosphonate, 1-acyl-sn2-O-methyl-sn3-halo-racglycero-3-phosphonate and derivatives thereof.

26. The compound of claim 24, wherein the compound is selected from the group consisting of 1-alkyl-sn2-hydroxide-sn3-dihalo-rac-glycero-3-phosphate, 1-alkenyl-sn2-hydroxide-sn3-dihalo-rac-glycero-3-phosphate, 1-alkynyl-sn2-hydroxide-sn3-dihalo-rac-glycero-3-phosphate, 1-acyl-sn2-hydroxide-sn3-dihalo-rac-glycero-3-phosphate, 1-alkyl-sn2-O-methyl-sn3-dihalo-rac-glycero-3-phosphate, 1-alkenyl-sn2-O-methyl-sn3-dihalo-rac-glycero-3-phosphate, 1-alkynyl-sn2-O-methyl-sn3-dihalo-rac-glycero-3-phosphate, 1-acyl-sn2-O-methyl-sn3-dihalo-rac-glycero-3-phosphate, 1-alkyl-sn2-hydroxide-sn3-dihalo-rac-glycero-3-phosphothionate, 1-alkenyl-sn2-hydroxide-sn3-dihalo-rac-glycero-3-phosphothionate, 1-alkynyl-sn2-hydroxide-sn3-dihalo-rac-glycero-3-phosphothionate, 1-acyl-sn2-hydroxide-sn3-dihalo-rac-glycero-3-phosphothionate, 1-alkyl-sn2-O-methyl-sn3-dihalo-rac-glycero-3-phosphothionate, 1-alkenyl-sn2-O-methyl-sn3-dihalo-rac-glycero-3-phosphothionate, 1-alkynyl-sn2-O-methyl-sn3-dihalo-rac-glycero-3-phosphothionate, 1-acyl-sn2-O-methyl-sn3-dihalo-rac-glycero-3-phosphothionate, 1-alkyl-sn2-hydroxide-sn3-dihalo-rac-glycero-3-phosphonate, 1-alkenyl-sn2-hydroxide-sn3-dihalo-rac-glycero-3-phosphonate, 1-alkynyl-sn2-hydroxide-sn3-dihalo-rac-glycero-3-phosphonate, 1-acyl-sn2-hydroxide-sn3-dihalo-rac-glycero-3-phosphonate, 1-alkyl-sn2-O-methyl-sn3-dihalo-rac-glycero-3-phosphonate, 1-alkenyl-sn2-O-methyl-sn3-dihalo-rac-glycero-3-phosphonate, 1-alkynyl-sn2-O-methyl-sn3-dihalo-rac-glycero-3-phosphonate, 1-acyl-sn2-O-methyl-sn3-dihalo-rac-glycero-3-phosphonate and derivatives thereof.

27. A compound having the formula: 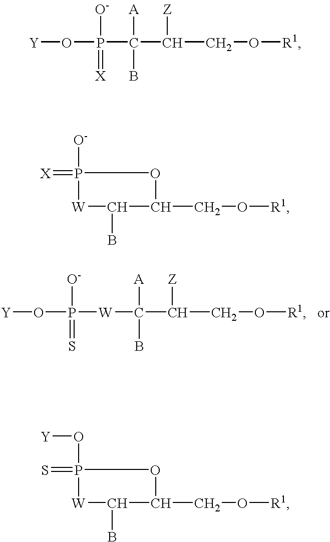
wherein R′ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, A is selected from the group consisting of hydrogen, hydroxyl, and halogen, B is selected from the group consisting of hydrogen, hydroxyl, and halogen, Z is selected from the group consisting of hydrogen, hydroxyl, halogen, haloakyl, haloalkyloxy, alkyl, alkenyl, alkylnyl, saturated acyl, unsaturated acyl, alkoxy, alkenyloxy, and alkynyloxy, W is oxygen or a bond, X is selected from the group consisting of oxygen and sulfur, Y is selected from the group consisting of hydrogen, halogen, saturated and unsaturated haloakyl, saturated and unsaturated haloalkyloxy, alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, substituted aryloxy, and lower alicyclic-oxy groups which are optionally substituted with one or more hydroxy or lower alkoxy groups; or a mimetic, stereoisomer, enantiomer, or pharmaceutically acceptable salt thereof.

28-87. (canceled)

88. A compound having the formula: 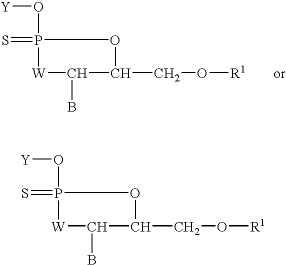
wherein R′ is selected from the group consisting of alkyl, alkenyl, alkylnyl, saturated acyl, unsaturated acyl, alkoxy, alkenyloxy, alkynyloxy, aryl, aryloxy, heteroaryl, heteroaryloxy, aralkyl, aralkyloxy, A is selected from the group consisting of hydrogen, hydroxyl, and halogen, B is selected from the group consisting of hydrogen, hydroxyl, and halogen, W is oxygen or a bond, Z is selected from the group consisting of halogen, haloakyl, haloalkyloxy, alkyl, alkenyl, alkylnyl, saturated acyl, unsaturated acyl, alkoxy, alkenyloxy, and alkynyloxy, Y is selected from the group consisting of cyano alkyl, cyano alkenyl, cyano alkylnyl, cyano acyl, cyano alkoxy, cyano alkenyloxy, cyano alkynyloxy, cyano aryl, cyano aryloxy, cyano heteroaryl, cyano heteroaryloxy, cyano aralkyl, cyano aralkyloxy, and lower cyano alicyclic-oxy optionally substituted with one or more hydroxy or lower alkoxy groups; or a mimetic, stereoisomer, enantiomer, or pharmaceutically acceptable salt thereof.

89-94. (canceled)
